(19) United States
(12) Patent Application Publication
(10) Pub. No.: US 2013/0282599 A1
(43) Pub. Date: Oct. 24, 2013

(54) METHOD OF GENERATING PATENT EVALUATION MODEL, METHOD OF EVALUATING PATENT, METHOD OF GENERATING PATENT DISPUTE PREDICTION MODEL, METHOD OF GENERATING PATENT DISPUTE PREDICTION INFORMATION, AND METHOD AND SYSTEM FOR GENERATING PATENT RISK HEDGING INFORMATION

(71) Applicants: Min Soo Kang, Seoul (KR); Ja Chul Gu, Seoul (KR); Chul Young Kim, Seoul (KR)

(72) Inventors: Min Soo Kang, Seoul (KR); Ja Chul Gu, Seoul (KR); Chul Young Kim, Seoul (KR)

(73) Assignee: Kwanggaeto Co., Ltd., Seoul (KR)

(21) Appl. No.: 13/882,995

(22) PCT Filed: Jun. 28, 2011
(86) PCT No.: PCT/KR2011/004723

§ 371 Date: Jul. 10, 2013

(30) Foreign Application Priority Data
Nov. 2, 2010 (KR) 10-2010-0108425
Mar. 23, 2011 (KR) 10-2011-0025698
Apr. 28, 2011 (KR) 10-2011-0039906

(51) Int. Cl. G06Q 50/18; G06Q 10/00

(52) U.S. Cl. CPC G06Q 50/184; G06Q 10/00
USPC 705/310

(57) ABSTRACT

The present invention relates to a method of generating a patent evaluation model, a method of evaluating a patent, a method of generating a patent dispute prediction model, a method of generating patent dispute prediction information, a method of generating patent licensing prediction information, a method of generating patent risk hedging information, a system for carrying out the methods, a recording medium for storing a program in which the methods are recorded, and a program in which the methods are recorded. According to the present invention, a patent evaluation model which is systemically reliable and highly valid can be generated, and patent evaluation information which is systemically reliable and highly valid can be generated. Furthermore, a patent dispute prediction model, patent dispute prediction information, patent licensing prediction information, and patent risk hedging information, which are systemically reliable and highly valid, can be generated.

### TECHNICAL FIELD

The present invention relates to a method of generating a patent evaluation model, a method of evaluating a patent, a method of generating a patent dispute prediction model, a method of generating patent dispute prediction information, a method of generating patent licensing prediction information, and a method and system for generating patent risk hedging information, and more particularly relates to a method of generating a patent evaluation model, a method of evaluating a patent, a method of generating a patent dispute prediction model, a method of generating patent dispute prediction information, a method of generating patent licensing prediction information, and a method and system for generating patent risk hedging information, which are capable of processing data statistically

### BACKGROUND ART

The 21^{st} century has become the first century when intellectual property is given importance in view of economy beyond Research and Development (R&D) and management. According to this situation, in addition to various conventional aspects of intellectual property, various new aspects of intellectual property such as venture capital business, an appearance of patent trolls, an acceleration of fluidity of intellectual property, an extension of global licensing business, an introduction of a new calculation method in IFRS for the intellectual property, and the like have been resolutely increased.

One of the basic foundations supporting this trend is an evaluation of a value for a patent right which is a representative aspect of the intellectual property rights. Various methods such as a real option and the like, as well as a traditional method are introduced as an evaluation method for the patent right. However, a value evaluation method carried out by a professional incurs a heavy evaluation cost per patent, and takes a long time to evaluate the patent. Accordingly, it is difficult to put the value evaluating method into practical use for a large amount of patents. Accordingly, a method of systematically evaluating a value of a patent has been introduced.

KPEG of the Korea Institute of Patent Information, SMART of the Korea Invention Promotion Association, PatentRatings of Ocean Tomo LLC. of the United States, and PatentScore of IPB (PatentResult Co.) of Japan are well known as the representative systems.

The PatentRatings system of Ocean Tomo, LLC. of the United States determines whether a patent is maintained, by comparing a predicted benefit with a necessary cost in the maintenance of the patent in view of various aspects, when determining an annual registration or a renewal of the patent right of patentees, and reflects a basic assumption that a valuable patent is maintained for a longer than that having a relatively small value, and that the value of a patent has a characteristics of a log-normal distribution. The PatentScore system of IPB Co. of Japan reflects lapse information as an important evaluation element on the assumption that the lapse information relating to various actions of an applicant, a third party and a judge for a whole life cycle of a patent has a large effect on an evaluation of a value of a patent.

In these evaluation systems, an important factor is to improve the reliability of an evaluation result. A variety of efforts are concentrated on an improvement of the reliability. However, these evaluation systems do not provide users with a high reliability that the users want.

Accordingly, a development of a new patent evaluation model and a system using the patent evaluation model has been acutely required in order to increase the reliability of an evaluation result.

On the other hand, patent disputes are increasing sharply in the whole world, bringing about an era of patent war. Conventionally, evaluation systems have attained a level in that databases are constructed based on information on patent disputes, the dispute information is analyzed by using the databases, dispute incurrence information is transmitted by using newsletter and the like, and the evaluation systems help to search the dispute information. These services have merely provided information on the past patent dispute, and have not provided prediction information on disputes which will be generated in the future. Accordingly, an introduction of a service of providing companies with specified dispute information has been acutely required because companies corresponding to a plaintiff or a defendant have different circumstance portfolios of products, technologies and patents. In addition, a method and a system for providing patent information which manage a patent risk systematically and hedge a patent dispute risk structurally have been increasingly required. Further, necessity of a method and a system for processing patents which can systematically search a patent to be licensed, a patent license, a counterpart who has a patent to be cross-licensed, and a patent to be cross-licensed, have been sharply increased.

### DISCLOSURE OF INVENTION

### Technical Problem

The present invention has been made in order to solve the above-mentioned problems. Accordingly, a first aspect of the present invention is to provide a method of generating a patent evaluation model in a patent evaluation system, a method of evaluating a patent, a program executed by a computer which has the methods, a storage medium in which the program is stored, and a system for executing the methods.

The second aspect of the present invention is to provide a method of generating a patent dispute prediction model in a system for generating patent dispute prediction information, a program executed by a computer which stores the method, a storage medium in which the program is stored, and a system for executing the method.

The third aspect of the present invention is to provide a method of generating patent dispute prediction information in a system for generating patent dispute prediction information, a program executed by a computer which stores the method, a storage medium in which the program is stored, and a system for executing the method.

The fourth aspect of the present invention is to provide a method of generating a patent license prediction model in a system for generating patent license prediction information, a method of generating license prediction information, a program executed by a computer which stores the methods, a storage medium in which the programs are stored, and a system for executing the methods.

The fifth aspect of the present invention is to provide a method of generating risk-hedging information in a system for generating patent dispute prediction information, a program executed by a computer which stores the method, a storage medium in which the program is stored, and a system for executing the method.

### Solution to Problem

In accordance with an aspect of the present invention, there is provided a method of generating a patent evaluation model of a patent information system. The method includes: (A1) obtaining at least one dispute patent set including a patent used for at least one kind of patent dispute and at least one non-dispute patent set; (A2) generating a patent evaluation element value for at least two predetermined patent evaluation elements with respect to at least two dispute patents constituting the dispute patent set and at least two non-dispute patents constituting the non-dispute patent set; and (A3) performing a predetermined statistical process for the dispute patent and the non-dispute patent by using the patent evaluation element value as a description parameter value and using a dispute patent grant value which is granted to the dispute patent and a non-dispute patent grant value which is granted to the non-dispute patent differently from the dispute patent grant value as a reaction parameter value, so as to establish at least one patent evaluation model for generating at least one predetermined patent evaluation model.

A size of the non-dispute patent set is equal to or larger than that of the dispute patent set, and the non-dispute patent set is preferably generated by one selected from a first method of extracting a non-dispute patent set from all patent sets and a second method of randomly extracting a non-dispute patent set while sharing at least one statistical property of the dispute patent set.

The method of granting the dispute patent grant value to the dispute patent preferably includes any one of a method of differently granting a first dispute patent grant value according to a property of the dispute patent, and a method of granting a second dispute patent grant value according to whether a dispute occurs, regardless of the property of the dispute patent.

The property of the dispute patent includes at least one of a multi-dispute property, a property of a number of co-defendants, and a co-participation property. The multi-dispute property is a property relating to the dispute patent involved in at least two disputes, the co-defendant property is a property of the dispute patent which is related to a dispute in which litigation is instituted with respect to at least two defendants, and the co-participation property is a property in which at least one dispute patent relates to a dispute to which the dispute patent relates.

In a case where the first method of granting a first dispute patent grant value is employed, the method of granting the dispute patent grant value grants the high dispute patent grant value when the dispute patent has the multi-dispute property, rather than when the dispute patent has no multi-dispute property, grants the high dispute patent grant value when the dispute patent has a co-defendant property rather than when the dispute patent has no co-defendant property, and grants the low dispute patent grant value when the dispute patent has a co-participation property rather than when the dispute patent has no co-participation property.

In a case where the dispute patent has a co-participation property, the dispute patent grant value is preferably granted at a lower value than a dispute patent grant value when the dispute patent does not have the co-participation property.

In a case where the first method of granting a first dispute patent grant value is employed, when the dispute patent has the multi-dispute property, the method of granting the dispute patent grant value grants the dispute patent grant value with reference to at least one of a total number of disputes, a distribution property of total disputes at each time, and a distribution property of total disputes of each defendant, to which the dispute patent relates, when the dispute patent has the co-defendant property, the method of granting the dispute patent grant value grants the dispute patent grant value with reference to at least one of a total number of defendants, an average number of defendant per dispute, and a statistical distribution property of the defendants per dispute, to which the dispute patent relates, when the dispute patent has the co-participation property, the method of granting a dispute patent grant value grants the dispute patent grant value with reference to at least one of an average share of the dispute patent and a statistical distribution property of the average share, to which the dispute patents relates.

Where the first method of granting the dispute patent granting value is employed, the statistical processing is a multi-regression analysis, and where the second method of granting the dispute patent granting value is employed, the statistical processing is a classification analysis.

In accordance with another aspect of the present invention, there is provided a method of generating a patent evaluation model of a patent information system. The method includes: (B1) generating a description parameter value of at least two description parameters of each individual patent which includes a description parameter value of each description parameter generated by using patent data generated before a predetermined reference time at a predetermined time interval; (B2) determining whether a patent survives on the basis of the predetermined reference time and performing a predetermined survival analysis by using a value corresponding to whether the patent survives as a reaction parameter; and (B3) generating at least one patent evaluation model by using at least one of the results of performing the survival analysis.

The predetermined time unit preferably includes at least one of each year unit, each quarter year, or a predetermined annual registration reference term unit.

The time unit is a year unit, and the description parameter value of each description parameter is preferably generated for a patent registered before a specific date of each year in all registered patent sets on the basis of the specific date of every year from the registration date of the individual patent to a predetermined termination time.

In the survival analysis, at least one of a description parameter value of each description parameter at a predetermined time interval, and a description parameter value of each description parameter generated at the predetermined time interval is preferably accumulated and used.

The survival of the patent refers to a renewal of annular registration, and a parameter value corresponding to whether the patent survives is differently granted where the annular registration is maintained and where the annular registration is invalid before the reference time.

The result of the survival analysis is to generate at least one of a hazard function, an intensity function, and a survival function, and the patent evaluation model is preferably generated by a time function.

In accordance with another aspect of the present invention, there is provided a method of generating a patent evaluation model of a patent information system. The method includes: (C1) generating an n^{th} patent evaluation model value (n is a natural number larger than 1) for at least two patents included in all registration patent sets which is constituted with a patent registered as an n^{th} patent evaluation model; (C2) generating a description parameter value of at least one parameter for an individual patent belonging to at least two patent sets which are extracted from all registration patent sets with reference to the n^{th} patent evaluation model value of a related patent with the individual patent; and (C3) generating an (n+1)^{th} patent evaluation model for the extracted patent set by using the description parameter value with the n^{th} patent evaluation model value.

The n^{th} patent evaluation model value is generated by using the n^{th} patent evaluation model, the n^{th} patent evaluation model and the (n+1)^{th} patent evaluation model are generated by using a predetermined statistical method, and as a statistical method of generating the n^{th} patent evaluation model and the (n+1)^{th} patent evaluation model, any one of a method of establishing an n^{th} regression model using an identical method and a method of establishing the (n+1)^{th} regression model is preferably used.

In step (C2), the description parameter value generated with reference to the n^{th} patent evaluation model value is at least one of a description parameter relating to a citation, a description parameter relating to a cited patent, a description parameter relating to an inventor, and a description parameter relating to an owner.

When the description parameter value of the description parameter relating to the cited patent is generated, it is checked whether at least one child patent of the individual patent is present, and the description value is generated by using the n^{th} patent evaluation model value of the child patent. When the description parameter value of the citation relating description parameter is generated, it is checked whether at least one parent patent of the individual patent is present, and the description parameter value is preferably generated by using the n^{th} patent evaluation model value of the checked parent patent.

The description parameter relating to the inventor is used to evaluate a patent set including at least one patent in which the inventor is included, and the description parameter relating to the owner is used to evaluate a patent set including at least one patent in which the owner is included. When the description parameter value of the description parameter relating to the inventor is generated, it is checked whether at least one patent in which the inventor is included is present, and the description parameter value is generated by using the n^{th} patent evaluation model value. When the description parameter value of the description parameter relating to the owner is generated, it is checked whether at least one patent in which the owner is included is present, and the description parameter value is preferably generated by using the n^{th} patent evaluation model value.

Preferably, the method further includes (C4) performing steps (C1) to (C3) more than two times.

Preferably, the method further includes (C5) generating a patent evaluation model value of each patent evaluation model for at least two astringency verification patents which are extracted from all registration patent sets, by using at least two patent evaluation models; and (C6) performing a predetermined statistical analysis for astringency by using the generated patent evaluation model values with respect to the astringency verification patent.

In accordance with still another aspect of the present invention, there is provided a method of generating a patent evaluation model of a patent information system. The method includes: (D1) generating a patent evaluation element value of at least two predetermined patent evaluation elements with respect to an individual patent belonging to at least two patent sets which are extracted from all registration patent sets including registered patents, in order to generate a patent evaluation model; (D2) generating a total a total cost presumption value according to cost presumption model for the individual patent; (D3) establishing at least one patent evaluation model by performing a predetermined statistical processing by using the total cost presumption value as a reaction parameter value and using the patent evaluation element value as the description parameter value.

The total cost presumption model includes an agent fee presumption and an official fee presumption, and is preferably carried out for each event.

The event preferably includes at least one of an application event, events from filing to registration, and events after the registration.

The patent evaluation element includes a citation related patent evaluation element. When the patent evaluation element value of the citation related patent evaluation element is generated, at least one of a direct citation, an indirect citation, a latent citation, a chain citation and a family citation is used. With relation to a method of using at least two of the direct citation, the indirect citation, the latent citation, the chain citation and family citation, it is preferably to use at least one of a first method of independently processing a patent model of each citation type to generate a patent evaluation element value of the predetermined patent evaluation element, and a second method of applying a predetermined weight to each citation type to generate a patent evaluation element value of the predetermined patent evaluation element.

The statistical process is preferably performed by a non-linear algorithm of a machine learning affiliation by using an ensemble scheme using a tree.

The method further includes (D4) generating a patent evaluation model value of each patent with respect to patents belonging to a patent set obtained by using the patent evaluation model. The obtained patent set includes all patent sets, a predetermined patent set, a patent set which a user designates, and a patent set related to the patent set which the user designates. The patent evaluation model value is temporarily or permanently stored in correspondence to the patent, or transmitted to a person who requests the patent evaluation model value.

The patent evaluation model value is preferably generated at a predetermined period, or according to whether a predetermined condition is satisfied.

In accordance with still another aspect of the present invention, there is provided a method of evaluating a patent of a patent information system. The method includes: (E1) obtaining at least one evaluation object patent; (E2) generating a patent evaluation model value by applying at least one predetermined patent evaluation model to the evaluation object patent; and (E3) storing a patent evaluation model value for the evaluation object patent, wherein the patent evaluation model is generated by using any one of a first method of generating a patent evaluation model, which includes: (A1) obtaining at least one dispute patent set including a patent used for at least one kind of patent dispute, and at least one non-dispute patent set; (A2) generating a patent evaluation element value for at least two predetermined patent evaluation elements with respect to at least two dispute patents constituting the dispute patent set and at least two non-dispute patents constituting the non-dispute patent set; and (A3) performing a predetermined statistical process for the dispute patent and the non-dispute patent by using the patent evaluation element value as a description parameter value and using a dispute patent grant value which is granted to the dispute patent and a non-dispute patent grant value which is granted to the non-dispute patent differently from the dispute patent grant value as a reaction parameter value, so as to establish at least one patent evaluation model for generating at least one predetermined patent evaluation model, a second method of generating a patent evaluation model, which includes: B1) generating a description parameter value of at least two description parameters of each individual patent which includes a description parameter value of each description parameter generated by using patent data generated before a predetermined reference time at a predetermined time interval, and which belongs to at least two patent sets extracted from a whole registration patent set including a registered patent, in order to generate a patent evaluation model; (B2) determining whether a patent survives on the basis of the predetermined reference time and performing a predetermined survival analysis by using a value corresponding to whether the patent survives as a reaction parameter; and (B3) generating at least one patent evaluation model by using at least one of the results of performing the survival analysis, a third method of generating a patent evaluation model, which includes: (C1) generating an n^{th} patent evaluation model value (n is a natural number larger than 1) for at least two patents included in all registration patent sets which are constituted with a patent registered as an n^{th} patent evaluation model; (C2) generating a description parameter value of at least one parameter for an individual patent belonging to at least two patent sets which are extracted from all registration patent sets with reference to the n^{th} patent evaluation model value of a related patent with the individual patent; and (C3) generating an (n+1)^{th} patent evaluation model for the extracted patent set by using the description parameter value with reference to the n^{th} patent evaluation model value, and a fourth method of generating a patent evaluation model, which includes: (D1) generating a patent evaluation element value of at least two predetermined patent evaluation elements with respect to an individual patent belonging to at least two patent sets which are extracted from all registration patent sets including registered patents, in order to generate a patent evaluation model; (D2) generating a total cost presumption value according to a total cost presumption model for the individual patent; (D3) establishing at least one patent evaluation model by performing a predetermined statistical processing by using the total cost presumption value as a reaction parameter value and using the patent evaluation element value as the description parameter value.

The method further includes: (E4) providing patent evaluation result information for the evaluation object patent to the user computer or a predetermined system.

The patent evaluation model value includes at least one of a patent evaluation score and a patent evaluation grade. The method of providing the patent evaluation score or the patent evaluation grade as the patent evaluation result information includes at least one of a first method of providing one patent evaluation score or patent evaluation grade to the evaluation object patent in view of patent evaluation, and a second method of providing a patent evaluation score or a patent evaluation grade to the evaluation object patent in view of at least two evaluations with at least one grade.

The patent evaluation resulting information includes a patent evaluation model value provided to least one similar patent to the evaluation object patent. The patent evaluation model value provided to the similar patent includes at least one of a patent evaluation score and a patent evaluation grade. The method of providing the patent evaluation score or the patent evaluation grade to the similar patent as patent evaluation result information may be any one of a first method of providing one patent evaluation score or patent evaluation grade to the similar patent in view of all evaluations, a second method of providing a patent evaluation score or a patent evaluation grade to the similar patent in view of at least two evaluations with at least two grades, a third method of comparing and providing one patent evaluation score and a patent evaluation grade to the evaluation object patent and the similar patent in view of all evaluations, and a fourth method of comparing and providing a patent evaluation score and a patent evaluation grade to the similar patent in view of at least two evaluations with at least two grades.

In accordance with still another aspect of the present invention, there is provided a patent information system using any one of the above mentioned methods.

In accordance with still another aspect of the present invention, there is provided a storage medium in which a program is read by a computer performing any one of the described methods.

In accordance with still another aspect of the present invention, there is provided a program which is read by a computer performing any one of the described methods.

In accordance with still another aspect of the present invention, there is provided a method of generating a patent prediction model of a patent information system. The method includes: (A) obtaining at least one dispute patent set including a patent used for at least one kind of patent dispute and at least one non-dispute patent set; (B) generating a dispute prediction element value for at least two predetermined dispute prediction elements with respect to at least two dispute patents constituting the dispute patent set and at least two non-dispute patents constituting the non-dispute patent set; and (C) performing a predetermined statistical process for the dispute patent and the non-dispute patent by using the dispute prediction element value as a description parameter value and using a dispute patent grant value which is granted to the dispute patent and a non-dispute patent grant value which is granted to the non-dispute patent differently from the dispute patent grant value as a reaction parameter value, so as to establish at least one dispute prediction model for generating at least one predetermined dispute prediction model.

The patent used for the patent dispute includes any one of a patent used for a patent dispute instituted in the judicature, a patent used for a patent dispute instituted in the administrate, a patent used for a notice of a patent infringer, a patent used for an execution of patent right to a patent infringer, and a patent for earning of royalty.

A size of the non-dispute patent set is equal to or larger than that of the dispute patent set, and the non-dispute patent set is preferably generated by one selected from a first method of extracting a non-dispute patent set from all patent sets and a second method of randomly extracting a non-dispute patent set while sharing at least one statistical property of the dispute patent set.

The dispute prediction element value of each dispute prediction element is generated by a unit of each patent constituting the dispute patent set. The dispute prediction element relates to any one of self-property affiliation, property affiliation of both oneself and others, and classification property affiliation.

The dispute prediction element includes a citation related dispute prediction element, wherein at least one of a direct citation, and an indirect citation, a latent citation, and a chain citation is used to generate a dispute prediction element value for the citation related dispute prediction element, and a method of using at least two of the direct citation, the latent citation, the latent citation and the chain citation uses at least one of a first citation using method of generating a dispute prediction element value for a predetermined prediction element by independently processing each kind of citation, and a second citation using method of applying a predetermined weight to each kind of citation to generate a dispute prediction element value for a predetermined dispute prediction element.

The dispute prediction element includes dispute prediction elements in which a term is differently set. At least one term setting is applied to an identical classification.

The dispute prediction element is preferably selected from any one of at least one citation view dispute prediction element, at least one dispute prediction element in view of a multi-dispute patent, at least one dispute prediction element in view of a multi-dispute causing person, and at least one dispute prediction element in view of a multi-dispute technique group.

The method of granting the dispute patent granting value to the dispute patent includes any one of a first method of differently granting the dispute patent grant value according to a property of the dispute patent and a second method of granting a dispute patent grant value according to whether the dispute occurs, regardless of the property of the dispute patent.

The property of the dispute patent includes at least one of a multi-dispute property, a property of the number of co-defendants, and a co-participation property. The multi-dispute property is a property relating to the dispute patent involved in at least two disputes, the co-defendant property is a property of the dispute patent which is related to a dispute in which litigation is instituted with respect to at least two defendants, and the co-participation property is a property in which at least one dispute patent relates to a dispute to which the dispute patent relates.

In a case where the first method of granting a first dispute patent grant value is employed, the method of granting the dispute patent grant value grants the high dispute patent grant value when the dispute patent has the multi-dispute property rather than when the dispute patent has no multi-dispute property, grants the high dispute patent grant value when the dispute patent has a co-defendant property rather than when the dispute patent has no co-defendant property, and grants the low dispute patent grant value when the dispute patent has a co-participation property rather than when the dispute patent has no co-participation property.

In a case where the first method of granting a first dispute patent grant value is employed, when the dispute patent has the multi-dispute property, the method of granting the dispute patent grant value grants the dispute patent grant value with reference to at least one of a total number of disputes, a distribution property of all disputes at each time, and a distribution property of total disputes of each defendant, to which the dispute patent relates, when the dispute patent has the co-defendant property, the method of granting the dispute patent grant value grants the dispute patent grant value with reference to at least one of a total number of defendants, an average number of defendants per dispute, and a statistical distribution property of the defendants per dispute, to which the dispute patent relates, when the dispute patent has the co-participation property, and the method of granting a dispute patent grant value grants the dispute patent grant value with reference to at least one of an average share of the dispute patent and a statistical distribution property of the average share, to which the dispute patents relates.

The statistical processing preferably is a multi-regression analysis.

The multi-regression analysis preferably uses a non-linear algorithm of a machine learning affiliation.

The non-linear algorithm of the machine learning affiliation preferably uses an ensemble scheme using a tree.

The dispute prediction model is preferably generated by applying any one of the first method of differently granting the dispute patent grant value according to the property of the dispute patent, the used dispute prediction element group, and the used dispute patent set.

The dispute patent set preferably is a dispute patent set satisfying a property which a user designates.

The method further includes (D) generating a dispute prediction model value of each patent with respect to patents belonging to a patent set which is obtained by using the dispute prediction model, wherein the obtained patent set is at least one of all patent sets, a predetermined patent set, a patent set which a user designates, and a patent set relating to the patent set which the user designates, and the obtained dispute prediction model value is temporarily or permanently stored in correspondence to the patent, or is transmitted to a person who requests the dispute prediction model value.

The dispute prediction model value is preferably generated at a predetermined period or according to whether a predetermined condition is satisfied.

In accordance with still another aspect of the present invention, there is provided a patent information system using any one of the above mentioned methods.

In accordance with still another aspect of the present invention, there is provided a storage medium in which a program is read by a computer performing any one of the above mentioned methods.

In accordance with still another aspect of the present invention, there is provided a program which is read by a computer performing any one of the above mentioned methods.

In accordance with still another aspect of the present invention, there is provided a patent information system for generating a patent dispute prediction model. The patent information system includes a dispute prediction element value generating unit for a dispute prediction element value for at least two predetermined dispute prediction elements with respect to at least to dispute patents constituting a dispute patent set and at least two non-dispute patents constituting the non-dispute patent set, a dispute prediction model generating unit for performing a predetermined statistical process for the dispute patent and the non-dispute patent by using the dispute prediction element value as a description parameter value and using a dispute patent grant value which is granted to the dispute patent and a non-dispute patent grant value which is granted to the non-dispute patent differently from the dispute patent grant value as a reaction parameter value, so as to establish at least one dispute prediction model for generating at least one predetermined dispute prediction model, and a dispute prediction model value generating unit for generating a dispute prediction model value of each patent with respect to the patents belonging to the patent set which is obtained by using the dispute prediction model value of each patent.

In accordance with still another aspect of the present invention, there is provided a method of processing dispute prediction information of a patent information system. The method includes: (a)(a1)(a11) firstly obtaining a self-patent set including at least one patent, and then (a12) obtaining at least one target patent set having a predetermined relation with the self-patent, or (a2)(a21) firstly obtaining a target patent set including at least one patent, and then (a22) obtaining at least one self-patent set having a predetermined relation with the target patent; (b) obtaining at least one dispute patent prediction model value of each patent with respect to an individual patent constituting the target patent set; and (c) generating at least one piece of dispute prediction information by using the dispute prediction model value of each patent.

The self-patent set preferably is a user management patent set which a user generates or manages, or a system management patent set which the patent information system generates or manages, and the self-patent set is defined by using a predetermined set definition option, or divided into two or more partial patent sets by applying a predetermined division reference thereto, and wherein the target patent set is a user management patent set which a user generates or manages, or a system management patent set which the patent information system generates or manages, and the target patent set is defined by using a predetermined set definition option or divided into at least two partial patent sets by applying a predetermined division reference thereto.

The target patent is a related patent which has a predetermined relation with self-patents constituting the self-patent set, the predetermined relation is at least one of a citing-cited patent relation, a relation of a similar patent group in a text mining scheme, and a similar technique patent relation in a patent classification.

The target patents constituting the target patent set have a predetermined relation with two or more target patents, the relation is measured, and the measurement of the relation includes at least one of relation frequency and relation strength.

The relation frequency is the number of self-patents which have a predetermined relation with the target patent, and the relation strength is preferably generated by at least one of citing-cited patent relation information, similar patent group relation information, and similar technique patent relation.

When the relation strength is generated by the citing-cited patent relation information, the relation strength is generated by using at least one of citing-cited depth information and citing-cited kind information.

When the relation strength is generated by the similar patent group relation information, the relation strength is generated by using similarity information of the self-patent and the target patent. The similarity information is generated by using at least one of keywords extracted from the self-patent and the target patent, citing-cited information generated from reference information of the self-patent and the target patent, at least one kind of patent classification extracted from the self-patent and the target patent, and at least one super ordinate patent classification the patent classification in the patent classification system.

When the relation strength is generated by the similar technique patent relation information, the relation strength is preferably generated by using at least one of coincidence depth, coincidence frequency and coincidence rank in the patent classification system with respect to at least one kind of patent classification included in the self-patent and the target patent.

The dispute prediction model value of each patent is generated by using at least one dispute prediction element value of the dispute prediction element selected from at least one dispute prediction element in view of citation, at least one dispute prediction element in view of a multi-dispute patent, at least one dispute prediction element in view of a multi-dispute causing person, and at least one dispute prediction element in view of a multi-dispute technique group.

When the dispute prediction model value of each patent is obtained, the dispute prediction model value is generated in real time with respect to the target patent, or is loaded from a dispute prediction model value DB of each patent which stores a predetermined dispute prediction model value.

The generated dispute prediction information preferably is at least one of the dispute prediction information of each target patent corresponding to the obtained self-patent set, the dispute prediction information of each target patent group corresponding to the obtained self-patent set, the dispute prediction information on the target patent set corresponding to the obtained self-patent set, the dispute prediction information of each target patent corresponding to at least one partial self-patent set, and the dispute prediction information of each target patent group corresponding to at least one partial self-patent set.

The dispute prediction information preferably includes at least one of one or more dispute prediction information values, at least one piece of dispute prediction analysis information and at least one piece of dispute prediction basis information.

In step (a12), only a patent satisfying a predetermined condition is obtained as the target patent. In step (a22), only a patent satisfying a predetermined condition is obtained as the self-patent. The predetermined condition is preferably set by the user or the patent information system.

The predetermined condition preferably is at least one of an owner condition, a relation condition, and a property condition of an individual patent.

With respect to the target patent set and at least one target patent constituting the target patent set, at least one of partial target patent sets to which a predetermined division reference or a predetermined selection reference is applied has a predetermined ranking. The ranking is preferably generated according to a ranking generation rule using any one of the relation frequency, the relation strength, the dispute prediction model value and the user input relation information.

In step (a12), the target patent set is obtained in correspondence to each partial self-patent set which is divided, and in step (c), the dispute prediction information is generated in correspondence to each partial target patent set corresponding to the partial self-patent set, or in step (a22), the self-patent set is obtained in correspondence to each partial target patent set, and in step (c), the dispute prediction information is generated in correspondence to each partial self-patent set corresponding the partial target patent set.

In step (a), when a method (a1) is selected, the at least two self-patent sets are obtained in step (a11). In step (a12), the target patent set is obtained in correspondence to two or more self-patent sets. In step (c), the dispute prediction information is generated in correspondence to each target patent set corresponding to two or more self-patent sets. When a method (a2) is selected, in step (a21), the self-patent set is obtained in correspondence to two or more target patent sets. In step (c), the dispute prediction information is generated in correspondence to each self-patent set corresponding to two or more target patent sets.

The target patent set is at least one user patent set which is generated or selected by a user, and the relation of the user patent set and the self-patent set refers to that the at least one self-patent constituting the self-patent set and at least one target patent constituting the user patent set have at least one of the citing-cited patent relation, the similar patent group relation in the text mining scheme, and the similar technique patent relation in the patent classification.

In step (c), the dispute prediction information of each self-patent is generated, in correspondence to the self-patent set which is divided into at least two parts or selected, or in correspondence to the target patent set which is divided into at least two parts or selected. The division or selection of the self-patent set, or the division or selection of the target patent set is performed by applying at least one of a selection of the user and a predetermined selection reference or a predetermined division reference of the system.

The predetermined selection reference or division reference includes at least one of an owner, an owner property, a patent technique classification, and at least one average value of the target patent constituting the target patent set.

The owner property preferably is at least one of properties which are designated by the system and properties which are designated by the user, and the evaluation value is a quality evaluation element value which is obtained by evaluating the target patent using at least one quality evaluation element.

In step (b), after a predetermined set operation for the obtained first target patent set is performed, the dispute prediction model value of each second target patent constituting the second target patent set is obtained. The second target patent set is generated by performing at least one of deletion of the first target patent constituting the first target patent set, definition of the first target patent set and addition of a new patent to the second target patent set.

In step (c), the dispute prediction information is generated by reflecting user weight information obtained from the user, and the user weight information includes at least one of weight information on each target patent which constitutes the target patent set and which the user sets up, weight information on each property of the target patent, citing-cited weight information on the citing-cited relation, and weight information on the text mining relation.

The dispute prediction model value is generated by performing statistical processing with respect to the dispute patent and the non-dispute patent by using a dispute prediction element value as a description parameter value and using a dispute patent grant value which is granted to the dispute patent and a non-dispute patent grant value which is granted to the non-dispute patent differently from the dispute patent grant value as a reaction parameter value.

The statistical processing uses a machine learning affiliation algorithm of an ensemble scheme using a tree.

In accordance with still another aspect of the present invention, there is provided a patent information system for processing patent dispute prediction information, which performs any one of the above mentioned methods.

In accordance with still another aspect of the present invention, there is provided a storage medium in which a program is read by a computer performing any one of the above mentioned methods.

In accordance with still another aspect of the present invention, there is provided a program which is read by a computer performing any one of the above mentioned methods.

In accordance with still another aspect of the present invention, there is provided a patent information system for processing patent dispute prediction information. The patent information system includes a self-patent set generating unit for obtaining a self-patent set including at least one patent; a target patent set generating unit of generating or obtaining at least one target patent set which has a relation with the self-set; a dispute prediction model value obtaining unit for obtaining a dispute prediction model value of each patent with respect to an individual patent constituting the target patent set; and a dispute prediction information generating unit for generating dispute prediction information by using the dispute prediction model value of each patent.

The patent information system further includes a multi-relation processing module for calculating a predetermined relation between a self-patent constituting the self-patent set and a target patent constituting the target patent set, and the predetermined relation which the multi-relation processing module calculates includes at least one of a citing-cited patent relation, a similar patent group relation of a text mining scheme, and a similar technique patent relation in the patent classification.

In accordance with still another aspect of the present invention, there is provided a method of processing patent licensing prediction information of a patent information system, the method includes: (I)(I1)(I11) firstly obtaining a self-patent set including at least one patent and then (I12) obtaining at least one target patent set which has a predetermined relation with the self-patent, or (I2)(I21) firstly obtaining a target patent set including at least one patent and then (I22) obtaining at least one self-patent set which has a predetermined relation with the target patent set; (J) obtaining at least one licensing prediction model value of each patent with respect to an individual patent constituting the target patent set; and (K) generating at least one licensing prediction information by using the licensing prediction model value of each patent.

In step (I12), the target patent set is a succeeding application on the basis of an earlier date of a self-patent which constitutes the self-patent set, or in step (I22), the self-patent set is a preceding application on the basis of an earlier date of a target patent which constitutes the target patent set.

The self-patent and the target patent are related patents including patents which have a predetermined relation, and the predetermined relation corresponds to at least one of a citing-cited patent relation, a similar patent group relation of a text mining scheme, and a similar technique patent relation. The target patents constituting the target patent set may have a predetermined relation with two or more self-patents. The relation can be measured, and the measurement includes at least one of relation frequency and relation strength.

The relation frequency is the number of self-patents which have a predetermined relation and correspond to the target patent. The relation strength is generated by using at least one of citing-cited patent relation information, similar patent group relation information, and similar technique patent relation information.

When the relation strength is generated by using the citing-cited patent relation information, the relation strength is generated by using at least one of citing-cited depth information and citing-cited sort information. When the relation strength is generated by the similar patent group relation information, the relation strength is generated by using similarity information of the self-patent and the target patent. When the relation strength is generated by the similar technique patent relation information, the relation strength is generated by using at least one of a coincidence depth, coincidence frequency, and coincidence rank in the patent classification system, with respect to at least one kind of patent classification included in the self-patent and the target patent. The similarity information is generated by using at least one of the keywords which are extracted from the self-patent and the target patent, citing-cited information generated from reference information of the self-patent and the target patent, at least one kind of patent classification extracted from the self-patent and the target patent, and a super ordinate patent classification of the patent classification in the patent classification system to which the patent classification belongs. When the relation strength is generated by the similar technique patent relation information, the relation strength is generated by using at least one of a coincidence depth, coincidence frequency, and coincidence rank in the patent classification system to which the patent classification belongs, with respect to at least one kind of patent classification which is included in the self-patent and the target patent.

The generated licensing prediction information includes at least one of licensing prediction information on each self-patent corresponding to the target set, licensing prediction information on each self-patent group corresponding to the target patent set, licensing prediction information on the self-patent set corresponding to the target patent, licensing prediction information on each self-patent corresponding to at least one partial target patent set and licensing prediction information on each self-patent group corresponding to at least one partial target set.

The licensing prediction information includes at least one of predetermined licensing prediction information value, licensing prediction analysis information, and licensing prediction basis information.

In step (I12) of obtaining the target patent set, only a patent satisfying a predetermined condition is obtained as a target patent, or a target patent is obtained in correspondence to each divided partial self-patent set or in correspondence to each of two or more self-patent sets, wherein the predetermined condition is set up by the user or the patent information system and includes at least one of an owner condition, a relation condition, an owner's total sales, recent dispute accused information on an owner, and a property condition of an individual patent, wherein in a case where the target patent set is obtained in correspondence to each partial self-patent sets, in step (d) of generating the licensing prediction information, the licensing prediction information is generated in correspondence to each partial target patent set corresponding to the partial self-patent set, and in a case where the target patent set is obtained in correspondence to two or more self-patent sets, in step (I) of obtaining the self-patent set, at least two self-patent sets are obtained, and in step (d) of generating the licensing prediction information, the licensing prediction information is generated in correspondence to each target patent set corresponding to the self-patent set.

In step (I22) of obtaining the self-patent set, only a patent satisfying a predetermined condition is obtained as a self-patent, or a self-patent set is obtained in correspondence to each divided partial target patent set or in correspondence to each of two or more target patent sets, wherein the predetermined condition is set up by the user or the patent information system and includes at least one of an owner condition, a relation condition, an owner's total sales, recent dispute accused information on an owner, and a property condition of an individual patent, wherein in a case where the self-patent set is obtained in correspondence to each partial target patent set, in step (d) of generating the licensing prediction information, the licensing prediction information is generated in correspondence to each partial self-patent set corresponding to the partial target patent set, and in a case where the self-patent set is obtained in correspondence to two or more self-patent sets, in step (I) of obtaining the target patent set, at least two target patent sets are obtained, and in step (d) of generating the licensing prediction information, the licensing prediction information is generated in correspondence to each self-patent set corresponding to the target patent set.

The self-patent constituting the self-patent set and at least one partial self-patent set to which at least one division reference or at least one selection reference is applied have a predetermined ranking. The ranking is generated according to a ranking generation rule using at least one of the relation frequency, the relation strength and the licensing prediction model value.

In step (K) of generating the licensing prediction information, the licensing prediction information is generated in correspondence to each target patent set which is divided into at least two or selected, and also the licensing prediction information is generated by reflecting user weight information obtained from the user. The selection or division of the target patent set is performed by the user or the system on a basis of selection reference or division reference. The predetermined selection reference or the division reference includes at least one of an owner, an owner property, a patent technique classification, and at least one evaluation value of the target patent constituting a target patent set. The user weight information includes at least one of weight information of each target patent which a user sets up, weight information of each property which is set in the individual property of the self-patent, citing-cited weight information set for citing-cite relation, text mining weight information set for the text mining relation, and weight information set for the similar technique patent relation, with respect to each target patent constituting the target patent set.

In step (J) of obtaining a dispute prediction model value of each patent, after a predetermined set operation is performed for the first target patent set, it is performed to obtain the second target patent constituting the second target patent set. The second target patent set is generated by performing deletion of the first target patent constituting the first target patent set, definition of the first target patent set, and addition of a new patent to the second target patent set.

The licensing prediction model value of each patent is generated by using at least one dispute prediction element in view of citation, at least one dispute prediction element in view of a multi-dispute patent, at least one dispute prediction element in view of a multi-dispute causing person and at least one dispute prediction element in view of a multi technique group.

The dispute prediction model value is generated by performing predetermined statistical processing with respect to the licensing patent and non-licensing patent by using the licensing prediction element value as a description parameter, and using a licensing patent grant value which is granted to the licensing patent and non-licensing patent grant value which is granted to the non-licensing patent differently from the licensing patent grant value, as a reaction parameter value.

The statistical processing uses a machine learning affiliation algorithm which uses an ensemble scheme using a tree.

In accordance with still another aspect of the present invention, there is provided a patent information system for processing patent licensing prediction information.

In accordance with still another aspect of the present invention, there is provided a program which is read by a computer performing any one of the above mentioned methods.

In accordance with still another aspect of the present invention, there is provided a patent information system for processing patent licensing prediction information. The patent information system includes: a self-patent set generating unit for obtaining or generating a self-patent set including at least one patent; a target patent set generating unit for obtaining or generating a target patent set including at least one patent; a dispute prediction model value generating unit for obtaining a licensing prediction model value of each patent with respect to an individual patent constituting the target patent set; and a licensing prediction information generating unit for generating licensing prediction information by using the licensing prediction model value of each patent.

The patent information system further includes a multi-relation processing module for calculating a predetermined relation between a self-patent constituting the self-patent set and a target patent constituting the target patent set. The predetermined relation which the multi-relation processing module calculates includes at least one of a citing-cited patent relation, a similar patent group of a text mining scheme, and a similar technique patent relation in the patent classification.

In accordance with still another aspect of the present invention, there is provided a method of processing patent risk hedging prediction information of a patent information system. The method includes: (i)(i1)(i11) firstly obtaining a target patent set including at least one patent and then (i12) obtaining at least one complementary patent set which has a predetermined relation with the target set, or (i2)(i21) firstly obtaining a complementary patent set including at least one patent and then (i22) obtaining at least one target patent set which has a predetermined relation with the complementary set; (j) obtaining at least one dispute prediction model value of each patent with respect to an individual patent constituting the complementary patent set; and (k) generating at least one risk hedging prediction information by using the dispute prediction model value of each patent.

In step (i12), the complementary patent set is a preceding application on the basis of the earlier date of the target patent which constitutes the target patent set, or in step (i22), the target patent set is a succeeding application on the basis of the earlier date of the complementary patent set which constitutes the target patent set.

The target patent set is a patent set which has a predetermined relation with a self-patent set including at least one patent, a partial patent set which has a predetermined relation with the self-patent set, a patent set including patents which have a larger value than a predetermined dispute prediction model value, a subset of a patent set including patents which have a larger value than a predetermined dispute prediction model value, a patent set including patents which have a larger value than a predetermined dispute prediction information value with relation to the self-patent set, a subset of a patent set including patents which have a larger value than a predetermined dispute prediction information value with relation to the self-patent set, a patent set which has a larger value than a predetermined dispute prediction information value with relation to the self-patent set, or a subset of a patent set which has a predetermined dispute prediction information value.

The target patent and the complementary patent are related patents which have a predetermined relation, the predetermined relation is at least one of a citing-cited patent relation, a relation of a similar patent group in a text mining scheme, and a similar technique patent relation in a patent classification, the complementary patents constituting the complementary patent set have a predetermined relation with two or more target patents, the relation is measured, and the measurement of the relation includes a relation frequency and a relation strength.

The relation frequency is the number of target patents which have a predetermined relation with the complementary patent, and the relation strength is preferably generated by at least one of citing-cited patent relation information, similar patent group relation information, and similar technique patent relation.

When the relation strength is generated by using the citing-cited patent relation information, the relation strength is generated by using at least one of citing-cited depth information and citing-cited sort information. When the relation strength is generated by the similar patent group relation information, the relation strength is generated by using similarity information of the complementary patent and the target patent. When the relation strength is generated by the similar technique patent relation information, the relation strength is generated by using at least one of a coincidence depth, coincidence frequency, and coincidence rank in the patent classification system, with respect to at least one kind of patent classification included in the self-patent and the target patent. The similarity information is generated by using at least one keyword which is extracted from the complementary patent and the target patent, citing-cited information generated from reference information of the complementary patent and the target patent, at least one kind of patent classification extracted from the complementary patent and the target patent, and a super ordinate patent classification of the patent classification in the patent classification system to which the patent classification belongs. When the relation strength is generated by the similar technique patent relation information, the relation strength is generated by using at least one of a coincidence depth, coincidence frequency, and coincidence rank in the patent classification system to which the patent classification belongs, with respect to at least one kind of patent classification which is included in the self-patent and the target patent.

The generated risk hedging prediction information includes at least one of risk hedging prediction information on each target patent corresponding to the complementary patent, risk hedging prediction information on each of one or more target patent groups corresponding to the complementary set, risk hedging prediction information on a target patent set corresponding to the complementary set, risk hedging prediction information of each target patent corresponding to at least one partial complementary set, and risk hedging prediction information on each of one or more target patent groups corresponding to at least one partial complementary set.

The risk hedging prediction information includes at least one of predetermined risk hedging prediction information, licensing prediction analysis information, and licensing prediction basis information.

In step (i12) of obtaining the complementary patent set, only a patent satisfying a predetermined condition is obtained as a complementary patent, or a complementary patent set is obtained in correspondence to each divided partial target patent set or in correspondence to each of two or more target patent sets, wherein the predetermined condition is set up by the user or the patent information system and includes at least one of an owner condition, a relation condition, an owner's total sales, recent dispute accusation information on an owner, and a property condition of an individual patent, wherein in a case where the complementary patent set is obtained in correspondence to each partial target patent set, in step (d) of generating the licensing prediction information, the licensing prediction information is generated in correspondence to each partial target patent set corresponding to the partial self-patent set, and in a case where the target patent set is obtained in correspondence to two or more target patent sets, in step (I) of obtaining the target patent set, at least two target patent sets are obtained, and in step (d) of generating licensing hedging? prediction information, licensing hedging prediction information is generated in correspondence to each complementary patent set corresponding to two or more target patent sets.

In step (i12) of obtaining the complementary patent set, the predetermined condition includes at least one owner property which is selected or set by the system or the user and which the complementary satisfies. The owner property includes owner scale information, owner type information, and information on whether the property is included in at least one specific relation owner group which the user selects or designates.

In step (i22) of obtaining the target patent set, only a patent which satisfies a predetermined condition is obtained as the target patent. In step (i22), the target patent set is obtained in correspondence to each partial complementary patent set which is divided. In step (i22), the target patent set is obtained in correspondence to each of two or more complementary patent sets. The predetermined condition is set by the user or the patent information system, and includes at least one of an owner condition, a relation condition, an owner's total sales, recent dispute accusation information on an owner, and a property condition of an individual patent. When the target patent set is obtained in correspondence to each partial complementary patent set, at least two complementary patent sets are obtained in step (i), and the risk hedging prediction information is generated by each target patent set corresponding to two or more of the complementary patent sets in step (d).

The target patent constituting the target patent set, and at least one partial target patent set to which at least one division reference or at least one selection reference is applied have a predetermined ranking. The ranking is generated according to a ranking generating rule using at least one of the relation frequency, the relation strength, and the dispute prediction model value.

In step (K) of generating licensing hedging prediction information, the licensing hedging prediction information is generated in correspondence to each of at least two divided or selected complementary sets. In step (K), the risk hedging prediction information is generated by reflecting user weight information which is obtained from the user. The complementary patent set is selected or divided by the user or the system according to a predetermined selection reference and division reference. The predetermined selection or division reference corresponds to at least one of an owner, an owner property, patent technique classification, and any one of predetermined evaluation values of the complementary patent constituting the complementary patent set. The user weight information includes weight information of a complementary patent which is set by the user, weight information of each property set for an individual property of the target patent, citing-cited weight information set for the citing-cited relation, text mining weight information set for the text mining relation, and a similar technique patent relation weight information set for the similar technique patent relation in the patent classification.

In step (J) of obtaining a dispute prediction model value of each patent, after a predetermined set operation is performed for the first complementary patent set, it is performed to obtain the second complementary patent constituting the second complementary patent set. The second complementary patent set is generated by performing deletion of the first complementary patent constituting the first complementary patent set, definition of the first complementary patent set, and addition of a new patent to the second complementary patent set.

The dispute prediction model value of each patent is generated by using a dispute prediction element value of at least one dispute prediction element which is selected from at least one dispute prediction element in view of citation, at least one dispute prediction element in view of a multi-dispute causing person and at least one dispute prediction element in view of a multi-dispute technique group.

The dispute prediction model value is generated by performing predetermined statistical processing with respect to the licensing patent and non-licensing patent by using the licensing prediction element value as a description parameter, and using a licensing patent grant value which is granted to the licensing patent and non-licensing patent grant value which is granted to the non-licensing patent differently from the licensing patent grant value, as a reaction parameter value.

The statistical processing uses a machine learning affiliation algorithm which uses an ensemble scheme using a tree.

In accordance with still another aspect of the present invention, there is provided a patent information system for processing patent licensing hedging prediction information.

In accordance with still another aspect of the present invention, there is provided a storage medium in which a program is read by a computer performing any one of the above mentioned methods.

In accordance with still another aspect of the present invention, there is provided a program which is read by a computer performing any one of the above mentioned methods.

In accordance with still another aspect of the present invention, there is provided a patent information system for processing patent risk hedging prediction information. The patent information system includes: a target patent set generating unit for obtaining or generating a target patent set including at least one patent, a complementary patent set generating unit for obtaining or generating a complementary patent set including at least one patent, a dispute prediction model value obtaining unit for obtaining at least one dispute prediction model value of each patent; and a risk hedging prediction information generating unit for generating risk hedging prediction information by using the dispute prediction model value of each patent.

The patent information system further includes a multi-relation processing module for calculating a predetermined relation between a target patent constituting the target patent set and a complementary patent constituting the complementary patent set, and the predetermined relation which the multi-relation processing module calculates includes at least one a citing-cited patent relation, a similar patent group relation in text mining scheme, and a similar technique patent relation of a patent classification.

### Advantageous Effects

The present invention has an effect as follows.

Firstly, it is possible to systematically generate a patent evaluation model which has a high reliability and a high validity.

Secondly, it is possible to systematically generate patent evaluation information which has a high reliability and a high validity.

Thirdly, it is possible to systematically generate a patent dispute prediction model which has a high reliability and a high validity.

Fourthly, it is possible to systematically generate patent dispute prediction information which has a high reliability and a high validity.

Fifthly, it is possible to systematically generate patent license prediction information which has a high reliability and a high validity.

Sixthly, it is possible to systematically generate patent risk-hedging information which has a high reliability and a high validity.

### BRIEF DESCRIPTION OF DRAWINGS

FIG. 1 is a view illustrating an exemplary embodiment of a use environment of a patent information system according to the present invention.

FIG. 2 is a view illustrating an exemplary embodiment of a structure of the patent information system according to the present invention.

FIG. 3 is a view illustrating an exemplary embodiment of a data section of the patent information system according to the present invention.

FIG. 4 is a view illustrating an exemplary embodiment of a structure of a data processing section in the patent information system according to the present invention.

FIG. 5 is a view illustrating an exemplary embodiment of a structure of an analyzed information generation section in the patent information system according to the present invention.

FIG. 6 is a view illustrating an exemplary embodiment of a structure of the patent evaluation system according to the present invention.

FIG. 7 is a view illustrating an exemplary embodiment of a method of generating a patent evaluation model through an existence analysis according to the present invention.

FIG. 8 is a view illustrating an exemplary embodiment of a method of generating a patent evaluation model by using a reflexive method according to the present invention.

FIG. 9 is a view illustrating an exemplary embodiment of a structure of a system for generating patent dispute prediction information according to the present invention.

FIG. 10 is a view illustrating an exemplary example of a method of generating a dispute prediction element value for each dispute prediction element according to the present invention.

FIG. 11 is a concept view illustrating a property of cited patent set according to the present invention.

FIG. 12 is a concept view illustrating a forward cited patent set among the properties of the cited patent set according to the present invention.

FIG. 13 is a concept view illustrating a backward cited patent set among the properties of the cited patent set according to the present invention.

FIG. 14 is a concept view illustrating a forward self-cited patent set and a backward self-cited patent set among the properties of the cited patent set according to the present invention.

FIG. 15 is a concept view illustrating cited and obtained patent set among the properties of the cited patent set according to the present invention.

FIG. 16 is a concept view illustrating forward cited patent set and backward cited patent set, which are used as cited patent set for the obtained patent set according to the present invention.

FIG. 17 is a concept view illustrating self-cited patent set and forward cited patent set, which are used as cited patent set for the obtained patent set according to the present invention.

FIG. 18 is a concept view illustrating the cited and obtained patent set which is used the cited patent set for the obtained patent set according to the present invention.

FIG. 19 is a concept view illustrating forward cited patent set and backward cited patent set, which are used as cited patent set for the obtained patent set which is obtained under a limited condition according to the present invention, in which the forward cited patent set and the backward cited patent set also are partial sets of the forward cited patent set and the backward cited patent set for the obtained patent set which is not limited as the obtained patent set is limited, and also in which all of the forward cited patent set, the backward cited patent set, the forward self-cited patent set, the backward cited patent set and the cited and obtained patent set are partial sets of the forward cited patent set, the backward cited patent set, the forward self-cited patent set, the backward self-cited patent set and the cited and obtained patent set, which are not limited, when the obtained patent set is under a certain condition.

FIG. 20 is a concept view illustrating forward cited patent set and backward cited patent set, which are limited under a certain condition and which are used as the cited patent set for the obtained patent set, in which the forward self-cited patent set, the backward self-cited patent set and the cited and obtained patent set, like the forward cited patent set and the backward cited patent set which are limited, become partial set of the forward self-cited patent set, the backward self-cited patent set and the cited and obtained patent set when they are limited.

FIG. 21 is a concept view of illustrating an exemplary embodiment of a first latent cited patent according to the present invention.

FIG. 22 is a concept view of illustrating an exemplary embodiment of a second latent cited patent according to the present invention.

FIG. 23 is a concept view of illustrating an exemplary embodiment of a first chain cited patent according to the present invention.

FIG. 24 is a concept view of illustrating an exemplary embodiment of a second chain cited patent according to the present invention.

FIG. 25 is a view illustrating an exemplary embodiment of a method of generating a dispute prediction element value in view of a citation of a system for generating patent dispute prediction information according to the present invention.

FIG. 26 is a view illustrating an exemplary example of a method of generating a dispute prediction model, which is performed by the system for generating the patent dispute prediction information according to the present invention.

FIG. 27 is a view briefly illustrating a Gradient Boosting algorithm.

FIG. 28 is a view briefly illustrating a stochastic gradient boosting algorithm which is newly proposed by Friedman (2002).

FIG. 29 is a view illustrating an exemplary example of a process of generating a dispute prediction model in the system for generating the patent dispute prediction information according to the present invention.

FIG. 30 is an auxiliary view illustrating an over-fitting concept.

FIG. 31 is a flowchart illustrating a process in which a dispute prediction model generation engine generates a dispute prediction model through a boosting algorithm in the system for generating the patent dispute prediction information according to the present invention.

FIG. 32 is a view illustrating an example of a stump generated by the boosting algorithm.

FIG. 33 is a view illustrating a concept of a 5-fold cross validation scheme.

FIG. 34 is a view illustrating an example of the stump with relation to a category-type reaction parameter.

FIG. 35 is a view illustrating an example of the stump with relation to a recurrence model, which is applied to a continuous reaction parameter.

FIG. 36 is a flowchart illustrating a process of generating and storing a dispute prediction model value, which is performed by the system for generating the patent dispute prediction information according to the present invention.

FIG. 37 is a view illustrating a concept in which relation information corresponds to each of relations when two or more self-patents respectively have relations to two or more target patents.

FIG. 38 is a view illustrating a concept in which a predetermined weight is given to each relation when one self-patent has a predetermined relation to at least one target patent.

FIG. 39 is a flowchart illustrating a process of generating dispute prediction information, which is performed by the system for generating the patent dispute prediction information according to the present invention.

FIG. 40 is a flowchart illustrating a process of generating weight information on each target and generating dispute prediction information in consideration of the weight information, in which the process is performed by the system for generating the patent dispute prediction information according to the present invention.

FIG. 41 is a flowchart illustrating a process of generating an exemplary kind of individual dispute prediction information and an example of dispute prediction information in a system for generating patent dispute prediction information according to the present invention.

FIG. 42 is a flowchart illustrating a process of generating dispute prediction information on the basis of target patent set corresponding to divided self-patent set in the system for generating the patent dispute prediction information according to the present invention.

FIG. 43 is a flowchart illustrating a process of generating dispute prediction information on the basis of divided target patent set in the system for generating the patent dispute prediction information according to the present invention.

FIG. 44 is a flowchart illustrating a process of analyzing dispute prediction information in the system for generating the patent dispute prediction information according to the present invention.

FIG. 45 is a flowchart illustrating a process of generating grade information on a grade given model in the system for generating the patent dispute prediction information according to the present invention.

FIG. 46 is a flowchart illustrating a process of generating a new dispute extending prediction information in the system for generating the patent dispute prediction information according to the present invention.

FIG. 47 is a flowchart illustrating a process of alerting dispute information in the system for generating the patent dispute prediction information according to the present invention.

FIG. 48 is a flowchart illustrating a process of generating risk-hedge prediction information in the system for generating the patent dispute prediction information according to the present invention.

FIG. 49 is a flowchart illustrating a process of generating cross-licensing prediction information in the system for generating the patent dispute prediction information according to the present invention.

FIG. 50 is a block diagram illustrating an exemplary embodiment of a structure of a system for generating patent licensing prediction information according to the present invention.

FIG. 51 is a flowchart illustrating a process of generating licensing prediction information in the system for generating the patent licensing prediction information according to the present invention.

FIG. 52 is a flowchart illustrating a process of generating a patent evaluation element value in view of a citation of a patent evaluation system according to the present invention.

FIG. 53 is a flowchart illustrating a process of generating a patent evaluation model in the patent evaluation system according to the present invention.

FIG. 54 is a flowchart illustrating a process of generating a patent evaluation model in the patent evaluation system according to the present invention, in which an engine for generating a patent evaluation model generates the patent evaluation model through a boosting algorithm.

FIG. 55 is a flowchart illustrating a process of generating and storing a patent evaluation model value in the patent evaluation system according to the present invention.

FIG. 56 is a flowchart illustrating a process of generating patent evaluation information in the patent evaluation system according to the present invention.

FIG. 57 is a flowchart illustrating a process of generating weight information on each target patent and generating patent evaluation information in consideration of the weight information in the patent evaluation system according to the present invention.

FIG. 58 is a flowchart illustrating a process of generating an exemplary kind of individual patent evaluation information and patent evaluation information in the patent evaluation system according to the present invention.

FIG. 59 is a flowchart illustrating a process of generating patent evaluation information on the basis of target patent set (patent set including a group of similar patents or related patents) corresponding to divided self-patent set (patent set including patents to be evaluated) in the patent evaluation system according to the present invention.

FIG. 60 is a flowchart illustrating a process of generating dispute prediction information on the basis of divided target patent set in the system for generating the patent dispute prediction information according to the present invention.

FIG. 61 is a flowchart illustrating a process of generating patent evaluation information in the patent evaluation system according to the present invention.

FIG. 62 is a flowchart illustrating a process of generating grade information on a grade grant model in the patent evaluation system according to the present invention.

### BEST MODE

### Mode for the Invention

Hereinafter, the embodiments of the present invention will be described with the accompanying drawings.

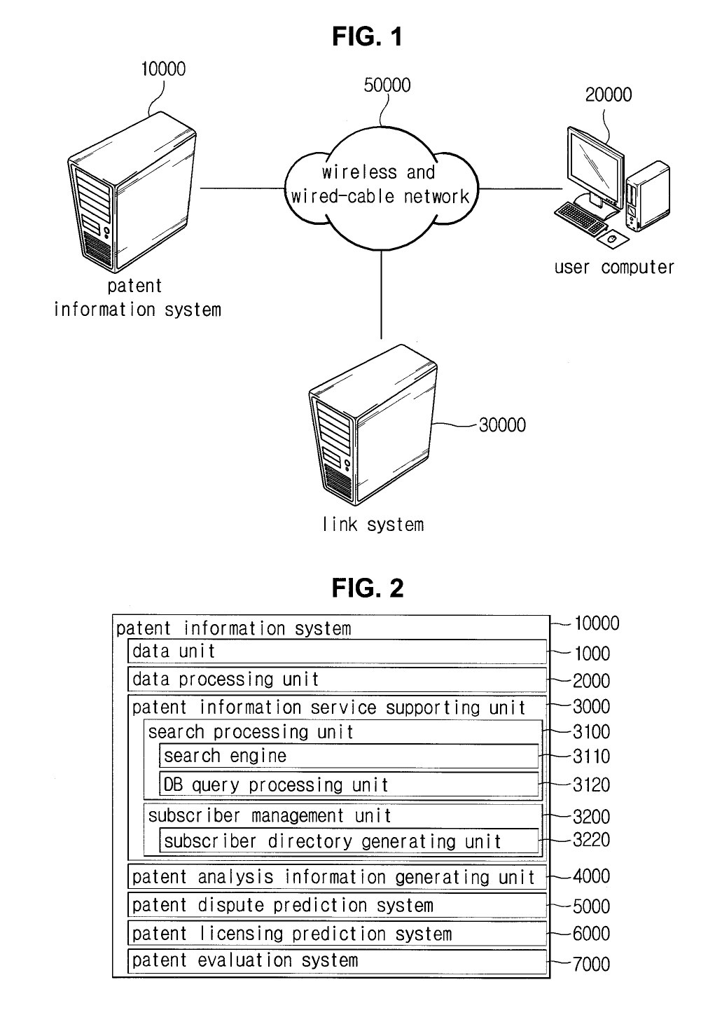

A patent information system 10000 of the present invention provides a user's computer 20000 with an information service through a wireless or wired network 50000, as shown in FIG. 1. The patent information system 10000 can be connected to at least one link system 30000 by the wireless or wired network 50000. An example of the link system 30000 includes a system of a patent office of each nation or a raw data provider which provides patent raw data, a system of an enterprise which provides information, and the like. Further, another example of the link system 30000 includes at least one system which is linked to a service of the patent information system 10000 of the present invention, but the patent information system of the present invention is not limited to the above-mentioned systems.

As exemplarily shown in FIG. 2, the patent information system 10000 generally includes a data unit 1000, a data processing unit 2000, a patent information service supporting unit 3000 having a search processing unit 3100 and a subscriber management unit 3200, a patent analysis information generating unit 4000, a patent dispute prediction system 5000, a patent licensing prediction system 6000, and a patent evaluation system 7000.

The data unit 1000 includes at least one of a patent data unit 1100, a non-patent data unit 1200, a core keyword Data Base (DB) 1300, a classification metadata DB 1400, a user data unit 1700, an auxiliary DB 1800, a specific data unit 1900, and the like. The patent data unit 1100 includes a patent specification file section 1110, a patent DB 1120, a patent classification DB 1130, other patent data DB 1140, other classification DB section, and the like.

The patent DB 1120 manages bibliographic details, a specification, drawings, and the like for all patents by each field, and includes core keywords which are extracted from various fields, i.e. title, abstract, prior art, claims, description of the present invention, constituting the specification. On the other hand, the patents further include citation information as a prior technical document for the patents. As an example, in a US patent data, the citation information is included in a Reference, which includes a U.S. Pat. Ser. No., foreign Patent Serial No(s)., and other references relating to non-patent documents. On the other hand, prior art search information reported by an examiner of the patent office or an applicant, reference information attached to an examiner's opinion, and the like become citation information in a broad sense. In a case where forward citation information is included in a specific document, the specific document becomes a forward citation document in view of a document included in the backward citation information. The document included in the forward citation information becomes a parent document on the basis of the specific document, while the specific document becomes a child document in view of the parent document. It is obvious to a person skilled in the art that information having the relationship of a child-parent is processed as DB. The description will be omitted.

The bibliographic details of the patent document include publication nation information, date information, serial number information, at least one rightful person or enterprise related information, at least one inventor related information, at least one patent classification related information, at least one priority related information, and the like. The date information includes an application filing date, a publication date, a registration date, and the other dates. The serial number information includes an application No., a publication No., a registration No., an original application No., a priority No., and the like. The rightful person or enterprise information includes an applicant, an assignee, a patentee, and the like, and may include information on an assigner and an assignee, and information on the final rightful person or enterprise in a case where the rightful person or enterprise is changed and managed. The priority information includes information on the priority No., a priority data, a nation, and the like. On the other hand, in a case of a divided application, a continuation-in-part application, and a continuation application, the bibliographic details additionally include an original application No., an original application filing data, and the like. Further, the bibliographic details include a representative figure, a title, an abstract, an index and the like. On the other hand, processed bibliographic details may include domestic family information, i.e. information on a patent application relating to a divided application, a changed application, a continuation-in-part application, or a continuation application, and foreign family information, i.e. information on a patent application relating to the priority treatment, an international application, and the like. On the other hand, the bibliographic details may further include core keyword information in which a text of a patent specification is extracted through a natural language processing in a manner of a predetermined keyword extraction in correspondence to each field or each field combination constituting the text.

The patent classification information may include a patent classification of each nation such as United States Patent Classification (USPC), Japanese F-Term classification (FT), Japanese File Index classification (FI), European Patent Classification (ECLA), and the like, as well as a common International Patent Classification (IPC). These classifications have a layered structure. The patent classification of the present invention includes IPC, USPC, FT, FI, and ECLA. An index is called a catchword, and refers to a system in which at least one patent classification corresponds to a word, a phrase, or a paragraph. A representative one among several indexes is an index to USPC which is a catchword into which the IPC is converted. Most indexes have a layered structure like the patent classification. The indexes have keywords inherent therein to correspond to a product name, a part name, an elemental technique, and the like. The indexes are used to easily search for a patent classification. Information on a catchword for the IPC provided by the World Intellectual Property Organization can be obtained in a file form of ipcr_catwordindex_{—}20100101.zip at a website of http://www.wipo.int/ipc/itos4ipc/ITSupport_and_download_area/20100101/MasterFiles/, as of April, 2011. In the file, it can be understood that ABACUSES corresponds to G06C 1/00. At this time, the ABACUSES are named an index corresponding to G06C 1/100. Accordingly, G06C 1/00 can be inversely mapped to the Abacuses. On the other hand, as known from an index of ABARADING in the contents of the file, it is understood that the catchword system has a layered structure of at least a first level. It shows that the ABARADING is a second layer. The USPC is provided by the USPTO, on which information can be identified at a website of http://www.uspto.gov/web/patents/classification/uspcindex/indextouspc.htm. It is understood that an index of Abrading is classified into a first layer in the contents of the link. It is known that the index of the Abrading corresponds to USPC 451/38, and a patent classification of another class as well as the Class 451 exists in a subordinate index of the Abrading. All items relating to the patent classification are stored in a patent classification DB 1130.

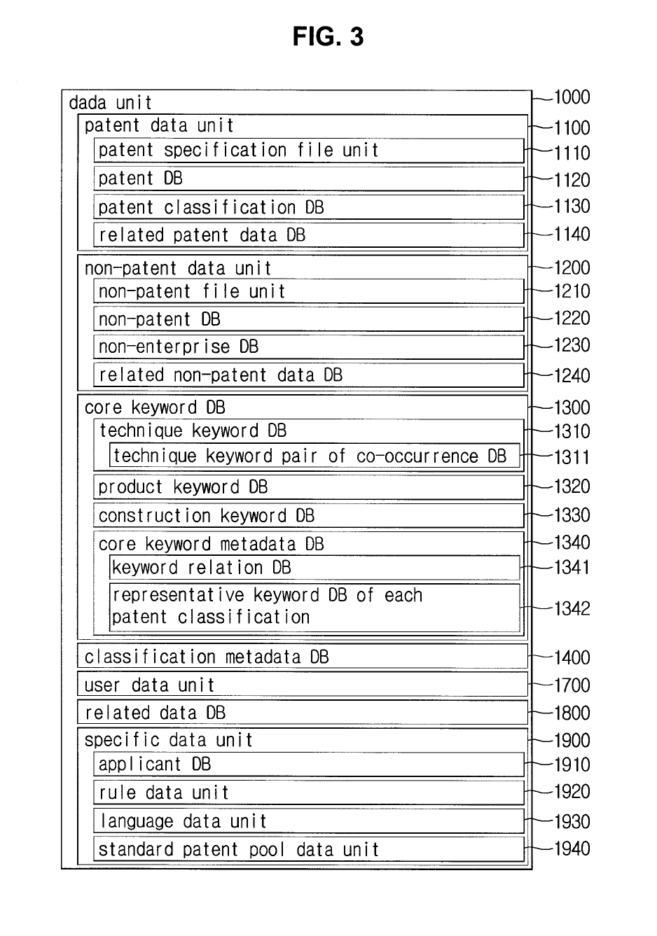

FIG. 3 shows a structure of an exemplary embodiment of a core keyword DB 1300 according to the present invention. The core keyword DB 1300 includes a technique keyword DB 1310, a product keyword DB 130, a construction keyword DB 1330 and a core keyword metadata DB 1340. The core keyword DB 1300 stores information on a core keyword, a co-occurrence pair, and the like, which are extracted from each patent document. The product keyword DB 1320 stores various keywords which characterize the product, or a co-occurrence pair. The construction keyword DB 1330 stores information on a construction keyword set which expresses a construction having a specific property, such as a construction expressing a technical problem, i.e. a weight-reduction, a reduction of the amount of hydrogen in a metal (an action+an object+a position of the object), and a construction expressing a technical solution. On the other hand, the core keyword metadata DB 1340 stores a relationship between keywords (the relationship information between the keywords may be generated resulting from a link analysis) as well as the above-mentioned information. The core keyword metadata DB 1340 may include a keyword relationship DB 1341, a patent classification representative keyword DB 1342 in which keywords representing each patent classification are collected, and the like.

The core keyword DB 1300 stores information on the extracted core keyword. The extraction of the core keyword (including a co-occurrence pair) from the patent document will be described later. The core keyword DB 1300 includes a metadata DB for each core keyword, in which metadata information on each core keyword is stored. When the core keywords are extracted, a patent document No., an extracted field, and a frequency in a specific field of the patent document can be simultaneously calculated with relation to the extraction of each keyword from each patent document. Bibliographic details of the patent document include bibliographic information such as information on various dates, applicant information, inventor information, patent classification information, reference information, and the like. Therefore, a patent document No., the bibliographic details, fields and the frequency may correspond to a certain core keyword, and such information becomes a basic content of the core keyword metadata DB 1340. On the other hand, in a case where there is the basic content of the core keyword metadata DB 1340, variation data for each keyword, link analysis result data, i.e. shopping basket analysis, and mapping probability data between the patent classifications for each core keyword may be generated. These data may be a content of the core keyword metadata DB 1340. When a core keyword is Kᵢ, the mapping probability data between the patent classifications for each core keyword correspond to a probability that K, corresponds to at least one patent classification Cⱼ, i.e. P(Cⱼ(Kᵢ)). In a case where Kᵢ is extracted from patent documents P₁, P₂, P₃ and P₄, P₁, P₂, and P₃ become a classification of C₁, and P₄ becomes a classification of C₂, the probability that the K₁ corresponds to C₁ is ¾, and the probability that the K₁ corresponds to C₂ is ¼. That is, the P(Cⱼ(Kᵢ)) equals to (a number of patent documents which have a classification of Cⱼ, among the patent documents from which Kᵢ is extracted)/(a number of patent documents from which the K is extracted). On the other hand, in a case where there is the P(Cⱼ(Kᵢ)), set of Kᵢs representing the Cⱼ may be extracted. At this time, the P(Cⱼ(Kᵢ)) for the Cⱼ of Kᵢ or the Kᵢs having a predetermined high metric can form the set.

The patent classification DB 1130 includes a classification metadata DB which is generated by processing the patent classification DB 1130 and which stores metadata information on each patent classification. The patent document corresponds to at least one kind of patent classification. The bibliographic details of the patent document include bibliographic information such as information on various dates, applicant information, inventor information, patent classification information, reference information, and the like. Accordingly, a patent document No., and bibliographic details may correspond to a specific patent classification, and the information becomes a basic content of the patent classification metadata DB. On the other hand, in a case where there is the basic content of the patent classification metadata DB, variation data for each patent classification, link analysis result data, i.e. shopping basket analysis, result data, and mapping probability data between the patent classifications for each patent classification, the applicant data or the inventor data can be generated which has a high value of each patent index, i.e. a kind of metric, such as a share or an activity ratio. These data can become a content of the patent classification metadata DB.

The user data unit 1700 stores whole management information on a user who uses the patent information system 10000, and information which the user generates or manages. On the other hand, the purpose-specialized data unit 1900 includes an applicant DB 1910 which stores a name of a representative applicant and information, a rule data unit 1920 which stores information on various rules (patent index, a construction of analysis instruction, and the like may become a rule), a language data unit 1930 which stores a dictionary for processing a natural language (a translation language dictionary for a translation, a thesaurus dictionary, and the like is an example of the dictionary) and other dictionaries (a dictionary of scientific and technological terminology, an index dictionary which has index language extracted from a thesis, and the like my be an example), and a standard patent pool data unit 1940 which stores patents belonging to a standard patent pool. The purpose-specialized data unit 1900 stores various data which meets a specialized purpose.

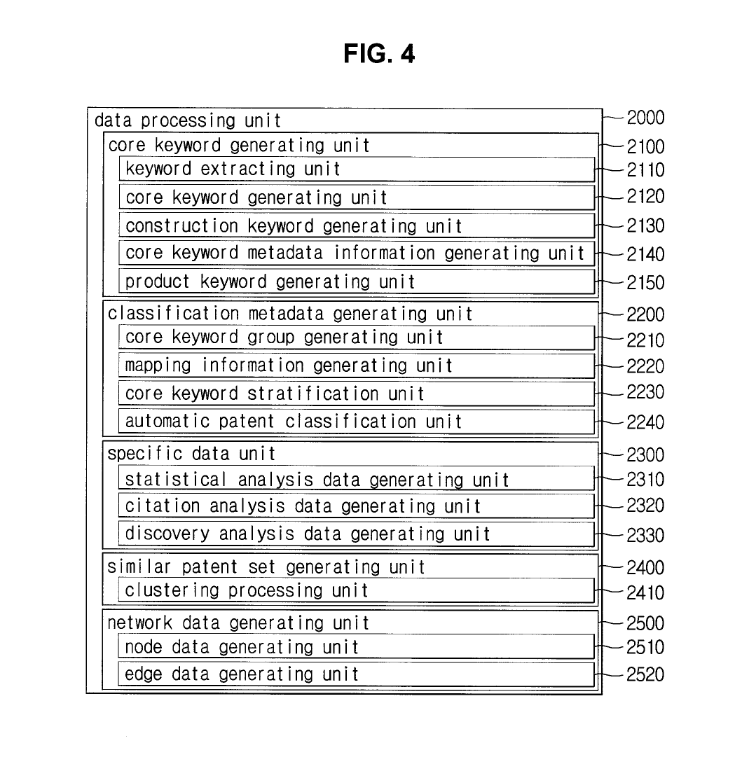

As exemplarily shown in FIG. 4, the data processing unit 2000 includes a core keyword generating unit 2100 which extracts at least one core keyword from a patent document, a classification metadata generating unit 2200 which generates various metadata for the patent classification, a purpose-specialized data generating unit 2300, a similar patent set generating unit 2400 which generates set of patents which have similar contents among given patents, and a network data generating unit 2500 which generates information on related nodes and relation information (edge information) between the related nodes if a link analysis result is present.

The patent information service supporting unit 3000 shown in FIG. 2 includes a search processing unit 3100 for performing a search process, a subscriber management unit 3200 for managing subscribers, a platform service providing unit for providing a platform service in a manner of a web service or SOA which provides at least one user computer 20000 (the user computer 20000 of the present invention includes a server system as well as a personal computer or a portable terminal) with a service, data and the like which are provided by the patent information system 10000, a unit for providing an electronic commercial transaction service, a unit 8500 for providing a community service, an electronic payment unit 8600 for providing a payment service, and a comment processing unit 8700 for processing all comment services, which includes functions of allowing users to write comments on each patent document, transmitting the comments to an inventor or applicant of the patent document, and providing the comments to a user computer 20000 which uses the patent document. The search processing unit 3100 may include at least one of a search engine unit 3110 and a DB query processing unit 310. A DBMS can perform a function of the DB query processing unit 3120 because the convention DBMS supports an SQL search and the like.

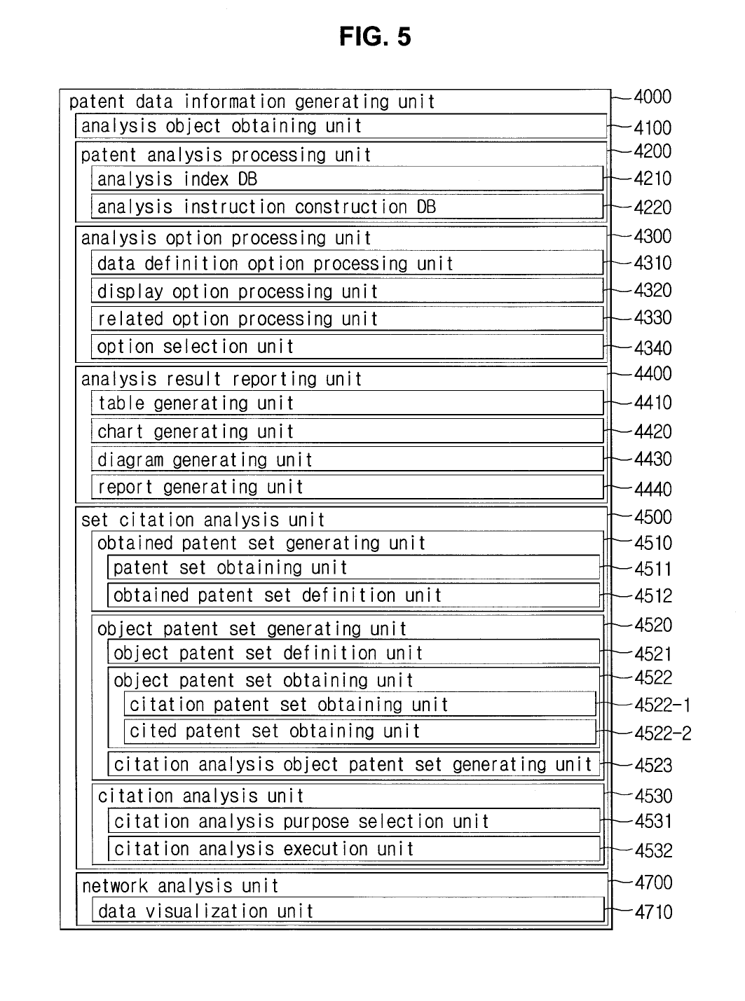

FIG. 5 is a view illustrating an exemplary embodiment of the patent analysis information generating unit 4000 according to the present invention. The patent analysis information generating unit 4000 obtains at least one temporary patent document set or an analyzed-object data set, and generates at least one analysis result for the obtained patent document set or the analyzed-object data set. The obtainment of the patent document set or the analyzed-object data set for the patent analysis is processed by an analyzed-object obtainment unit 4100. An analysis result is generated by a patent analysis processing unit 4200. The patent analysis processing unit 4200 obtains an instruction which generates an analysis index value for at least one analysis index stored in the analysis index DB 4210, or an analysis instruction construction stored in an analysis instruction construction DB 4220, and applies the instruction or the analysis instruction construction to the obtained patent document set or analyzed-object data set so as to generate an analysis result. On the other hand, since various options are added in the patent analysis, these options are processed by an analysis option processing unit 4300. The analysis option processing unit 4300 includes a data limitation option processing unit 4310 for limiting the patent document set or the analyzed-object data, a display option processing unit 4320 for determining which item of the analysis result is displayed, other option processing unit 4330 for processing various options in order to analyze a patent, and an option selection unit 4340 for obtaining selection information on the various options from the user computer 20000 and transmitting the obtained option selection information to the patent analysis processing unit 4200. The analysis result transmitted to the user is generated by an analysis result reporting unit 4400. A reporting format may include at least one of a table, a chart, a diagram, i.e. a network diagram, and a document having a conventional format, i.e. pdf, web page, and the like. These formats are generated by a table generating unit 4410, a chart generating unit 4420, a diagram generating unit 4430, and a report generating unit 4440. A citation analysis 4500 for each set is performed by applying at least one analysis index or an analysis instruction construction to at least two patent document set groups, resulting in a generation of a patent analysis result. This will be described later.

FIG. 5 shows the option selection unit 4340 according to the present invention. The option selection unit 4340 includes a period defining unit for performing a definition relating to a period of the patent document, such as application date, publication date, registered date, priority date, earliest date, and the like, a nation defining unit for defining a nation based on nation information in an address of a rightful person, an applicant defining unit for defining at least one applicant, an inventor defining unit for defining at least one inventor, a patent classification defining unit for performing a definition for at least one kind of patent classification, a depth of the patent classification, and at least one of a main patent classification and a sub patent classification, a field property defining unit for defining a property of a certain field, an individual patent property value defining unit for performing a definition for a detail property of an individual patent, and another defining unit for performing a definition for a citation depth, a citation kind, for example at least one of direct, indirect, latent, chain, and the like, and a citation direction, for example forward and backward. The field includes bibliographic details which include an applicant, an inventor, a patent classification, and the like. For example, examples of the applicant definition include a definition for an enterprise, an organization, a university, and a person among the applicants, a definition for a large enterprise and a small and middle enterprise based on an enterprise scale, and a definition for a domestic inventor and a foreign inventor based on an address of an inventor. On the other hand, the definition for the individual field value includes a definition for an applicant which has a number of citations per patent larger than a predetermined value, and a definition for an inventor which has an increasing rate of patent application of more than 25% for five years. Further, an example of the individual patent property value definition includes a definition based on a value of an individual patent property, i.e. a cited number of patents, a patent grade, and a presence or an absence of a dispute, such as a patent cited more than ten times, a patent within a high ranking of 10%, a patent which is disputed, and the like.

The patent information system 10000 of the present invention processes patent information to generate a prediction model or an evaluation model, and applies the prediction model or the evaluation model so as to generate prediction information and evaluation information. A system for generating the prediction information includes a patent dispute prediction system 5000 and a patent licensing prediction system 6000, and a patent evaluation system 7000 generates evaluation information. In order to establish the prediction model or the evaluation model, it is necessary 1) to introduce a description parameter and a reaction parameter, 2) to calculate a description parameter value and a subordinate parameter value, 3) to establish a model, and 4) to apply the established model to the system.

The description parameter used for a prediction model or an evaluation model is referred to as a prediction element, or briefly as an element. Since an evaluation of a value or a grade of a patent through an evaluation model is a prediction for a value or grade, the description parameter can be equally used as the prediction element or the element in the present invention.

In the present invention, two or more parameters among the description parameters which are exemplarily shown are used.

Table 1 shown below exemplarily indicates the description parameter in view of citation.

TABLE 1

| | affiliation | | |
|---|---|---|---|
| affiliation | code | Description parameter in view of citation | remark |
| Total | A1 | total cited frequency | |
| number | | | |
| Late n | B1 | Cited number for late n years (n = 1) | |
| years | | | |
| self-cited | C1 | self-cited frequency, self-cited frequency for late n | |
| frequency | | years | |
| Non Self- | D1 | Non self-cited frequency, non self-cited for late n | |
| cited | | years | |
| frequency | | | |
| Average | E1 | Number of A1~D1 per claim, number of cited | |
| number | | owners per cited patent, number of cited patent | |
| | | classification per cited patent, number of owner types | |
| | | per cited patent | |
| Property | F1 | A1, B1, D1 and E1 on basis of owner of each cited | |
| value | | patent, A1, B1, D1 and E1 on basis of owner type of cited | |
| | | patent, A1, B1, D1 and E1 on basis of ratio of each owner | |
| | | type of cited patent, A1, B1, D1 and E1 on basis of patent | |
| | | classification of cited patent | |
| Variation | G1 | Variation or variation ratio of A1 to F1 for whole | |
| or variation | | period, variation or variation ratio of A1 to F1 for a | |
| ratio | | specific period | |
| Reference | H1 | Number of References, number of patents in | |
| | | References, number of theses to patents in References, | |
| | | number of foreign patents in Reference, number of | |
| | | domestic patents in Reference/number of foreign patents | |
| | | in Reference | |

Table 1 will be described hereinafter. The patentee can be generally classified into an enterprise, an organization, a university or a person, into a domestic patentee or a foreign patentee, into a large scale enterprise and or a small and middle scale enterprise. The enterprise and the person can be classified as a private subject, while the organization and university are classified as a public subject. Further, the patentee can be classified into a subject having a large amount of applications or a subject having a small amount of applications. The Maintenance Fee information published by the United States Patent and Trademarks Office (USPTO) indicates whether the patentee is a large entity. The patentee of other nations can be divided into a subject having a large number of applications and patent rights or a subject having a small number of application and patent rights on the basis of the number of applications or registered patents of the patentee or the applicant. The enterprise, the organization and the university can be identified by using structure information of an organization included in an applicant/patentee name, i.e. name=organization name+organization type. For example, in a case where the name is Samsung Electronics Co., Ltd., Samsung Electronics becomes an organization name and Co., Ltd. becomes an organization type. A ratio of patentee type includes a ratio of enterprise patentees/whole patentees, a ratio of (enterprise patentees+personal patentees)/(organization patentees+university patentees), and the like. A Self indicates a case where a patentee of an individual patent is identical to that of a cited patent, and a Non-self only indicates a case where a patentee of a certain patent is different from that of a cited patent.

On the other hand, abbreviated transcriptions such as “A1, B1, D1 and E1” or A1˜D1 which are used as a number of transcription items is very large will be described. Among A1, B, D1 and E1 expressed on the basis of the patentee of the cited patent, A1 indicates a total number of patentees of the cited patents, B1 indicates a total number of patentees of the cited patents for recent n years, D1 indicates a total number of patentees of individual patents and other patentees among the patentees of the cited patents, and E1 indicates a value of A1, B1 and D1 divided by a number of claims of the individual patents. Such abbreviated transcriptions are constituted with “an element part+a range of a reference part”. In the above description, the element part corresponds to “patentees of the cited patents”, and the range corresponds to a range of references which constitute dispute prediction element candidates on the basis of the patentees of the cited patents.

On the other hand, it is possible to generate the dispute prediction element candidate according to any one or a combination of the patent classification methods, i.e. IPC, USPC, FT, FI and ECLA, a level in the patent classification layered structure, i.e. in a case of the IPC, subclass or main group, and a use range of the main patent classification and the sub patent classification. For example, in a case where both the USPC and the IPC are transcribed, only main patent classification is used. The USPC generates a description parameter in a level of a class while the IPC generates description parameters in levels of subclass and main group. Accordingly, it is possible to generate prediction element values which are the description parameter values for a total of three kinds of classes.

The present invention greatly includes five types of citations. Firstly, a first type of citation is a direct citation which has a citation depth of 1. In a case where reference information of a patent P1 includes a patent P2, the patent P2 is a parent of the patent P1, while the patent P1 is a child of the patent P2. In this case, the patent P2 is a direct citation of the patent P1, and the patent P1 is a reference which is directly cited in the patent P2. Secondly, a second type of citation is an indirect citation which has more than citation depth 2. In a case where a reference of the patent P includes a patent P3, the patent P3 is an indirect citation of the patent P1 which has a citation depth of 2. A third type of citation is a latent citation. A fourth type of citation is a chain citation. A fifth type of citation is a family citation.

All types of citations can be classified into forward citations and backward citations. The dispute prediction element value or dispute prediction element candidate value for the various dispute prediction element or dispute prediction element candidate in view of the citation indicated in Table 1 may include subordinate types of citations of each of the five types of the citations, i.e. a first latent citation, a second latent citation, a first chain citation, a second chain citation, and the like. The dispute prediction element value or the dispute prediction element candidate value can be separately generated, or can be generated by simply adding two or more citation of the five types of the citations, or by giving a predetermined weight to each of the five types of the citations and adding two or more citation of the five types of the citations. Of course, it is preferable to separate and generate the dispute prediction element value or the dispute prediction element candidate value into the forward and backward type.

Further, in a case where a company having its patent or an applicant, i.e. a subsidiary company, having a closed relation to the company cites the patent, it is referred to as a self-citation in a narrow sense. The self-citation is a case where a patent and a reference cited in the patent have a predetermined common denominator. The common denominator may include an identical applicant, an identical inventor, an identical patent classification, and the like.

A module for generating a citation patent set according to the present invention generates any one of a direct citation patent set including at least one direct citation patent in the self-patent SSi, an indirect citation patent set including at least one indirect citation patent, a latent citation patent set including at least one latent citation patent, a chain citation patent set including at least one chain citation patent, and a family citation patent set including at least one family citation patent.

Reference information relating to the direct citation of the present invention includes at least one of 1) a reference given by the applicant or the patentee of the patent P1 (an applicant citation), 2) a reference given by an examiner (an examiner citation), 3) a reference given by searching for a preceding technology (a citation of a preceding technology search), and 4) a cited reference given by an examiner during an examination (a reference citation). With the generation of the cited patent set of the cited patent set generating unit 5121, the indirect citation information, the latent citation information and the chain citation information are generated in consideration of any one of the references of 1) to 4).

Continuously, the obtained self-patent set, cited patent set, forward cited patent set, backward cited patent set, forward self-cited patent set, backward self-cited patent set, and cited and obtained patent set will be described with reference to FIGS. 11 to 20.

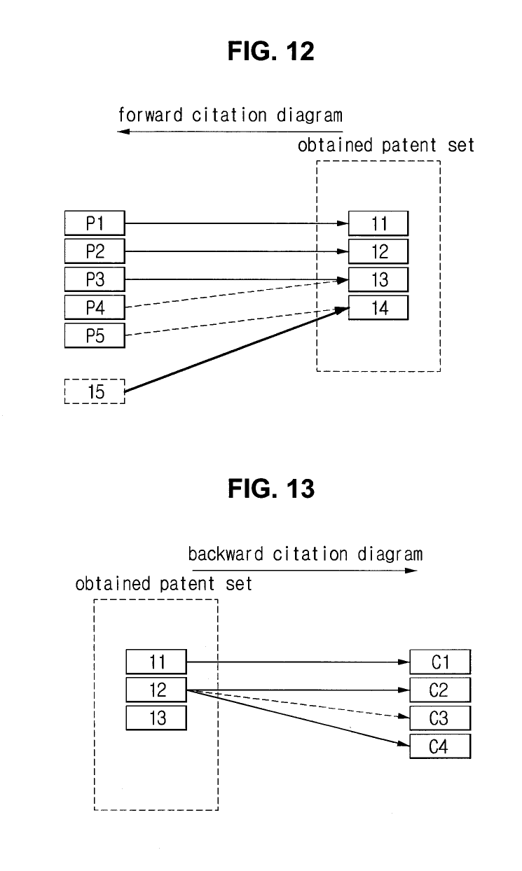

In FIG. 11, patents I1 to I6 constitute obtained patent set. The patent I1 cites the patent P1, the patent I2 cites the patent P, the patent I3 cites the patents P3 and P4, the patent I4 cites the patent P5 and the patent I4 which belongs to the obtained patent set, the patent I4 cites the patent I5, and the patent I5 cites the patent I6. On the other hand, the patent I1 is cited by a patent C1, and the patent I2 is cited by patents C2 to C4. At this time, with respect to the citation patent set I1 to I6, the patents P1 to P5, I5 and I6 become a forward cited patent set, and the patents C1 to C4, I4 and I5 become a backward cited patent set. As shown in FIG. 12, in a case where the citation patent set is limited to the patents I1 to I4, the forward cited patent set includes the patents P1 to P5 and I5. On the other hand, as shown in FIG. 13, in a case where the citation patent set is limited to the patents I1 to I3, the backward cited patent set includes the patents C1 to P4.

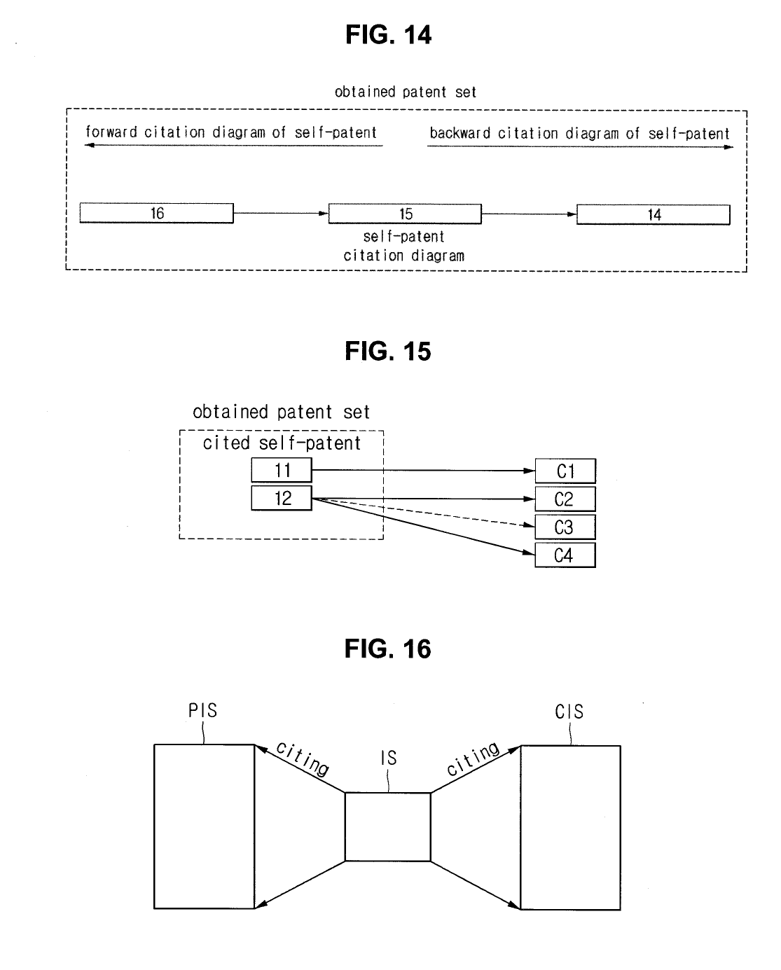

FIG. 14 shows a concept of a self-citation diagram. The patents I4 to I6 belong to an obtained patent set. In view of the patent I4, the patent I5 is a forward cited patent, and the patent I6 is a forward cited patent having a depth of 2. In view of the patent I5, the patent I6 is a forward cited patent, and the patent I4 is a backward cited patent. In view of the patent I6, the patent I5 is a backward cited patent, and the patent I4 is a backward cited patent having a depth of 2. Accordingly, in a case where the obtained patent set is limited to the patents I1 to I4, the patent I5 becomes a forward self-cited patent set having a depth of 1, and the patent I6 becomes a forward self-cited patent set having a depth of 2. In the forward self-cited patent set, where the patentees of the patents I1 to I6 are identical, since the patents I5 and I6 constituting the forward self-cited patent set have the same patentees, the patent I5 and/or the patents I6 and I4 may be similar technology. Since the patent I4 may be a technology which is obtained by improving the patents I5 and/or I6, it is possible to know a tendency of a technology development which is achieved by a specific patentee. Likewise, this is applied to the backward self-cited patent set. That is, the patents relating to the forward self-cited patent set and the backward self-cited patent set have a strong relationship with respect to a patent included in the cited patent set, and become a symbol of a continuation, an improvement, an extendibility, and inclusion with relation to the patent portfolio of the patentee. The cited patent set is shown in view of the patentee. It may be similar to limit the cited patent set by each inventor, or to limit the cited patent set by each patent classification (indicating a technical field). That is, a patent of a specific inventor belonging to the cited patent set, and patents of the same inventor among the patents relating to the cited and obtained patent set and the backward self-cited patent set may be a symbol of a technology development, a continuation of research, and the like, in view of the inventor. The obtainment of this result is a specific effect of the citation analysis by the set unit of the present invention.

Continuously, the cited and obtained patent set will be described. The cited and obtained patent set is comprised of a group of patents which are cited more than one time, among the patents constituting the obtained patent set. The patents I1, I2, I4 and I5 among the patents constituting the cited patent set constitute the cited and obtained patent set. On the other hand, when the patent belonging to the obtained patent set which constitutes the cited and obtained patent set is excluded from the cited and obtained patent set, the defined cited and obtained patent set is generated. If the patentees of the patents I1 to I6 are identical and the applicants of the patents C1 to C4 are different from the patentees of the patents I1 to I6, the patent I2 is one which is most cited by other patentees, and may have a high possibility that it becomes an important patent among the cited and obtained patent set. A person who invents the important patent may have the possibility of being an important inventor.

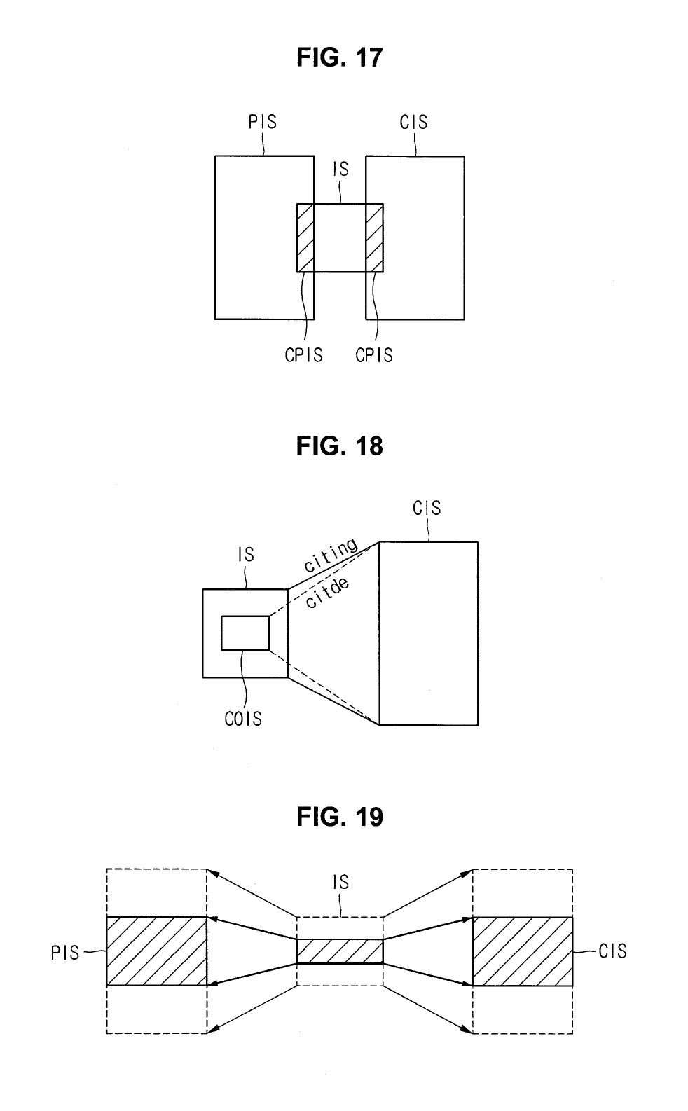

Continuously, the obtained self-patent set, cited patent set, forward cited patent set, backward cited patent set, forward self-cited patent set, backward self-cited patent set, and cited and obtained patent set will be described with reference to FIGS. 16 to 20. In FIG. 16, an Input Set (IS) means the cited patent set, a Parent of Input Set (PIS) means the forward cited patent set, and a Child of Input Set (CIS) means the backward cited patent set. In FIG. 17, a Cross-over Parent of Input Set (CPIS) means the forward self-cited patent set, and a Cross-over Child of Input Set (CCIS) means the backward self-cited patent set. The patents which belong to the CPIS and CCIS also belong to the IS. FIG. 18 shows a Citation Occurred IS (COIS) which means the cited and obtained patent set. There is a characterization that the backward cited patent set relating to all patents which belong to the IS is identical to the backward cited patent set relating to all patents which belong to the COIS.

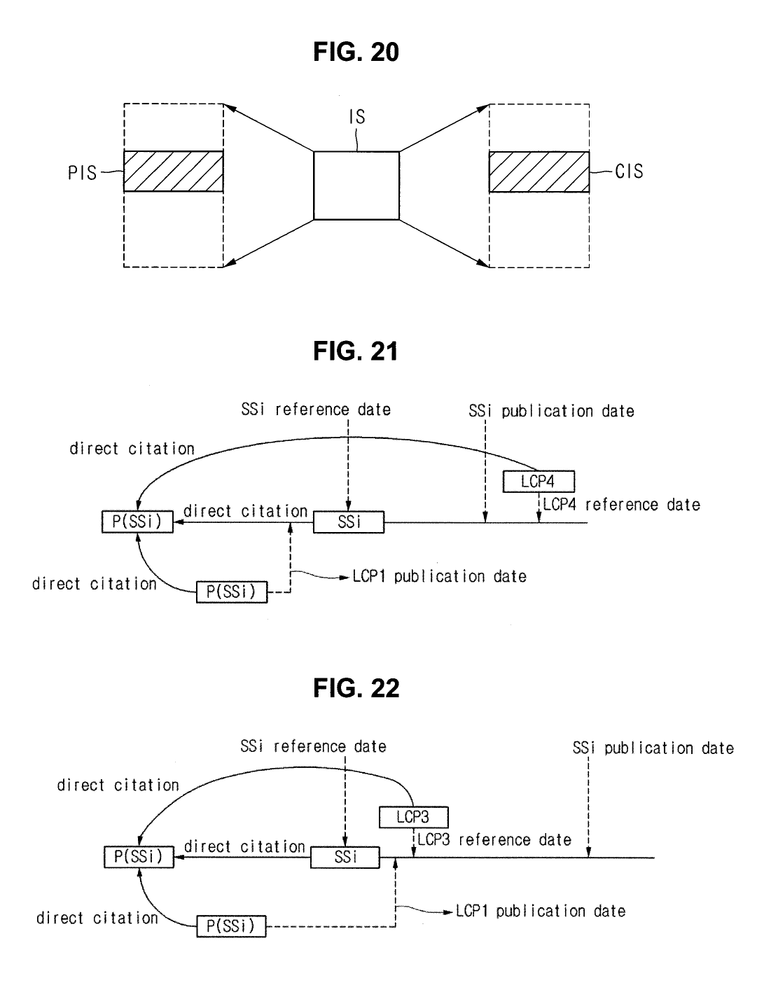

FIGS. 19 and 20 show an example of the cited and obtained patent set, in which a definition occurs. This definition can be equally applied to the cited patent set which is generated through the indirect citation, the latent citation, and the chain citation as well as the direct citation. When a specific definition is applied to the obtained patent set IS, a Specified Input Set (SIS) is generated. A Parent of Specified Input Set (PSIS) which is the defined forward cited patent set and a Child of Specified Input Set (CSIS) which is the defined backward cited patent set are generated with respect to the SIS. In FIG. 20, in a case where a predetermined definition is performed with respect to the forward cited patent set and the backward cited patent set when the forward cited patent set and the backward cited patent set are generated with respect to the obtained patent set IS, a Specified Parent of Input Set (SPIS, after a forward cited patent set is firstly generated, a specification is applied to the forward cited patent set) which is a sort of the defined forward cited patent set and a Specified Child of Input Set (SCIS) which is a sort of the backward cited patent set are generated.

The definition is performed through the option selection unit 4340. FIG. 5 shows a presence of the option selection unit 4340. The definition includes a term definition, a nation definition, an applicant definition, an inventor definition, a patent classification definition, a field property definition, an individual field value definition, an individual patent property value definition, and other definitions. The term definition is selected by “from ˜ to ˜”, and a basis of the term includes an application date, a publication date, a registration date, and the like. The nation definition may include a nation denoted in a priority application (a nationality of the patentee), and a nationality of an inventor (denoted in an address of the inventor). A status indicates a present condition of a patent including a publication, a registration, invalidity, expiration, and the like. In a case of the patent classification, the definition includes a selection of a patent classification type from the IPC, the USPC, the FT, the FI, and the ECLA, a selection of a main patent classification or a sub patent classification, and a selection of a depth (in a case of the IPC, section, class, subclass, main group, 1 dot sub group, n dot sub group, and the like). On the other hand, a numerical value for each field, such as a number of common inventors, a number of common applicants, cited times, a number of patent classifications, a patent grade, a patent score, and the like, which are measured, calculated, or obtained with relation to the individual patent, may be selected.

The definition includes the term definition, the nation definition, the patentee definition, the inventor definition, the patent classification definition, and the like, which are respectively performed by a term definition unit 4341, a nation definition unit 4342, an applicant definition unit 4343, an inventor definition unit 4344 and a patent classification definition unit 4345. When an applicant and the like are defined, the patent information system shows a list of rightful persons included in the obtained patent set, and allows a user to select at least one rightful person. In a case of the inventor definition and the patent classification definition, the definition is similarly performed in the above-mentioned manner.

Continuously, a specific definition will be described. Firstly, the field property definition will be described. For example, when a specific rightful person is classified as a patent troll or a competing company, the patent troll or the competing company becomes a specific field property. In a case where a patent of the rightful person who is classified as the patent troll is cited, this is important because a patent dispute or a requirement of a license increases. The rightful person belongs to a field to which the applicant belongs, and the property of the applicant field includes a property of the patentee (the university, the research institution, the enterprise), a scale of the patentee (a large enterprise, a small and middle enterprise), a property of the patentee (an enterprise having many applications, an enterprise having a plurality of core patents, an enterprise having a high quality index of patent) as well as the patent troll or the competing company (this patent troll or the competing company can be processed in correspondence to each specific user and designated to each user). It is obvious that various properties may be given to the inventor like the patentee. The definition of the field property is carried out by the field property definition unit of the present invention. On the other hand, when the field property is present as a value, the definition is carried out by an individual field value definition unit of the present invention. On the other hand, with relation to the self-patent set SS, a field value such as more than two applicants, more than three inventors, more than two patent classifications, more than five times cited, and the like is defined to each individual field so that a group of patents satisfying a defined condition may be extracted. These definitions are carried out by an individual patent property value definition unit. On the other hand, when other definitions are present, these definitions are performed by other definition unit of the present invention. The definitions are generally carried out by the option selection unit 4340.

The definitions are performed for both the obtained patent set and the cited patent set. With the generation of the obtained self-patent set, in a case where first obtained set is obtained and itself processed to the obtained patent set, the first obtained set will be defined. Furthermore, with the generation of the cited patent set, in a case where a first object patent set is generated, the first object patent set will be defined. The performance of the definition is well shown in FIGS. 19 and 20. FIG. 19 shows a case where the forward cited patent set for the defined and obtained patent set is defined rather than the forward cited patent set for the obtained patent set which is not defined, and the backward cited patent set for the defined and obtained patent set is defined rather than the backward cited patent set for the obtained patent set which is not defined, when the obtained patent set is additionally defined. On the other hand, FIG. 20 shows a case where the forward cited patent set and the backward cited patent set are defined to generate the forward cited patent set and the backward cited patent set which are defined, when the forward cited patent set and the backward cited patent set are generated with respect to the obtained patent set. There is a keyword definition as a special definition. That is, in a case where a core keyword is extracted from each patent, the patent set can be defined by a keyword related condition in a manner of including or excluding at least one specific keyword.

Continuously, the latent citation will be described in more detail with reference to FIGS. 21 and 22. The latent citation patent includes a first latent citation patent and a second latent citation patent.

The first latent citation patent refers to a citation patent which can be publicized and obtained on a predetermined reference date of a self-patent, or a self-patent which can be publicized and obtained on a predetermined reference date of the citation patent, in which the citation patent and the self-patent are included in patents having a parent patent, i.e. P(SSi), a patent which is directly citied by SSi, identical with that of the self-patent (SSi), and have no direct citation relation to each other. The first latent citation patent refers to patents LCP1 and LCP4 shown in FIG. 21. In order to seek a first forward latent citation patent LCP1 among the first latent citation patent, it is preferable to seek a patent which has a publication date prior to an application date of the self-patent, among the patents citing the patent set (including indirect cited patents having a citation depth of 2 as well as direct cited patents having a citation depth of 1) which are cited by the self-patent. In order to seek a first backward latent citation patent LCP4 among the first latent citation patents, it is preferable to seek a patent which is applied after a publication date of the self-patent, among the patents citing the patent set (including indirect cited patents having a citation depth of 2 as well as direct cited patents having a citation depth of 1) which are directly cited by the self-patent.

The second latent citation patent refers to a citation patent which cannot be obtained because it is not publicized on a predetermined reference date of a self-patent, or a self-patent which cannot be obtained because it is not publicized on a predetermined reference date of the citation patent, in which the citation patent and the self-patent are included in patents having a parent patent, i.e. P(SSi), a patent which is directly citied by SSi, identical with that of the self-patent (SSi), and have no direct citation relation to each other. The second latent citation patent refers to patents LCP2 and LCP3 shown in FIG. 22. In order to seek a second forward latent citation patent LCP2 among the second latent citation patent, it is preferable to seek a patent which has an application date prior to and a publication date later than an application date of the self-patent, among the patents citing the patent set (including direct cited patents having a citation depth of 1 as well as indirect cited patents having a citation depth of 1) which are directly cited by the self-patent. In order to seek a second backward latent citation patent LCP3 among the second latent citation patents, it is preferable to seek a patent which has an application date later than an application date of the self-patent and prior to a publication date of the self-patent, among the patents citing the patent set (including direct cited patents having a citation depth of 1 as well as indirect cited patents having a citation depth of 1) which are directly cited by the self-patent.

Preferably, the predetermined reference date is defined by the application date. Strictly, the reference date corresponds to a date of each reference cited by the self-patent, for example, an input date in a case where an examiner inputs references, and a prior art searching date in a case where a prior art search report is input. On the other hand, in a case of the United States which has the IDS provision, a submission date of each reference may be different. In fact, it is difficult to know the submission date of each reference through data. On the other hand, in a case where the application date is defined as the reference date, when an international application under the PCT enters a national stage, an international application date is generally regarded as a filing date in the national stage. However, in a case of the international application, it is further preferable to define the reference date as the filing date in the national stage.

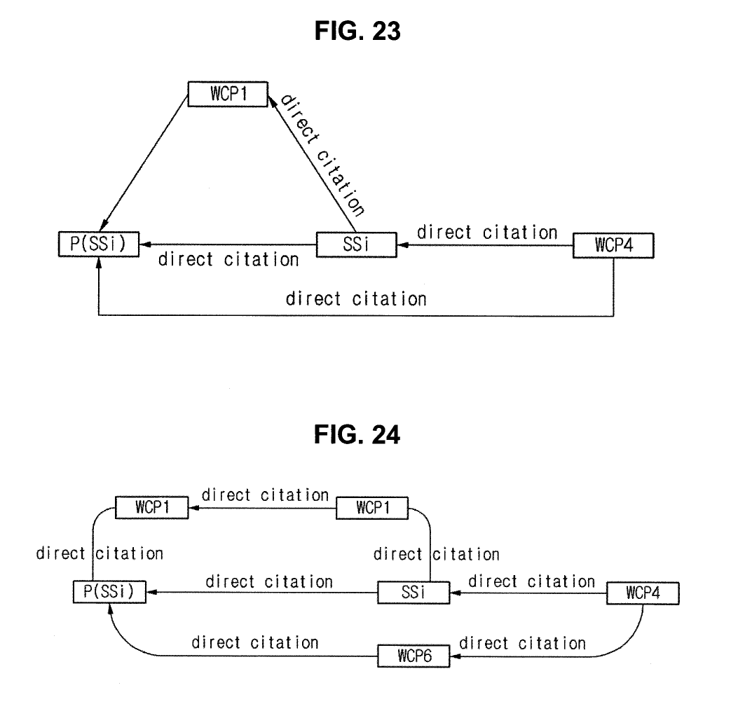

Continuously, the chain citation patent will be described in more detail with reference to FIGS. 23 and 24. The chain citation patent includes a first chain citation patent and a second chain citation patent.

The first chain citation patent refers to a patent, i.e. WCP1, which a direct citation patent cites and has a parent patent identical to that of a self-patent, among the direct citation patents (including direct citation patents having a citation depth of 1 and indirect citation patents or latent citation patents having the citation depth of 2) cited by the self-patent SSi, and a patent, i.e. WCP4, which is cited by the direct citation patent and has a parent patent identical to that of the self-patent, among the direct citation patents which directly cite the self-patent SSi. The first chain citation patent is well shown in FIG. 23.

The second chain citation patent refers to a patent WCP2 which is directly cited by a self-patent SSi and a directly cited patent WCP3 which is directly cited by the self-patent SSi and has at least one citation depth, in a case where the patent WCP3, which is directly cited by the patent WCP2 (including indirect citation patents or latent citation patents having a citation depth of 2 as well as a citation depth of 1) which is directly cited by the self-patent SSi, and has at least one citation depth, has a parent patent P(SSi) identical to that of the self-patent SSi. On the other hand, in a case where a patent WCP6, which is directly cited by a patent WCP5 directly citing the self-patent SSi and has at least one citation depth, has a parent patent P(SSi) identical to that of the self-patent, the second chain citation patent refers to the patent WCP5 which directly cites the self-patent SSi and the patent WCP6 which is directly cited by the patent WCP5 directly citing the self-patent and has the at least one citation depth.

In order to seek the chain citation patents by using only directly cited patents, chain citation patent set is constituted with the self-patent and the patents which are directly cited by the self-patent. Then, patents having a citing-cited relation are extracted from the chain citation patent set. Among the extracted patents, patents having a filing date prior to that of the self-patent become forward patents and patents having a filing date later than that of the self-patent become backward patents. On the other hand, among the extracted patents, patents which cite the self-patent or are cited by the self-patent become the first chain citation patent, and patents which have no direct citation relation to the self-patent become the second chain citation patents. In order to seek the chain citation patents by using only the indirect citation patents, chain citation patent set is constituted with the self-patent and the indirect citation patent and is processed in an identical information processing manner. On the other hand, in order to seek the chain citation patents by using only the latent citation patents, a chain citation patent set is constituted with the self-patent and the indirect citation patent and is processed in an identical information processing manner. On the other hand, chain citation patent set is constituted with at least two of the self-patent, the direct citation patent, the indirect citation patent and the latent citation patent and may be processed in an identical information processing manner.

With all patents relating to the citation, the forward and backward patents are preferably determined on the basis of the filing date of the self-patent and the citation patents. However, the forward and backward patents may be determined on the basis of the earliest date (in a case of a priority claiming application, a priority date is the earliest date, and in a case of a non-priority claiming application, a general filing date is the earliest date).

Continuously, the family citation patent of the present invention will be described. A family citation means that all patents having the family relation to the cited patent are intended to be cited when any one of patents which has a family relation is cited. That is, when a patent Pi cites references R1, . . . , Ri, and Rn, and patents FRi1, . . . , FRij, and FRin having a family relation to the reference Ri, the patents FRi1, . . . , FRij, and FRin and the patent Pi are regarded as having a citatory relation. In a case where the patent Pi cites the patent Ri, the patents Ri, FRi1, . . . , FRij, and FRin have significantly similar contents (especially, in a case of a divisional application, a foreign family application, CP, or CIP, the applications have substantially similar contents). Of course, the family citation relating to the divisional application or the foreign family is classified into a first family citation, and the family citation relating to the CP/CIP is classified into a second family citation. Accordingly, there is a high possibility that the patent Pi may have contents similar to the patents FRi1, . . . , FRij, and FRin. Therefore, it is difficult to deny that there is a reference relation in content between the patent P1 and the family patents FRi1, . . . , FRij, and FRin although only the patent Ri is input by a reference inputter. As a result, an introduction of the family citation is necessary. At this time, in a case where the patent Ri is included as a reference in the patent Pi, it is processed that the patents FRi1, . . . , FRij, and FRin are included in the family parent patents cited by the patent P1, and the patent Pi is included in the family child patents of the patents FRi1, . . . , FRij, and FRin which are have a family relation with the patent Ri. When these family citations are introduced, the citation becomes more substantial than that which could be made by the reference inputter, and the relation between the patents becomes more factually identifiable.

As indicated in Table 1 relating to the citation in the present invention, a prediction element (candidate) value for each prediction element (candidate) may be made to correspond to at least one of the direct citation, the indirect citation, the latent citation, the chain citation, and the family citation. Further, each prediction element can be subdivided to correspond to each depth of the indirect citation and/or each of the latent citation, the chain citation, and the family citation. On the other hand, when the prediction element is not subdivided, it is possible for the user or a manager of the patent information system 10000 to select a range of the depth of the indirect citation and a sort of the latent citation which is used in the generation of the prediction model.

When a self-patent set SS is specified by the user or the patent information system 10000, a patent set formed with a group of patents which are cited by the patent included in the patent set may be a prior application patent set, and patents satisfying a specific condition (patents filed within the last 3 years or including a certain applicant or patent classification, among patents citing the patents included in the patent set) may become the prior application set. A temporary combination of patents in which a registered patent is included in the prior application patent set becomes a group of the prior application patents. A patent set formed of a patent group citing the patents included in the patent set or a patent group satisfying a specific condition and citing the patents included in the patent set may be a later application patent set (child set). A temporary combination of the patents included in the later application patent set becomes the later application patent group. The dispute prediction element value can be generated to correspond to each of the self-patent set, the prior application patent set, or the later application patent set. In a case where the self-patent set B is the later application patent set of the patent set A, the patent set A becomes a self-set, and the self-patent set B becomes a child set. In a case where the self-patent set B is a prior application patent set of the patent set C, the patent set C becomes a self-set, and the self-patent set B becomes a parent set. On the other hand, with a characteristic of the citing-cited relation, if the self-patent set B is the later application patent set of the patent set A, the patent set A is not necessibly the parent set of the self-patent set B. Generally, the patent set A becomes a part of the parent set of the self-patent set B.

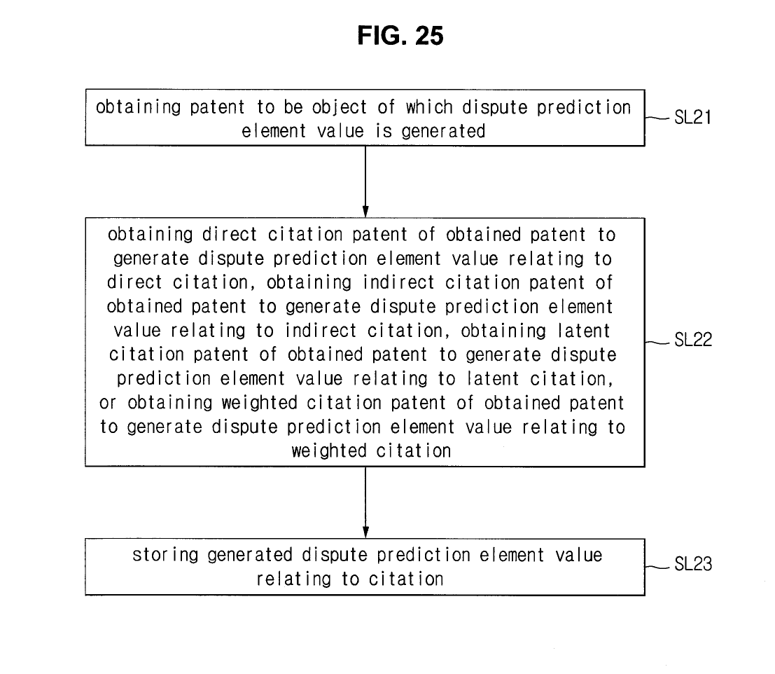

FIG. 25 is a flowchart illustrating an exemplary embodiment of a process of generating the dispute prediction element value for each of the citation and dispute prediction elements, in which an example of generating the prediction element value with relation to Table 1 is shown. A dispute prediction element value generating unit 5510 obtains a patent to be an object for which a dispute prediction element value is generated in step SL21. Then, the dispute prediction element value generating unit 5510 obtains a direct citation patent of the obtained patent to generate a dispute prediction element value with relation to the direct citation, obtains an indirect citation patent of the obtained patent to generate a dispute prediction element value with relation to the indirect citation, obtains a latent citation patent of the obtained patent to generate a dispute prediction element value with relation to the latent citation, obtains a family citation patent of the obtained patent to generate a dispute prediction element value with relation to the family citation, or obtains a chain citation patent of the obtained patent to generate a dispute prediction element value with relation to the chain citation in step SL22. Finally, the generated dispute prediction element value with relation to the citation is stored in step SL23. Likewise, with respect to an evaluation element value, an evaluation element value generating engine obtains a patent to be an object for which the evaluation element value is generated, and obtains a direct citation patent of the obtained patent to generate the evaluation element value with relation to the direct citation, obtains an indirect citation patent of the obtained patent to generate the evaluation element value with relation to the indirect citation, obtains a latent citation patent of the obtained patent to generate the evaluation element value with relation to the latent citation, obtains a family citation patent of the obtained patent to generate the evaluation element value with relation to the family citation, or obtains a chain citation patent of the obtained patent to generate the evaluation element value with relation to the chain citation. Then, the generated evaluation element value relating to the citation can be stored.

The reason that the citation and prediction elements indicated in Table 1 are important is as follows. Dispute patents have a strong citatory relation. The dispute patents are relatively and significantly cited more often than non-dispute patents, and there is a trend in that a citation of the dispute patents increases. Especially, there are many cases where a dispute counterpart patent and a defendant's patent have a strong citatory relation. That is, cases where the dispute counterpart patent is cited by the patent of the defendant are much more common than cases where a non-dispute patent is cited by the patent of the defendant. This citatory relation can be known by obtaining and analyzing bibliographic details such as owner (applicant) information of later application patents citing the dispute counterpart patent. The reason that the citatory relation plays an important role with relation to the dispute counterpart is because 1) there is a strong trend in that the patents are reflected in products, and there are many cases where the later application owner files a patent application relating to functions of the products in order to protect the functions of the products (particularly, improved functions), 2) a patentee of a later application recognizes a patent of a former application owner and summits the patent as an IDS, or the patent is listed as a patent related to the later application patent in the reference during a prior art search or an examination of an examiner in a patent office, 3) the former application owner monitors the later application citing the owner's patent, and 4) the patent of the former application owner which is significantly cited by the later application owners is reflected in the products of the later application owners, or has a strong relation. Especially, where the patent of the former application owner has a wide scope of claims, there is a trend as described above. Accordingly, the citation relation has a significant relation to the dispute. According to the relation between the patent dispute and the citation as described above, a group of citation relating dispute prediction elements can be developed for the purpose of a dispute prediction or a licensing prediction, as indicated in Table 1. With relation to a patent value, since the patent with a high value is cited by a great number of patents, the citation and the value of the patent have a close relation with respect to the evaluation of the patent. Therefore, according to the relation between the highly valuable patent and the citation, a group of patent evaluation elements relating to the citation can be derived, as indicated in Table 1.

Table 2 indicates description parameters relating to plural disputes and bibliographic and periodic information below.

TABLE 2

| | affiliation | | |
|---|---|---|---|
| affiliation | code | Description in view of multi-dispute causing patent | remark |
| Total | A2 | Number of re-disputes (number of related disputes- | |
| number | | 1), number of family, number of changed owners, or | |
| | | number of non-inventors or assignees | |
| Number for | B2 | A2 for late n years (i.e, number of re-disputes for | |
| late n years | | late n years, number of family patents for late n years, | |
| | | number of changed owners for late n years, number of | |
| | | changed non-inventor or assignees for late n years) (n ≧ 1) | |
| Variation | C2 | Variation of A2 and B2 for whole period, variation | |
| or variation | | ratio of A2 and B2 for specific period | |
| ratio | | | |
| case | D2 | Reissue patent, foreign patent, troll patent | |
| Bibliographic | E2 | Number of application claims, number of registered | |
| detail | | claims, number of drawings, pages, number of patent | |
| | | classifications, number of different patent classifications | |
| | | on basis of level of specific patent classification, number | |
| | | of co-applicants, number of co-inventors, necessary time | |
| | | for registration, right maintenance term, number of foreign | |
| | | inventors, ratio of foreign inventors, number of priorities, | |
| | | registration maintenance term | |
| Standard | E2 | Participation in standard patent pool, number of | |
| pool or | | standard patent pools in which patent is included, number | |
| related pool | | of related pools in which patent is included | |
| Multi- | F2 | Frequency of disputes, frequency of related | |
| dispute | | disputes, number of related patents per dispute, total | |
| | | number of defendants, number of defendants per related | |
| | | dispute | |
| Variation of | G2 | Variation of F2 for late n years, variation ratio of F2 | |
| Multi-dispute | | for whole period, variation ratio of F2 for specific period | |
| Distribution | H2 | First dispute year, late dispute year, year of large | |
| of disputes | | frequency of dispute | |
| Lapse | I2 | Filing of request of trial in each trial type, frequency | |
| information | | of trial filings for each trial type, filing of a request of | |
| | | accelerated examination, term between filing date of | |
| | | application and filing date of request of examination, term | |
| | | between filing date of application and registration date | |

The dispute patent set includes a patent which causes a plurality of disputes and is present in a patent dispute several times, as a plurality of dispute patents causes the dispute two or more times. The dispute is not caused evenly in all the registered patents, but rather a small number of dispute counterpart patents are involved in the dispute. Particularly, a small number of patents cause the plural disputes. The patents causing the plural disputes can be recognized by analyzing patent dispute information. The dispute patents are obtained with respect to each patent dispute case, and patent Nos. relating to the patent dispute is obtained. Then, when the patent No. is indicated in more than a predetermined number of related disputes, the corresponding patent becomes a patent causing the plural disputes. These dispute incurring patents become first multiple dispute causing patents.

On the other hand, even though dispute does not occur, patents having a high possibility of dispute are present. For example, there are at least one patent group which the patent troll, a child company of the patent troll, and a related company manage, at least one patent included in a standard patent pool, and patents or new patents (newly included patents can be known by identifying current assignee information) included in a patent group which plural dispute causing owner maintains. The above-mentioned patents are referred to as second plural dispute causing patents.

On the other hand, a reissue patent, a patent having a plurality of family patents, a patent having an increased number of family patents, a patent which is cited a plurality of times, and a patent having a highly increasing ratio of cited times are referred to as third plural dispute causing patents.

On the basis of an individual patent, according to whether respective dispute prediction elements correspond to the first, second, and/or third plural dispute causing individual patents in view of the plural dispute causing patents, a dispute prediction element value can be generated in view of the plural dispute causing patent. When the individual patent corresponds to the reissue patent, the dispute prediction element value becomes 1. Otherwise, when the individual patent is not the reissue patent, the dispute prediction element value becomes 0. However, most dispute prediction element values may not be 0 and 1 but other values (in a case of a patent having a plurality of family patents, the value is indicated by an integral number, and in a case of a patent having a highly increasing ratio of cited times, the value is indicated by a rational number). On the basis of not the individual patent but a patent group, where the respective dispute prediction elements correspond to the first, second, and/or third plural dispute causing patents in view of the plural dispute causing patents, the dispute prediction element values can be generated. That is, in a case of the plural dispute causing patent group including the n number of patents, a dispute prediction element value is generated to correspond to each dispute prediction element in view of the plural dispute causing patents of the n number of patents. At this time, the generated dispute prediction element value may include any one of a count value (added value), an average value (an arithmetic average value, a geometric average value), and a predetermined functional value. For example, in a case of a patent group including one hundred patents, if the number of reissue patents is ten, “ten” is a count value. On the other hand, even though the number of reissue patents identically is ten, as the total number of patents n becomes smaller, the relative portion of reissue patents increases. That is, a density of the reissue patent value increases. The increased density increases a possibility that the patent group relates to dispute. On the other hand, the density may be measured to obtain an average value.

Further, it is obvious that the dispute prediction element candidate value can be generated to correspond to each of the first, second, and third plural dispute causing patents, or each of the first, second, and third plural dispute causing patent groups, in view of the citation.

On the other hand, the dispute incurring patents can be mostly commercialized, or the technical contents of the patents can be implemented in products. Accordingly, it is possible for the patents to relate to a royalty or damages, thereby increasing the value of the patents. Accordingly, in the evaluation of the patent, the prediction elements may be an important description parameter in view of the plural disputes and bibliographic/periodic information as indicated in Table 2.

Table 3 shown below exemplarily indicates the description parameter in view of owner.

TABLE 3

| | affiliation | Description parameter in view of | |
|---|---|---|---|
| affiliation | code | multi-dispute causing person | remark |
| Relation of | A3 | Frequency of dispute in which owner participates, | |
| multi- | | number of total patents which owner maintains with | |
| dispute | | relation to dispute, a ratio of dispute patent to total patents | |
| institutor | | of owner | |
| Relation of | B3 | Frequency of dispute in which owner is accused, ratio of | |
| multi- | | accusation frequency to accused frequency in dispute to | |
| dispute | | which owner relates | |
| experienced | | | |
| person | | | |
| Participant | C3 | Number of patents of owner which participates in | |
| relation of | | standard pool, number of patents of owner which does not | |
| standard | | participates in standard pool, ratio of patents in standard | |
| pool | | pool to owner's total patents | |
| Number for | D3 | A3 to C3 for late n year | |
| late n years | | | |
| Variation or | E3 | Variation of A3 to C3 for late n years, variation ratio of A3 | |
| variation | | to C3 for late n years | |
| ratio | | | |
| Relation of | F3 | If owner is troll or not. | |
| registered | | | |
| troll | | | |
| Owner's | G3 | if owner is company, institution, university, person, large | |
| property | | enterprise, or foreign enterprise | |
| Owner's | H3 | Total number of application claims, number of claims per | |
| patent | | patent application, the number of claims per person, total | |
| portfolio | | number of registered patents, total number of registered | |
| property | | claims, patent registration ratio, total number of effective | |
| | | patents, residual ratio of effective patents, average | |
| | | residual time of effective patents, citation index per patent, | |
| | | technical effective index, technological capability index, | |
| | | technological progress measurement index, Innovation | |
| | | Speed Index (ISI), scientific relation, scientific capability | |
| | | index, scientific linkage index, International Knowledge | |
| | | Flow (IKF), technological dependence, technological | |
| | | independence, ratio of co-application, number of co- | |
| | | applicant | |

At least one owner causing plural disputes can be extracted by obtaining patent dispute information and applying various conditions such as a predetermined frequency, a predetermined increasing rate, and the like with relation to an owner or a plaintiff of a patent included in the patent dispute information. The multi-dispute causing owner which is extracted by analyzing the dispute information is referred to as a first multi-dispute causing owner. On the other hand, the patent troll or an owner who retains more than a predetermined number of patents in at least one patent pool, or a patent satisfying a predetermined condition (number, increasing rate) is referred to as a second multiple-dispute causing owner. An owner who retains patent groups respectively having a weight of a reissue patent, a weight of a multiple family patent, a weight of a multiple family increased patent, a weight of a multiple cited patent, a weight of an increasing cited rate patent among patents of patent groups determined under an entire patent portfolio of the owner, a specific period or a specific condition is referred to as a third multiple dispute causing owner.

In a case of a patent set including n number of patents, at least one of a count value, an average value and a predetermined function value of a patent, which is retained by the multi-dispute causing owner, among the n patents may be a dispute prediction element value in view of the multi-dispute causing owner. For example, in a case of a patent group including one hundred patents, if the number of patents which are retained by a multi-dispute causing owner named AA is ten, “ten” is a count value. On the other hand, even though the number of patents which are retained by a multi-dispute causing owner identically is ten, as the total number of patents n becomes smaller, the relative portion of patents retained by the multi-dispute causing owner increases. That is, a density of the patents relating to the multi-dispute causing owner increases. The increased density increases a possibility that the patent group relates to dispute. On the other hand, the density may be measured to obtain an average value.

Further, the dispute prediction element candidate value may be generated with respect to each of a patent group including all patents of the first, second and third multi-dispute causing owners and a patent group satisfying predetermined conditions (a specific term, a specific patent classification, a certain keyword, and other conditions).

On the other hand, since the owners relating to the multi-disputes have a possibility of retaining plural patents relating to a dispute, most patents which are retained by the owners can be commercialized, or a production of the technical contents can be implemented. Further, since the patents have a possibility of relating to royalty or damages, the value of the patents increases. Especially, most disputes do not reach legal proceedings and are resolved in a negotiation step through a warning. The patent of the multi-dispute causing owner may include a plurality of patents which do not cause dispute, and thus is not classified into as a dispute patents, and is cross-licensed with relation to royalty, among patents of the multi-dispute owner. Accordingly, in the evaluation of the patent, the prediction elements may be an important description parameter in view of the multi-dispute owner as indicated in Table 3.

Table 4 shown below exemplarily indicates the description parameter in view of a technical group.

TABLE 4

| | affiliation | | |
|---|---|---|---|
| affiliation | code | Description in view of multi-dispute technology group | remark |
| Relation | A4 | Frequency of dispute incurrence in each patent | |
| of multi- | | classification, number of dispute patents in each patent | |
| dispute | | classification, number of dispute institutors in each patent | |
| technology | | classification, number of the accused in dispute of each | |
| group | | patent classification, ratio of dispute incurrence | |
| | | frequency to all patents in each patent classification, ratio | |
| | | of number of dispute patents to all patents in each patent | |
| | | classification, ratio of dispute institutors to all patents in | |
| | | each patent classification, ratio of dispute accused | |
| | | persons to all patents in each patent classification | |
| Multi- | B4 | Frequency of dispute incurrence in each patent | |
| technique | | classification in owner's patent group, number of dispute | |
| group | | patents in each patent classification in owner's patent | |
| relation in | | group, number of dispute institutors in each patent | |
| patent | | classification in owner's patent group, number of the | |
| group | | accused in dispute of each patent classification in | |
| which | | owner's patent group, ratio of dispute incurrence | |
| owner | | frequency to all patents in each patent classification in | |
| maintains | | owner's patent group, ratio of number of dispute patents | |
| | | to all patents in each patent classification in owner's | |
| | | patent group, ratio of dispute institutors to all patents in | |
| | | each patent classification in owner's patent group, ratio | |
| | | of dispute accused persons to all patents in each patent | |
| | | classification in owner's patent group | |
| Portfolio | C4 | Occupation ratio in owner's patent classification, | |
| property in | | convergence ratio in owner's patent classification, activity | |
| owner's | | ratio in owner's patent classification, H3 in owner's patent | |
| technical | | classification, average maintenance term per patent | |
| field | | registration in owner's patent classification | |
| Number | | A4 to C4 for late n years | |
| for late n | | | |
| years | | | |
| Variation | | Variation of A4 to C4 for late n years, Variation ratio of | |
| or variation | | A4 to C4 for late n years | |
| ratio | | | |
| Technology | | Economical life of technology | |
| group | | | |
| property | | | |

In Table 4, a patent classification may be at least one, or a combination of at least two of each of patent classification types, i.e. IPC, USPC, and the like, each of patent classification depth (in a case of the IPC, class, subclass, main group, n dot subgroup, and the like), each of main patent class, and each of all patent classifications. On the other hand, in FIG. 4, a restricted patent classification reference of a patent group which is retained by the owner refers to a dispute prediction element which is generated with respect to only the patent classification included in the patent group which the owner of a specific patent Pi retains. For example, in a case where an owner A retains m number of patents belonging to a patent classification C1, and n number of patents belonging to a patent classification C2, the dispute prediction element values corresponding to the B4 respectively are processed for m and n. In a case where two of m patents of the owner A are present in dispute, and one of n patents is present in dispute, a dispute prediction element value, which is the number of dispute patents in a restricted patent classification for the patent group which is retained by the owner A, becomes 2 for C1, and 1 for C2. A dispute prediction element value, which is a ratio of dispute patents to all patents in the restricted patent classification for the patent group which is retained by the owner A, becomes 2/m for C1 and 1/n for C2.

A multi-dispute technique group exists. Further, multi-dispute technique group and a non-dispute technique group exist on the basis of a patent portfolio which is retained by the owner. The patent portfolio of the owner may be different in the technique group, and a subjective importance of the owner may be different. Since the owner generally can retain two or more patents with respect to two or more technique groups, i.e. patent classifications, the presence or absence of dispute, the number of present disputes, and the like are different with relation to each patent included in each technique group.

For example, it is known through patent dispute information in USA that patent disputes between the patents belonging to the IPC G06F and A61K among the patent classifications are more significantly incurred in comparison with other patent classifications. The dispute causing patent includes at least one kind of patent classification. The patent classification is processed so as to extract at least one multi-dispute technique group. The multi-dispute technique group may belong to the IPC, the USPC, or a patent classification included in patent bibliographic details. On the other hand, with relation to a layered structure of a patent classification system, multi-dispute technique group information can be generated for each layer. For example, in a patent classification of H04B 7/26, parent of H04B 7/26 (2 dot subgroup) sequentially corresponds to H04B 7/24 (1 dot subgroup), H04B/7/00 (main group), H04B (subclass), H04 (class), and H (section) in a system of the patent classification. Accordingly, at least one patent classification of most significant frequency can be extracted from each layer such as n dot subgroup, main group, subclass, class, and the like, on the basis of the patent classification of the disputted patent group. At this time, it can be changed by a setting of the system or a selection of a user whether the patent classification of the most significant frequency is extracted from only the main classification, or from the main classification and the sub classification. Of course, it may be changed by the setting of the system or the selection of the user whether any depth (the depth is different according to the patent classification system, for example n dot subgroup of a section in IPC and n dot subgroup of a class in USPC) in a patent classification layered structure is selected.

It is regarded that the multi-dispute technique group is a field in which technique development or a commercialization of a technique actively proceeds. The technique group relating to the multi-dispute has an important effect on the value of the patent. Accordingly, a description parameter in view of the technique group as indicated in Table 4 may be an excellent patent evaluation element.

Continuously, a method of processing patent dispute prediction information in a patent information system 10000 of the present invention will be described in detail.

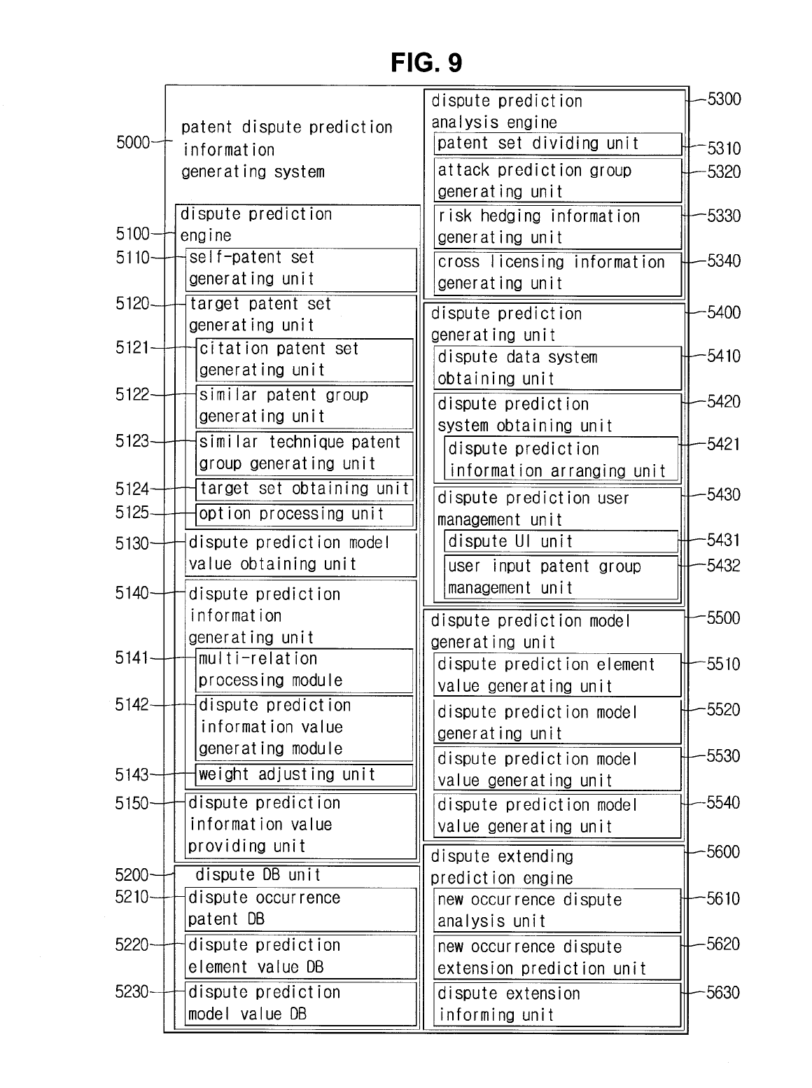

FIG. 9 is a view illustrating an exemplary embodiment of a structure of a system 5000 for generating patent dispute prediction information according to the present invention. The patent dispute prediction information generating system 5000 includes a dispute prediction engine 5100 for generating patent dispute prediction information, a dispute DB unit 5200 for storing various data relating to a dispute, a dispute prediction management unit 5400 for controlling management information on the system and/or a user, a dispute prediction model engine for generating a dispute prediction model, and a dispute prediction information analysis engine 5300 for analyzing dispute prediction information.

The dispute prediction engine 5100 includes a self-patent set generating unit 5110 for generating or specifying a self-patent set including self-patents constituted with at least one patent which is generated or managed by the user, the patent information system 10000, or the patent dispute prediction information generating system 5000, a target patent set generating unit 5120 for generating a target patent set including at least one target patent having a predetermined relation to self-patents which constitute the self-patent set, or for obtaining a target patent set which is constituted with target patents generated or designated by the user, a dispute prediction model value obtaining unit 5130 for obtaining a dispute prediction model value for each patent generated by the dispute prediction model value generating unit 5530, controlling to generate a dispute prediction model value of at least one patent designated by the dispute prediction model generating unit 5520, and obtaining a generated dispute prediction model value, a dispute prediction information generating unit 5140 for generating predetermined dispute prediction information, and a dispute prediction information value providing unit 5150 for providing the generated dispute prediction information value.

The dispute prediction model generating engine 5500 includes a dispute prediction element value generating unit 5510 for generating a dispute prediction element value according to a prescribed dispute prediction element value generating regulation with respect to each dispute prediction element, a dispute prediction model generating unit 5520 for generating at least one dispute prediction model by using a predetermined statistical algorithm, a dispute prediction model value generating unit 5530 for generating a dispute prediction model value for each patent by using the dispute prediction model, and a dispute prediction model value providing unit 5540 for providing the generated dispute prediction model value for each patent.

On the other hand, the dispute prediction element value generating unit 5510 includes a citation affiliation dispute prediction element value generating unit 5510 for generating a dispute prediction element value for a citation affiliation dispute prediction element according to a property of the generated dispute prediction element value, a product or technique group affiliation dispute prediction element value generating unit 5510 for generating a dispute prediction element value for a product or technique group affiliation dispute prediction element, a subject affiliation dispute prediction element value generating unit 5510 for generating a dispute prediction element value for a subject affiliation dispute prediction element such as an owner, an applicant, an inventor, and the like, and a user input affiliation dispute prediction element value generating unit 5510 for generating a dispute prediction element value for a user affiliation dispute prediction element including a patent group having a predetermined property such as at least one patent troll which is input or set by the user, a patent technique classification, a patent set, a competing company or a related company, a standard patent, and the like.

The dispute DB unit 5200 includes a disputed patent DB 5210 for storing information on an incurred dispute. The disputed patent DB 5210 can store dispute inherent identification information, dispute treatment court information, information on at least one dispute patent (all patent information which is specified by a patent No., and includes patent No., bibliographic information corresponding to the patent No., specification information, drawing information, period information), information on at least one plaintiff, information on at least one defendant, information on at least one litigation progress, information on a litigation result, information on litigation instance, and the like. On the other hand, the dispute DB unit 5200 includes a dispute prediction element DB for storing regulation data (SQL instruction, and the like) for generating dispute prediction elements and a dispute prediction element value for each dispute prediction element, a dispute prediction model DB for storing the dispute prediction model, a dispute prediction element value DB 5220 for storing the dispute prediction element value for each patent, and a dispute prediction model value DB 5230 for storing the dispute prediction model value for each patent.

The dispute prediction management unit 5400 includes a dispute data obtaining unit 5410 for obtaining data relating to a patent dispute to perform parsing, a patent group management unit 5432 for managing dispute related data input by a user and a patent set input by another user, and a dispute UI unit 5431 for allowing a user to use dispute information generated by the dispute prediction engine 5100 with relation to the dispute and to use the patent dispute prediction information generating system 5000 with relation to the patent dispute prediction, and for providing the generated dispute prediction information through a preset UI. The dispute prediction management unit 5400 further includes a dispute prediction system management unit 5420 for managing the patent dispute prediction information generating system 5000, and a dispute prediction user management unit 5430 for managing users who use the patent dispute prediction information generating system 5000. The dispute prediction system management unit 5420 further includes a dispute prediction information batch generating unit 5421 for performing a batch process in order to generate predetermined dispute prediction information. The batch process refers to a process of generating predetermined patent dispute prediction information corresponding to a predetermined owner, a predetermined patent classification and a patent group for each user which is managed by the patent dispute prediction management unit 5400 according to a predetermined period or a predetermined condition (renewal of a patent evaluation model or a patent evaluation element value, and an inflow of new patent evaluation data). The dispute prediction user management unit 5430 further includes a patent group management unit 5432 for managing a patent group input by users.

The dispute prediction information value providing unit 5150 includes a dispute information report generating unit 4440 for generating a report in order to provide patent dispute information or patent dispute prediction information in a form of a document. The dispute information report generating unit 4440 generates a report which is transmitted to users through a dispute information input/output unit by electronic mail or a predetermined means.

The dispute prediction information analysis engine 5300 includes a patent set dividing unit 5310 for dividing a provided patent set, an aggressed patent group generating unit for generating information on a patent group which is predicted to be aggressed, a risk-hedge information generating unit 5330 for generating information to effectively hedge a patent dispute risk, a cross-licensing information generating unit 5340 for seeking a candidate patent group for cross-licensing, and a licensed object information generating unit for generating information on a licensed object.

Continuously, a method of processing patent evaluation information in a patent information system 10000 of the present invention will be described in detail.

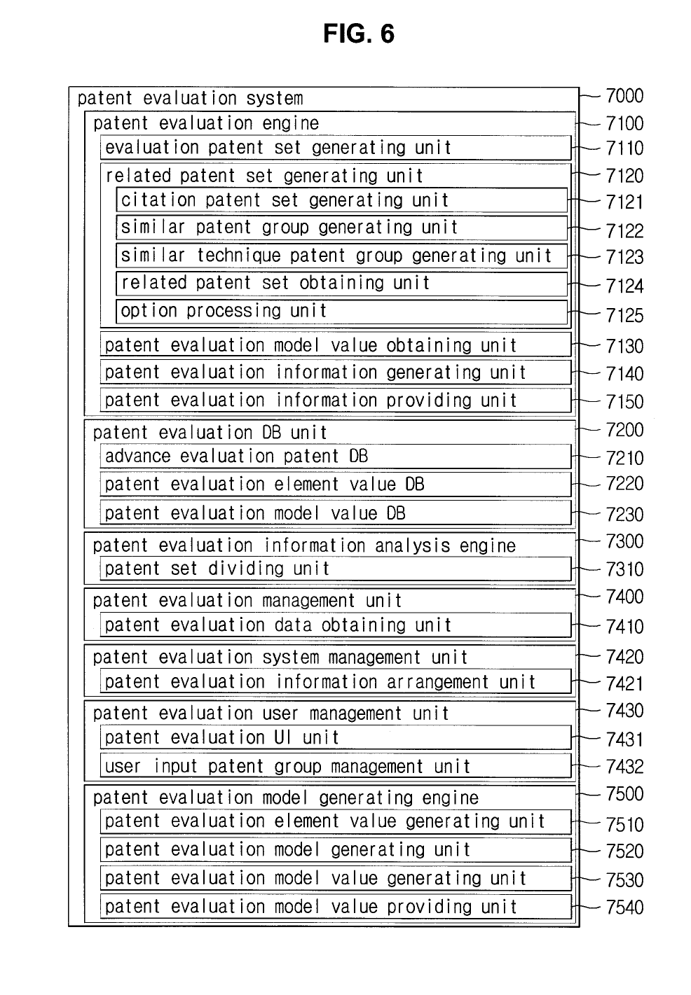

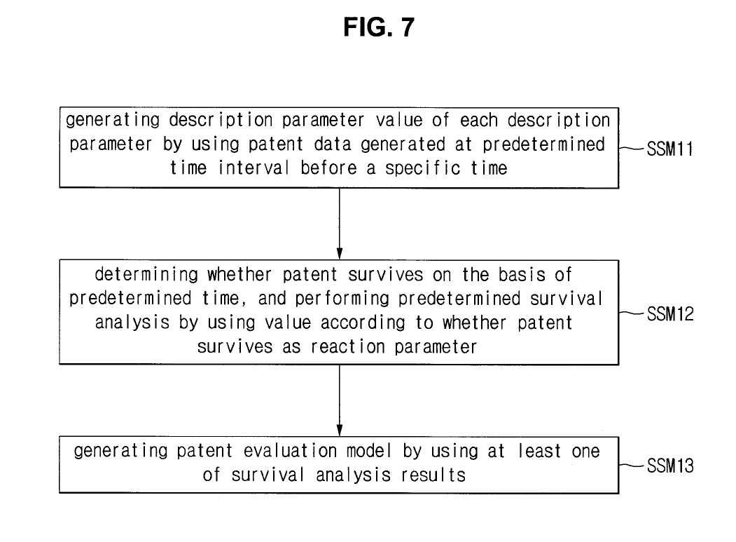

FIG. 6 is a view illustrating an exemplary embodiment of a structure of a system 7000 for generating patent evaluation information according to the present invention. The patent evaluation information generating system 7000 includes a patent evaluation engine 7100 for generating patent evaluation information, a patent evaluation DB unit 7200 for storing various data with relation to patent evaluation, a patent evaluation management unit 7400 for controlling management information on the system and users with relation to the patent evaluation, a patent evaluation model engine for generating a patent evaluation model, and a patent evaluation information analysis engine 7300 for analyzing patent evaluation information.

The patent evaluation engine 7100 includes a self-patent set generating unit 7110 for generating or specifying a self-patent set including self-patents constituted with at least one patent which is generated or managed by the user, the patent information system 10000, or the patent evaluation information generating system 7000, a target patent set generating unit 7120 for generating a target patent set including at least one target patent having a predetermined relation to self-patents which constitute the self-patent set, or for obtaining a target patent set which is constituted with target patents generated or designated by the user, a dispute evaluation model value obtaining unit 7130 for obtaining a patent evaluation model value for each patent generated by the patent evaluation model value generating unit 7530, controlling to generate a patent evaluation model value of at least one patent designated by the patent evaluation model generating unit 7520, and obtaining a generated patent evaluation model value, a patent evaluation information generating unit 7140 for generating predetermined patent evaluation information, and a patent evaluation information value providing unit 7150 for providing the generated patent evaluation information value.

The patent evaluation model generating engine 7500 includes a patent evaluation element value generating unit 7510 for generating a patent evaluation element value according to a prescribed patent evaluation element value generating regulation with respect to each patent evaluation element, a patent evaluation model generating unit 7520 for generating at least one patent evaluation model by using a predetermined statistical algorithm, a patent evaluation model value generating unit 7530 for generating a patent evaluation model value for each patent by using the patent evaluation model, and a patent evaluation model value providing unit 7540 for providing the generated patent evaluation model value for each patent.

On the other hand, the patent evaluation element value generating unit 7510 includes a citation affiliation patent evaluation element value generating unit 7510 for generating a patent evaluation element value for a citation affiliation patent evaluation element according to a property of the generated patent evaluation element value, a product or technique group affiliation patent evaluation element value generating unit 7510 for generating a patent evaluation element value for a product or technique group affiliation patent evaluation element, a subject affiliation patent evaluation element value generating unit 7510 for generating a patent evaluation element value for a subject affiliation patent evaluation element such as an owner, an applicant, an inventor, and the like, and a user input affiliation patent evaluation element value generating unit 7510 for generating a patent evaluation element value for a user affiliation patent evaluation element including a patent group having a predetermined property such as at least one patent troll which is input or set by the user, a patent technique classification, a patent set, a competing company or a related company, a standard patent, and the like.

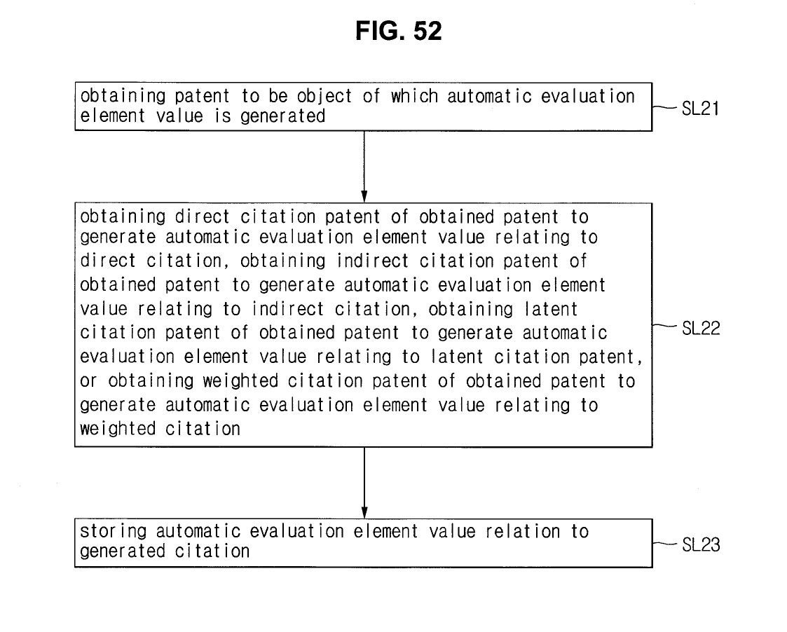

FIG. 52 is a flowchart illustrating an exemplary embodiment of a process of generating the patent evaluation element value for each patent evaluation element in view of the citation, in which an example of generating the prediction element value with relation to Table 1 is shown. A patent evaluation element value generating unit 7510 obtains a patent to be an object for which a patent evaluation element value is generated in step SL21. Then, the patent evaluation element value generating unit 5510 obtains a direct citation patent of the obtained patent to generate a patent evaluation element value with relation to the direct citation, obtains an indirect citation patent of the obtained patent to generate a patent evaluation element value with relation to the indirect citation, obtains a latent citation patent of the obtained patent to generate a patent evaluation element value with relation to the latent citation, obtains a family citation patent of the obtained patent to generate a patent evaluation element value with relation to the family citation, or obtains a chain citation patent of the obtained patent to generate a patent evaluation element value with relation to the chain citation in step SL22. Finally, the generated patent evaluation element value with relation to the citation is stored in step SL23. Likewise, with respect to an evaluation element value, an evaluation element value generating engine obtains a patent to be an object for which the evaluation element value is generated, and obtains a direct citation patent of the obtained patent to generate the evaluation element value with relation to the direct citation, obtains an indirect citation patent of the obtained patent to generate the evaluation element value with relation to the indirect citation, obtains a latent citation patent of the obtained patent to generate the evaluation element value with relation to the latent citation, obtains a family citation patent of the obtained patent to generate the evaluation element value with relation to the family citation, or obtains a chain citation patent of the obtained patent to generate the evaluation element value with relation to the chain citation. Then, the generated evaluation element value relating to the citation can be stored.

The patent evaluation DB unit 7200 includes an advance evaluation patent DB 7210 for storing information on a high-evaluated patent or a patent including an evaluation result. An example of the advance evaluation patent DB includes a dispute DB which is a set of the disputed patents. A number of dispute incurrences of each disputed patent, or a corresponding score obtained by applying a predetermined conversion formula to the number of dispute incurrences is mapped as a result of evaluating the patent (for example, when dispute occurs, 1 corresponds to the number of dispute incurrences unconditionally. 1 corresponds to one time of dispute, 2 corresponds to two to five times of disputes, 3 corresponds to six to twenty times of disputes, and 4 corresponds to more than twenty one times of disputes. Further, the number of disputes, increasing and decreasing of disputes, an increasing ratio of disputes, an increasing rate of disputes, and the like are categorized and correspond to conversion score, or the square roots of the dispute time, and the like are extracted to obtain conversion scores by applying temporary conversion formula).

On the other hand, the advance evaluation patent DB includes an evaluation result of evaluating at least two patents. The evaluation result may include an evaluation score and evaluation grade for the patent, or an evaluation score and grade in view of evaluation for the patent such as technique, right, marketability, a ripple effect, originality, and the like.

Further, the patent evaluation model value DB 7230 includes an evaluation result of evaluating at least two patents by applying a patent evaluation model. The evaluation result may include an evaluation score and evaluation grade for the patent, or an evaluation score and grade in view of evaluation for the patent such as technique, right, marketability, a ripple effect, originality, and the like.

The evaluation view corresponds to at least one subordinate view. On the other hand, the evaluation view or the subordinate evaluation view corresponds to at least one description parameter. The patent evaluation model generates a patent evaluation model value for each description parameter. Scores are generated to correspond to the evaluation view or the subordinate evaluation view by using the generated patent evaluation model value for each description parameter. For example, the evaluation view of technique may correspond to a subordinate evaluation view of technical influence, a technical ripple effect, technical attraction, technical continuation, and the like. It is possible to make at least one description parameter such as total cited-times (description parameter Xi) correspond to the subordinate evaluation view of the technical influence. In a case where at least one description parameter Xi value according to the patent evaluation model is generated with respect to the evaluated object patent Pi, it is possible to generate a score of the subordinate evaluation view for the patent Pi by using the description parameter Xi.

Of course, the patent evaluation system 7000 performs a predetermined conversion processing for the patent evaluation model value of the patent P1 generated by using the patent evaluation model value, a score of at least one evaluation view, and a score of at least one subordinate evaluation view. In a case where a patent evaluation model value is generated by a patent evaluation model with relation to a plurality of patents (all registered patent or sample patents extracted from all registered patents), it is possible for the patent evaluation model value not to be distributed preferably. In this case, the patent evaluation model converts the generated patent evaluation model value by applying the predetermined conversion regulation, so that the patent evaluation model value is preferably distributed. The conversion regulation includes a processing of matching a range of a specific patent evaluation model value to a specific converted patent evaluation model value in a manner of one-to-one correspondence. Of course, in a case where the patent evaluation model is regulated or converted by using a predetermined conversion formula with respect to the patent evaluation model value, the patent evaluation model can be regulated so that a predetermined number of patents are included in a specific converted patent evaluation model value. The conversion processing is further necessary when it is difficult to immediately use the patent evaluation model value which the patent evaluation model generates. Of course, the patent evaluation model value including the conversion processing may be generated. It should be understood that the patent evaluation model value includes the converted patent evaluation model value in not the present paragraph but also other paragraphs.

On the other hand, a perfect score may correspond to each evaluation view or each subordinate evaluation view, and the perfect score can be either identically or differently applied to the evaluation view and the subordinate evaluation view. At this time, the patent evaluation model value of the patent P1 can be calculated as below.

Patent evaluation model value of patent Pi=sum of {(evaluation score of evaluation view I according to patent evaluation model*perfect score of evaluation view)/(sum of perfect score of evaluation view)}

Evaluation score of evaluation view I according to patent evaluation model=sum of {(evaluation score of subordinate view j according to patent evaluation model*perfect score of subordinate evaluation view j)/(sum of perfect score of subordinate view j)}

In a case where there are an evaluated object patent Pi and a patent Tj belonging to a similar patent group of the patent Pi, the patent evaluation system 7000 compares the patent Pi with the patent Tj with relation to the patent evaluation score. Further, the patent evaluation system 7000 can compare the patent evaluation scores according to each evaluation view or each subordinate evaluation view. On the other hand, the patent evaluation system 7000 may compare the patent evaluation scores of at least two subjects or at least two groups (the subject or the group includes at least one patent. For example, a company A may include ten patents, and a company B may include fifteen patents) with one another, and also may compare the patent evaluation scores with one another with relation to each evaluation view or each subordinate evaluation view. That is, the patent evaluation system 7000 can compare the patent evaluation score for each patent, the patent evaluation score for each patent according to the evaluation view, and the patent evaluation score for each patent according to the subordinate evaluation view. Further, the patent evaluation system 7000 can generate sequential information or sequential comparison information with respect to the patent evaluation score, the patent evaluation score according to each evaluation view, and the patent evaluation score according to each subordinate evaluation view.

On the other hand, the patent evaluation DB unit 7200 includes a patent evaluation element DB for storing regulation data (SQL instruction and the like) which is used to generate a patent evaluation element value for each patent evaluation element, a patent evaluation DB for storing the patent evaluation model, a patent evaluation element value DB 7220 for storing the patent evaluation element value of each patent, and a patent evaluation model value DB 7230 for storing the patent evaluation model value of each patent.

The patent evaluation managing unit 7400 includes a patent group managing unit 7432 for managing a patent set input by users, and a patent evaluation UI unit 7431 for allowing the users to use the patent evaluation information generating system 7000 and patent evaluation information which the patent evaluation engine 7100 generates, with relation to patent evaluation, and providing the generated patent evaluation information through the preset UI. The patent evaluation management unit 7400 further includes a patent evaluation system management unit 7420 for managing the patent evaluation information generating system 7000, and a patent evaluation user management unit 7430 for managing users who use the patent evaluation information generating system 7000. The patent evaluation system management unit 7420 further includes a patent evaluation information batch generating unit 7421 for performing a batch process in order to generate predetermined patent evaluation information. The batch process refers to a process of generating predetermined patent evaluation information corresponding to a predetermined owner, a predetermined patent classification and a patent group for each user which is managed by the patent evaluation management unit 7400 according to a predetermined period or a predetermined condition (renewal of a patent evaluation model or a patent evaluation element value, and an inflow of new patent evaluation data). The patent evaluation user management unit 7430 further includes a patent group management unit 7432 for managing a patent group input by users.

The patent evaluation information value providing unit 7150 includes a patent evaluation information report generating unit 4440 for generating a report in order to provide patent evaluation information or provide patent evaluation information in a form of a document. The patent evaluation information report generating unit 4440 generates the report which is transmitted to users through a patent evaluation information input/output unit by electronic mail or a predetermined means. The patent evaluation information analysis engine 7300 may include a patent set dividing unit 7310 for dividing a provided patent set.

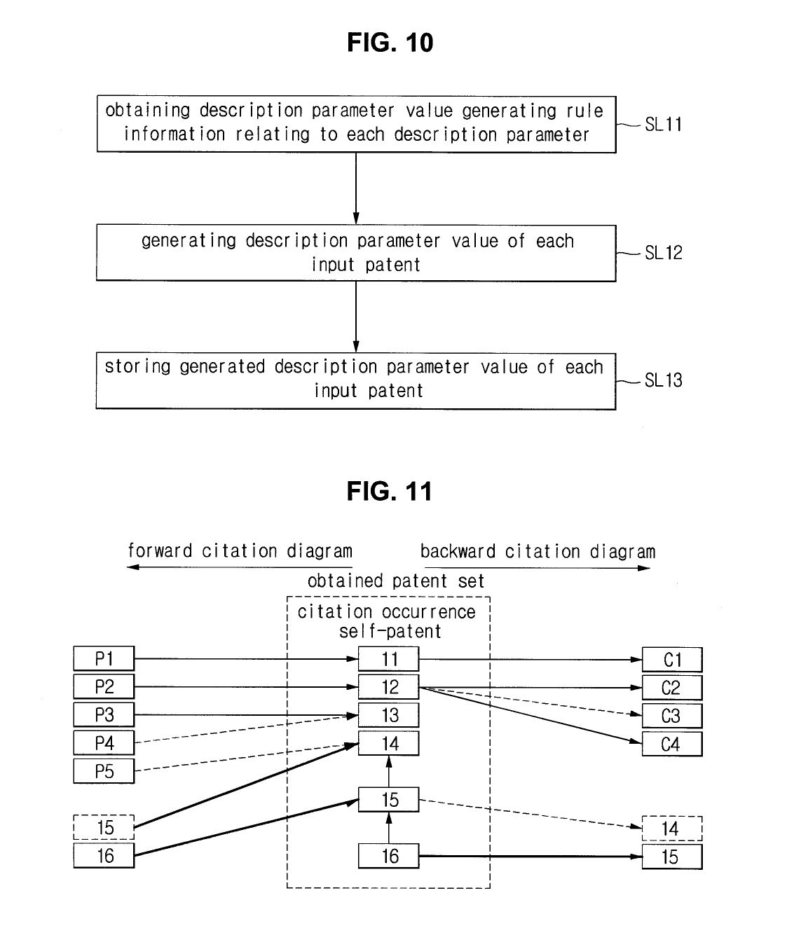

Firstly, referring to FIG. 10, a generation of a prediction element value/description parameter value will be described. The dispute prediction element value generating unit 5510 or the patent evaluation element value generating unit 7510 of the present invention obtains regulation information on a generation of a description parameter value of each description parameter in step SL11, and generates a description parameter value of each input patent in step SL12. Then, the generated description parameter value of each patent is stored in step SL13.

On the other hand, the dispute prediction element value generating unit 5510 or the patent evaluation element value generating unit 7510 generates at least one or all of the description parameter values as indicated in Tables 1 to 4 according to each patent belonging to the patent DB 1120 or each patent set (patent set according to each owner, and patent set according to each patent classification) including at least one patent on the basis of a predetermined period or a predetermined condition. In a case where a description parameter is a number of claims, and a specific patent Pi has twenty claims, the description parameter value of the number of claims becomes 20. On the other hand, the dispute prediction element value generating unit 5510 or the patent evaluation element value generating unit 7510 generates in real-time at least one or all of description parameter values of all description parameters as indicated in Tables 1 to 4, according to each patent set including at least one patent or each patent.

Object information to be processed in the dispute prediction element value generating unit 5510 or the patent evaluation element value generating unit 7510 can be generated according each patent classification depth in a patent classification system to which a patent classification belongs, with respect to a type of a predetermined patent classification. The information processing is performed by using only a main patent classification or the main patent classification and a patent sub-classification together. For example, with respect to a US patent, when the IPC and USPC are marked, it is possible that description parameter values are respectively generated by a unit of sub-class and main group in a case of the IPC, and that description parameter values are generated by a unit of class. At this time, in a case of the IPC, the description parameter value may be generated by using only the main classification for a patent, and in a case of the USPC the description parameter value may be generated considering both the main classification and the sub-classification for a patent (in a case where C1 main classification and C2 sub-classification are marked in the patent Pi, if a description parameter value is generated on the basis of the C2, the patent Pi is processed as an object).

On the other hand, when processing information on a specific patent classification on the basis of the patent classification, the dispute prediction element value generating unit 5510 or the patent evaluation element value generating unit 7510 simultaneously processes patents which correspond to the subordinate patent classification of the specific patent classification. For example, the dispute prediction element value generating unit 5510 generates a dispute prediction element value of each predetermined dispute prediction element for each of a group of patents classified into H04B 7/24 of the IPC (of course, when there is a child patent classification which regards H04B 7/24 as a parent classification, patents corresponding to the child patent classification constitute a group of the patents. It is obvious in a property of a layered structure of the patent classification) and a group of patents satisfying a predetermined condition (a specific period, a specific patent classification, a specific keyword, or another condition), in a case where a patent classification of H04B 7/24 is a multi-dispute technical field.

A relation between a description parameter and a description parameter candidate will be described. The description parameter candidate essentially becomes the description parameter. When a dispute prediction model is generated with respect to the description parameter candidate, description parameter candidates which do not contribute or are below a predetermined level can be removed, and the residual description parameter candidates become the description parameters. However, the description parameters which contribute insignificantly and are below the predetermined level are included in the dispute prediction model (in a generation of the model, there is no case where the extent that each description parameter contributes to the model is 0, and in most cases, the extent that each description parameter contributes to the model is insignificantly). The dispute prediction model value is not changed substantially since the description parameter has a small contribution even though the description parameter below the predetermined level is included in the dispute prediction model. Accordingly, all the description parameter candidates may be description parameters. In a case of including the description parameter having an insignificant contribution, a description parameter value is generated with respect to the description parameter and is reflected to the generation of the model. Further, the description parameter value for the description parameter is reflected to generate the dispute prediction model value. Therefore, there is an uneconomic and inefficient aspect in a consumption of computing power. However, if the computing power is enough, it is preferable to use many description parameters.

An advance statistical analysis can be basically performed with respect to the description parameter indicated in Tables 1 to 4. The dispute prediction model generating engine 5500 or the patent evaluation element value generating unit 7510 generates a predetermined statistic and statistical processing information on the description parameter value of any one of the description parameters with respect to individual patents belonging to each of the dispute patent set and the non-dispute patent set. The statistic is a numeric value relating to an average of the description parameter value, dispersion, standard deviation, a distribution property, and the like, and the statistical processing information may include visualized information such as a comparison graph relating to statistical analysis, and the like. With respect to a specific description parameter, in a case where a description parameter value for dispute patent set is identical to or very similar to that of non-dispute patent set, such a parameter may be initially excluded when generating a dispute prediction model (may be excluded at a candidate step).

Continuously, a method of generating a dispute prediction model and a patent evaluation model by using the dispute prediction element value generating unit 5510 or the patent evaluation element value generating unit 7510 will be described in detail. Firstly, a method of generating a dispute prediction model will be described in detail.

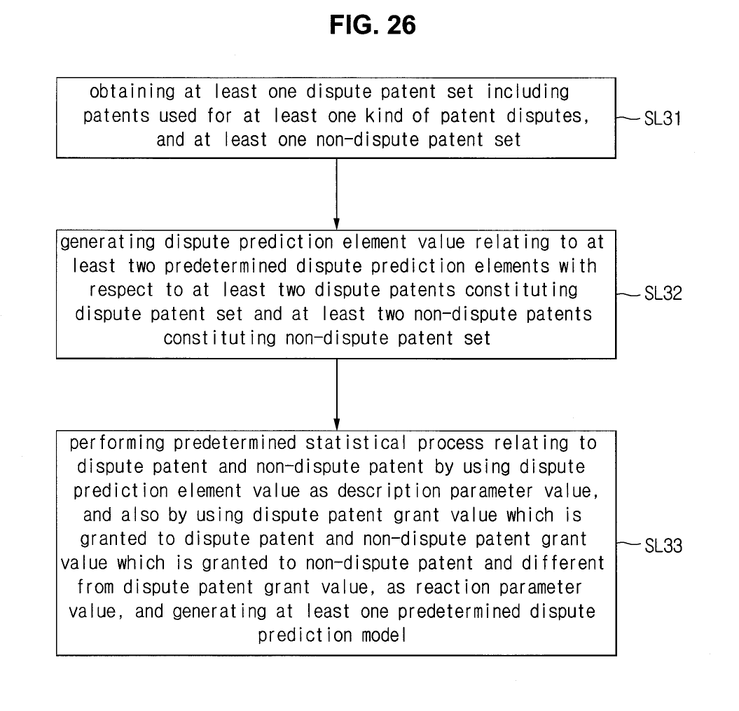

FIG. 26 is a flowchart illustrating an exemplary process of generating a dispute prediction model. The dispute prediction model generating engine 5500 obtains at least one dispute patent set including at least one kind of patent used for a patent dispute, and at least one non-dispute patent set in step SL31, generates dispute prediction element values of at least two predetermined dispute prediction elements with respect to at least two dispute patents constituting the dispute patent set and at least two non-dispute patents constituting the non-dispute patent set, in step SL32, and generates at least one predetermined dispute prediction model in a manner of performing a predetermined statistical processing by defining the dispute prediction element value as the description parameter value, and defining a value which is given to the dispute patent and a value which is given to the non-dispute patent and different from that given to the dispute patent, as a reaction parameter value in step SL33, with respect to the dispute patent and the non-dispute patent. Hereinafter, it will be described in detail.

Firstly, the dispute patent set and non-dispute patent set are generated in order to generate the dispute prediction model. The dispute patent set is constituted of patents which causes dispute. The non-dispute patent set includes patents which do not cause dispute. Since most patents do not cause dispute, the non-dispute patent set used to generate the dispute prediction model is separately constituted by sampling. With respect to the non-dispute patents, the sampling of the non-dispute patent set is carried out by using 1) random sampling, 2) stratification sampling, or 3) predetermined statistical sampling after a size of a sample is determined. A large size of a sample in the non-dispute patent set is preferable. However, the size of the sample is determined in consideration of a size of the dispute patent set and computing power, and it is necessary to determine the size of the sample to be identical to or larger than that of the dispute patent set. In a case of selecting the stratification sampling, proportional stratification sampling is preferable. The proportional stratification sampling can be carried out in consideration of at least one of time distribution information such as a registration year or a filing year of a dispute patent constituting the dispute patent group, and technique distribution information on the basis of the patent classification. On the other hand, in a case where a patent owner causes dispute, stratification sampling is partially performed in which a number of dispute patents constituting the dispute patent group are considered according to each owner of the dispute patents while a plurality of non-dispute patents of the owner can be sampled. Further, the stratification sampling can be partially carried out considering a number of dispute patents according to each dispute generation year.

The dispute prediction model generating engine 5500 divides each or a combination of the dispute patent set and the non-dispute patent set into at least two parts. A first divided dispute patent set and a first divided non-dispute patent set are used to generate a dispute prediction model, and a second divided dispute patent set and a second divided non-dispute patent set are used to verify the generated dispute prediction model. At this time, the first dispute patent set and the first non-dispute patent set preferably have a size larger than that of the second dispute patent set and the second non-dispute patent set.

The dispute prediction element value generating unit 5510 generates or obtains a dispute prediction element value of each dispute prediction element with respect to dispute patents and non-dispute patents respectively constituting the dispute patent set and the non-dispute patent set.

The dispute prediction model generating unit 5520 allocates a dispute patent reaction parameter value to patents belonging to the dispute patent set, and allocates a non-dispute patent reaction parameter value, which is different from a dispute patent reaction parameter value, to patents belonging to the non-dispute patent set. A method of allocating the dispute patent reaction parameter value generally includes 1) a method of matching an identical value to all dispute patents, and 2) a method of matching a different value to the dispute patents according to a property of the dispute patent. Generally, the former uses a classification model as the statistical model and the latter uses a regression model. However, the latter may use the classification model according to a design of a reaction parameter.

A method of assigning another reaction parameter value according to a property of the dispute patent includes 1) a method of matching dispute incurrence times of the dispute patent to a reaction parameter value, 2) a method of classifying the dispute incurrence frequency of the dispute patent into at least two categories and matching a category value to a reaction parameter value (for example, a n division method including a method of dividing dispute incurrence frequency into two parts or into four parts in consideration of a distribution of dispute frequency according to each dispute patents), and 3) a method of constituting a matrix of n*m cells in consideration of a dispute incurrence frequency reference n of the dispute patent and a dispute incurrence year reference m together and matching a reaction parameter value to each cell. On the other hand, a dispute patent relating to an appeal trial is regarded as an independent dispute according to each stage of law and is applied by a method of increasing a dispute frequency or matching a different reaction parameter value to each stage of law.

On the other hand, a dispute patent in a broad sense may include a semi-dispute patent. The semi-dispute patent is categorized by dispute and includes 1) a first kind of semi-dispute patent relating to a non-judicial and administrative dispute such as an invalidation trial, an ITC lawsuit, and the like, 2) a second kind of semi-dispute patent in which it is required to pay a royalty and which is included in a warning notice, 3) a third kind of semi-dispute patent in which a royalty is paid or which is an object to be cross-licensed, and 4) a fourth kind of semi-dispute patent in which an owner' right in law is exercised. In a case of the first kind of semi-dispute patent, data can be easily collected via the patent office or other methods. On the other hand, in a case of the second to fourth kinds of semi-dispute patent, the dispute is incurred in a private region, resulting in a difficulty in a collection of data. However, since each user can recognize the kinds of semi-dispute patents according to 2) to 4) when a dispute prediction model is generated according to each user (for example, specified to A for a certain company A), the cases of 2) to 4) can be utilized in a dispute prediction model. The cases 2) to 4) can be importantly used in a dispute prediction model suitable to company.

The semi-dispute patent can be applied by a method of matching a reaction parameter value which is identical to that applied to a dispute patent (a patent for which a judicial dispute is incurred) and a method of matching a reaction parameter value which is different from that applied to a dispute patent. The latter is more preferable. As an example of briefly matching the reaction parameter value, 1 is applied to both the dispute patent and the semi-dispute patent, and 0 is applied to the non-dispute patent.

When the reaction parameter value is matched to a dispute prediction model value which is a description parameter value for the dispute patent and the non-dispute patent and corresponds to each dispute prediction model, the dispute prediction model generating unit 5520 generates a dispute prediction model by applying at least one predetermined statistical modeling scheme relating to the description parameter value and the reaction parameter value.

In a case where 1 is matched as a reaction parameter value to a dispute patent and a non-dispute patent and 0 is matched to a non-dispute patent, generating a dispute prediction model generates a typical classification model. When the dispute prediction model generating unit 5520 generates a classification model, a variety of statistical schemes are used. The statistical schemes are adopted to the present invention, and included in a statistical processing of the present invention. Although the statistical schemes are not described in detail, it is obvious not to exclude the statistical schemes from the present invention.

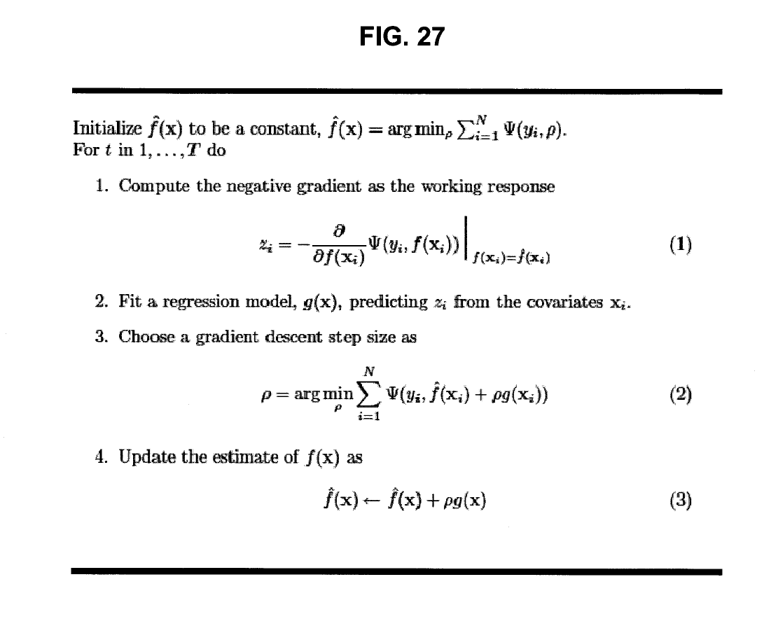

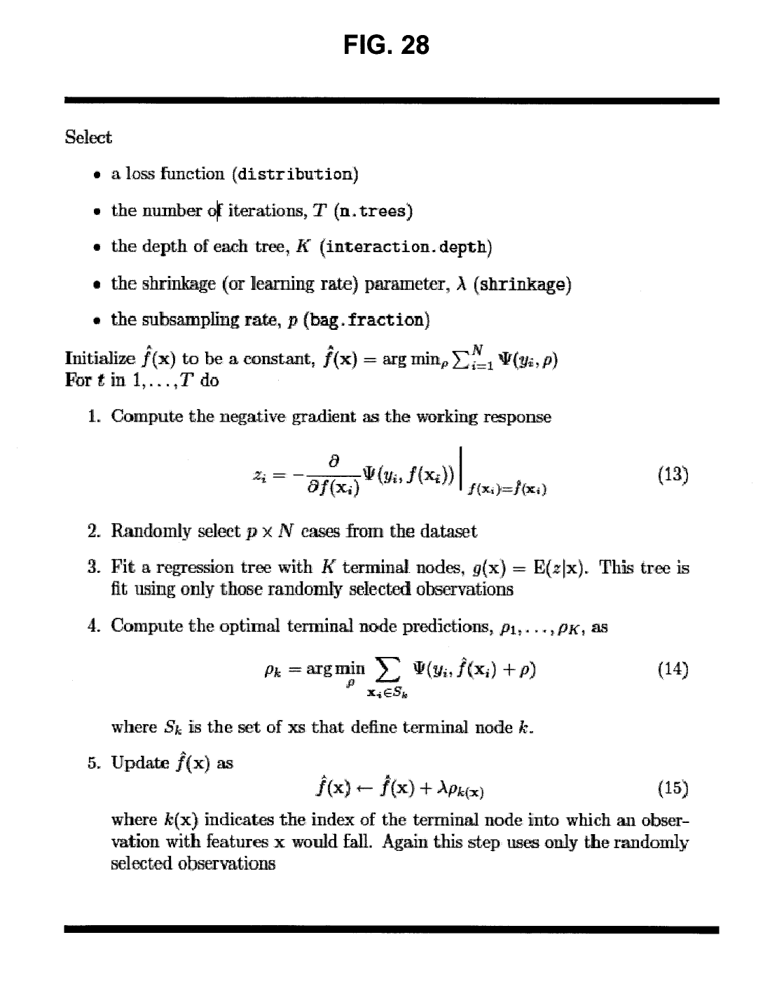

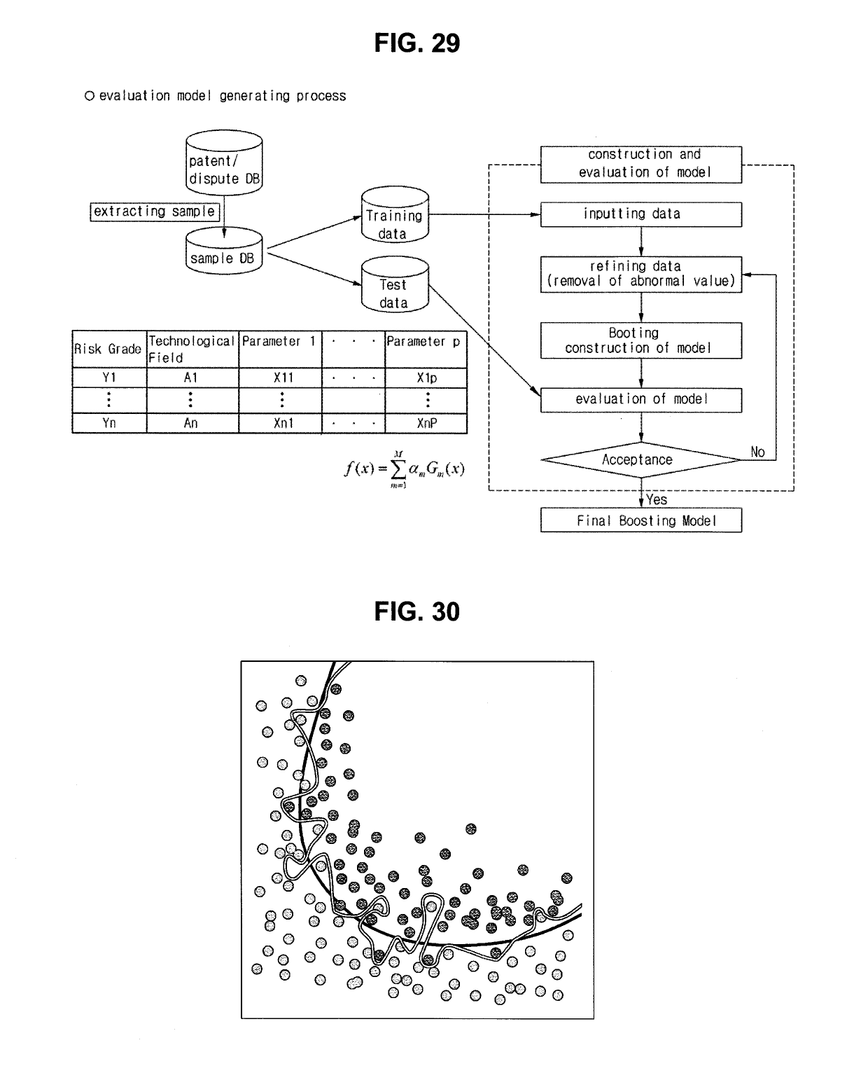

In the specification, as an example of a method of generating a classification model, a method of generating a classification model using a boosting scheme of an ensemble scheme based on a mechanical learning scheme tree will be described (another method using the ensemble scheme includes a random forest scheme). FIG. 27 is a view illustrating an abstract of a Gradient Boosting algorithm, FIG. 28 is a view illustrating an abstract of a stochastic gradient boosting algorithm which Friedman newly proposed in 2002, and FIG. 29 is a view illustrating an exemplary concept of a process of generating a dispute prediction model of a patent dispute prediction information generating system 5000 of the present invention.

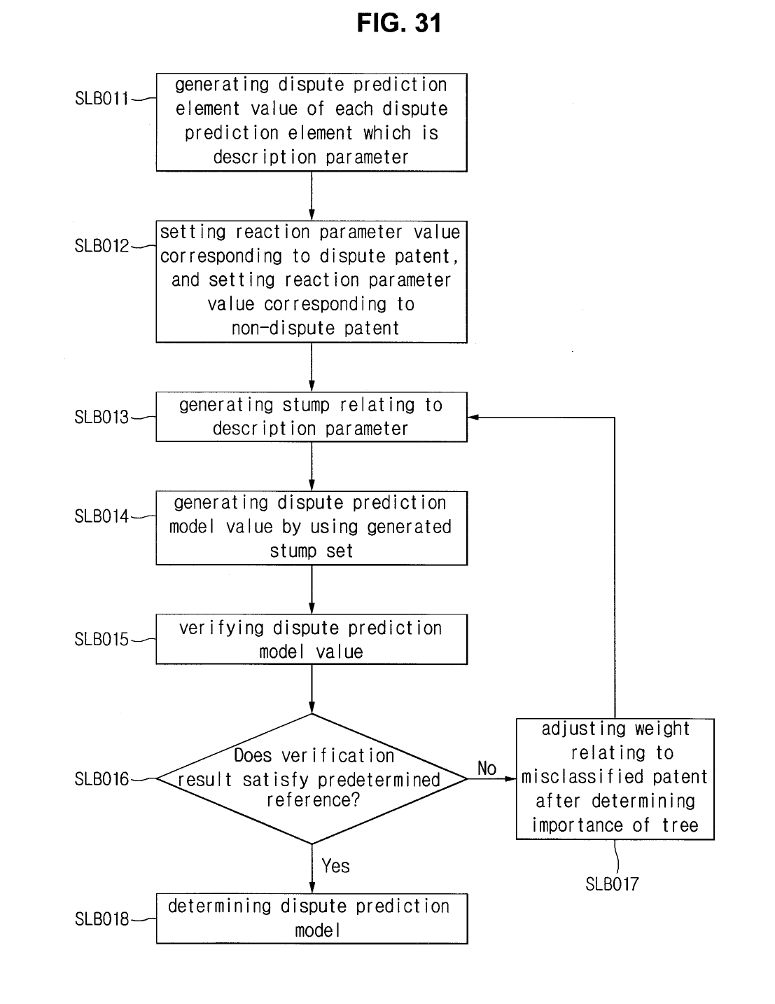

Continuously, an information processing method of a dispute prediction model generating unit 5520 of the present invention will be described in detail with reference to FIGS. 29 and 31. With respect to the dispute patents and the non-dispute patents, the dispute prediction model generating unit 5520 generates a dispute prediction element value corresponding to each dispute prediction element which is a description parameter in step SLB011, and respectively sets corresponding reaction parameter values for the dispute patents and the non-dispute patents in step SLB012. Continuously, the dispute prediction model generating unit 5520 generates a first stump for at least one of the description parameters in step SLB013, generates a dispute prediction model value by using first stump set including the first stump in step SLB014, and verifies the dispute prediction model value in step SLB015. As a result of the verification, if the dispute prediction model value does not satisfy a predetermined reference in step SLB016, a misclassification patent object weight is adjusted after the importance of a tree is determined in step SLB017. Then, the dispute prediction model generating unit 5520 generates a second stump for the description parameter, generates a dispute prediction model value by using the first and second stumps, and verifies the dispute prediction model value. Until the verifying result satisfies the predetermined reference, the generating of stump, the generating of dispute prediction model value by using the generated stump, and the verifying of dispute prediction model vale are repeated. As a result of the verification, if the dispute prediction model value satisfies the predetermined reference, the dispute prediction model is determined by joining the generated stumps in step SLB018.

The dispute prediction model generating unit 5520 generates a stump corresponding to each description parameter. According to circumstances, a general tree instead of the stump may be used. The dispute prediction model generating unit 5520 analyzes the description values of dispute patents constituting a dispute patent set and non-dispute patents constituting a non-dispute patent set so as to generate at least one stump including an important dispute prediction element. The stump includes five pieces of information such as 1) a dispute prediction element, 2) a split point, 3) a left node prediction value, 4) a right node prediction value, and 5) a prediction value when an application of a split is impossible. In a rule of generating a split, it is preferable to minimize a given loss function and to seek a reference point of the split and a prediction value. In the above-mentioned case, Deviance, Exponential loss functions, etc. can be used as loss functions.

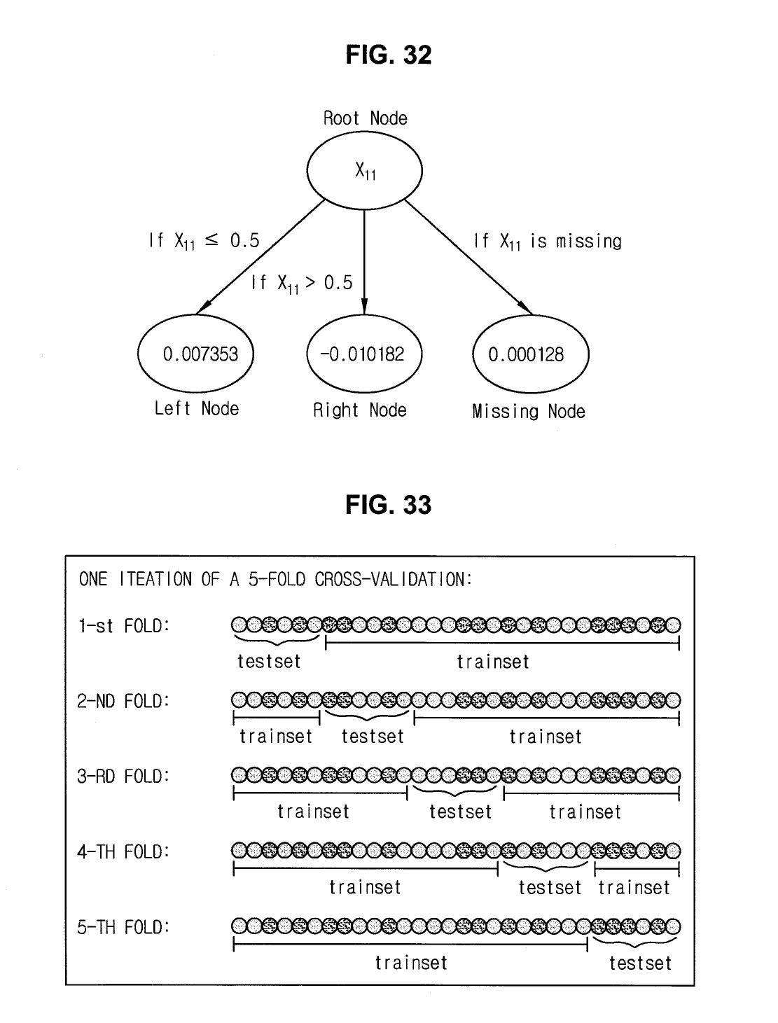

FIG. 32 shows an example of the generated stump, and Table 5 indicates an example of the stump information.

TABLE 5

| | Split | | | | | | | |
|---|---|---|---|---|---|---|---|---|
| | Var | SplitCodePred | LeftNode | RightNode | MissingNode | ErrorReduction | Weight | Prediction |
| 0 | 11 | 0.5 | 1 | 2 | 3 | 802.9285468 | 22666 | 0.000128321 |
| 1 | −1 | 0.007353469 | −1 | −1 | −1 | 0 | 13327 | 0.007353469 |
| 2 | −1 | −0.010182157 | −1 | −1 | −1 | 0 | 9339 | −0.010182157 |
| 3 | −1 | 0.000128321 | −1 | −1 | −1 | 0 | 22666 | 0.000128321 |

In Table 5, the SplitVar refers to a description parameter (a dispute prediction element) which is split, and a value of 11 refers to an eleventh description parameter. The SplitCodePred refers to a split point at which the description parameter is split, and 0.5 refers to a value of the split point. The LeftNode indicates a left node and corresponds to 1, and a third row starting with 1 indicates information when a left split occurs. When a left split occurs, X11<=0.5. In this case, a prediction value is about 0.007353469, and FIG. 32 shows the prediction value of 0.007353469. The RightNode is a right node, and shows an information value in a fourth row. The MissingNode is a case in which a split is missing, and shows an information value in a fifth row.

Table 6 includes information of Table 5, and indicates an example of generating a plurality of stumps.

TABLE 6

| SplitVar | SplitCodePred | LeftNode | RightNode | MissingNode | ErrorReduction | Weight |
|---|---|---|---|---|---|---|
| 11 | 0.5 | 1 | 2 | 3 | 802.9285 | 22666 |
| −1 | 0.007353 | −1 | −1 | −1 | 0 | 13327 |
| −1 | −0.01018 | −1 | −1 | −1 | 0 | 9339 |
| −1 | 0.000128 | −1 | −1 | −1 | 0 | 22666 |
| 11 | 0.5 | 1 | 2 | 3 | 773.5689 | 22666 |
| −1 | 0.007046 | −1 | −1 | −1 | 0 | 13238 |
| −1 | −0.01016 | −1 | −1 | −1 | 0 | 9428 |
| −1 | −0.00011 | −1 | −1 | −1 | 0 | 22666 |
| 11 | 0.5 | 1 | 2 | 3 | 785.034 | 22666 |
| −1 | 0.007055 | −1 | −1 | −1 | 0 | 13242 |
| −1 | −0.0103 | −1 | −1 | −1 | 0 | 9424 |
| −1 | −0.00016 | −1 | −1 | −1 | 0 | 22666 |

As indicated in Table 6, four rows correspond to one stump. In Table 6, it is shown that at least three stumps are generated with respect to the description parameter 11. There are plural cases in which at least one stump is generated with respect to one description parameter, as described above.

The dispute prediction model generating unit 5520 generates prediction values corresponding to each patent of the dispute patent set and each patent of the non-dispute patent set by applying an initial stump S1 and using a dispute prediction element value of the dispute patent and a non-dispute prediction element value (the prediction value is any one of 3) a left node prediction value, 4) a right node prediction value, and 5) a prediction value when an application of a split is impossible, in which the stump S1 is applied). The initial stump S1 becomes an initial dispute prediction model candidate. The prediction value may be generated for each of the dispute patent and the non-dispute patent which are used in a generation of a model. At this time, the dispute prediction model generating unit 5520 analyzes a reaction parameter value for the dispute patent, a prediction value for the dispute patent, a reaction parameter value for a non-dispute patent, and a prediction value for a non-dispute value so as to generate prediction error information such as a misclassification error. The dispute prediction model generating unit 5520 determines an importance of a tree, and then (forcedly) increases a weight for a misclassification dispute patent and a misclassification non-dispute patent (for example, increasing of frequency, when a certain dispute patent P1 is misclassified as a non-dispute patent, a frequency of the patent P1 is increased from 1 to more than 1), so as to readjust dispute patent set data and non-dispute patent set data. A second stump S2 is generated for dispute patent set and non-dispute patent set which are readjusted. A second dispute prediction model candidate includes a first stump S1 and a second stump S2. At this time, the dispute prediction model generating unit 5520 generates a prediction value of a dispute patent and a non-dispute patent by applying S1 and S2. With respect to the dispute patent and the non-dispute patent, prediction error information is generated by comparing a reaction parameter value of a dispute patent and a reaction parameter value of a non-dispute patent with a dispute prediction model value which is a prediction value generated by a second dispute prediction model candidate which is constituted with S1 and S2. Data of the dispute patent and the non-dispute patent is readjusted in consideration of generated prediction error information. A prediction value is generated for each patent P1 constituting dispute patent set and non-dispute patent set by using an i^{th} stump set (a set including S1 to Si stumps becomes the i^{th} dispute prediction model candidate). Then, error prediction information is generated by comparing the generated prediction value and a reaction parameter value of the patent Pi. The dispute patent set data and the non-dispute patent set data are readjusted with reference to the generated error prediction information so as to generate Sᵢ₊₁, and (i+1)^{th} dispute prediction model candidate using (i+1)^{th} stump set.

A significant size of a stump set including a number n of stumps S1, S2, . . . , Sn is generated through the above-mentioned process. 1) a dispute prediction element, 2) a split point, 3) a left node prediction value, 4) a right node prediction value, and 5) a prediction value when an application of split is impossible, are matched to each stump Si. 1) to 5) become a dispute prediction model candidate with respect to each of the number n of stumps Si.

A use of the dispute prediction model candidate will be described below. The dispute prediction model generating unit 5520 inputs a dispute prediction element value corresponding to each dispute prediction element of an arbitrary patent Pi to the dispute prediction model candidate with respect to the patent P1. The dispute prediction model generating unit 5520 applies a dispute prediction element value of each dispute prediction element to each corresponding stump (in a specific case of no corresponding stump, the dispute prediction element is not used for the model), so as to generate a prediction value corresponding to each stump. The prediction value may be any one of 3) the left node prediction value, 4) the right node prediction value, and 5) the prediction value when the application of a split is impossible. When the generated prediction value is added to all stumps, a dispute prediction model value is generated. That is, the dispute prediction model generating unit 5520 generates a dispute prediction model value of each patent P1 in such a manner that a dispute prediction element value of each dispute prediction element of a patent P1 is applied to a stump set which is the dispute prediction element candidate and all the generated prediction values are added. When the dispute patent reaction parameter value is set to 1, and the non-dispute patent reaction parameter value is set to 0, the dispute prediction model value of each patent Pi is present in a range of 0 to 1. If the dispute prediction model value of the patent P1 is less than 0.5, the patent P1 is regarded as a non-dispute patent. If the dispute prediction model value of the patent P1 is equal to and more than 0.5, the patent P1 is classified into a dispute patent. On the other hand, since the patent P1 is the dispute patent or the non-dispute patent, a reaction parameter value corresponding to the patent P1 is true. Generally, the true value is different from the prediction value.

Continuously, a method of generating an optimal or valid dispute prediction model in the dispute prediction model generating unit 5520 will be described. In a case where a dispute prediction model candidate uses a number n of stumps, the dispute prediction model is generated through a cross validation. Typically, when n becomes larger, a prediction possibility increases in a training set (including dispute patents and non-dispute patents). However, when n excessively increases, an over fitting occurs, thereby causing a decrease of a prediction performance in a test set (when the second divided dispute patent set and the second divided non-dispute patent set are used to verify the generated dispute prediction model candidate, they become the test set). Accordingly, it is important to determine a suitable size of n. With respect to generated dispute prediction model candidates M1, M2, . . . , Mi, the dispute prediction model generating unit 5520 generates a dispute prediction model value Mi (Pi) for an individual patent Pi included in the test set. The Mi (Pi) refers to a prediction value which is generated by applying a dispute prediction element value of each dispute prediction element of the patent Pi to a prediction model candidate Mi. On the other hand, a reaction parameter value of the patent Pi is defined by Y(Pi). If the reaction parameter value is 0 or 1, the Y(Pi) becomes 0 or 1. Continuously, the dispute prediction model generating unit 5520 calculates values of Y(Pi) and Mi(Pi) of all patents Pi constituting the test set, and substitutes the values for a given loss function so as to select an Mi in which a sum of the values is minimum.

FIG. 30 is a view illustrating an example of expressing a concept of an over fitting. In FIG. 30, with relation to a generation of a model in which red points and blue points are distinguished, when a model such as a green line is generated, the red points are definitely distinguished from the blue points in the train set. However, in this case, there is a problem in that a prediction performance is degraded in the test set which does not take part in the generation of the model. At this time, when a model such as a black line is generated, it becomes an appropriate classification model.

Continuously, a shrinkage parameter will be described. The determination of the importance of the tree is carried out by an algorithm of determining the importance of the tree. The shrinkage parameter is introduced in a generation of a prediction model in such a manner that a determined value of the tree importance obtained by the tree importance determination algorithm is multiplied by the shrinkage parameter, and it makes a performance of the model to be improved. In the tree importance determination algorithm, the tree importance can be determined by a cross validation process as a split point of each dispute prediction element is changed.

While the dispute prediction model generating unit 5520 generates a dispute prediction model, a dispute patent set can be divided when the dispute patent set has a significant size (since most patents have no dispute, a non-dispute patent set may have a significant size). However, if the dispute patent set has no significant size, an n-fold cross validation scheme can be used. FIG. 33 is a view illustrating a concept of an n-fold cross validation scheme. The dispute prediction model generating unit 5520 divides data in which dispute patents and non-dispute patents are mixed, into five sets. Then, the n-fold cross validation scheme is performed in such a manner of forming models with four sets according to each case and calculating a test error using one residual set so as to select a model which has a smallest error.

In the above-mentioned description, a classification model for two categories will be described. On the other hand, the classification model method can be applied to a number n of categories (non-dispute, dispute, multi-dispute, and the like). If the dispute patent has a dispute incurrence frequency in a range of 1 to a predetermined value, it is classified into as a dispute. Also, if the dispute patent has the dispute incurrence frequency in excess of the predetermined value, it may be classified as a multi-dispute. In this case, a reaction parameter value is set to 0 for relation to non-dispute, 1 for dispute, and 2 for multi-dispute. At this time, 2 does not indicate only a meaning of the number 2 and but also a non-dispute as a classified category, and is preferably regarded as a classification group which has a property different from a dispute. Accordingly, 3 or another numeric value instead of 2 may become a reaction parameter value. In this case, the reaction parameter may be expressed by a reaction parameter. For example, data of (1, 0, 0) indicates that a reaction parameter belongs to a first category, and data of (0, 1, 0) indicates that a reaction parameter belongs to a second category.

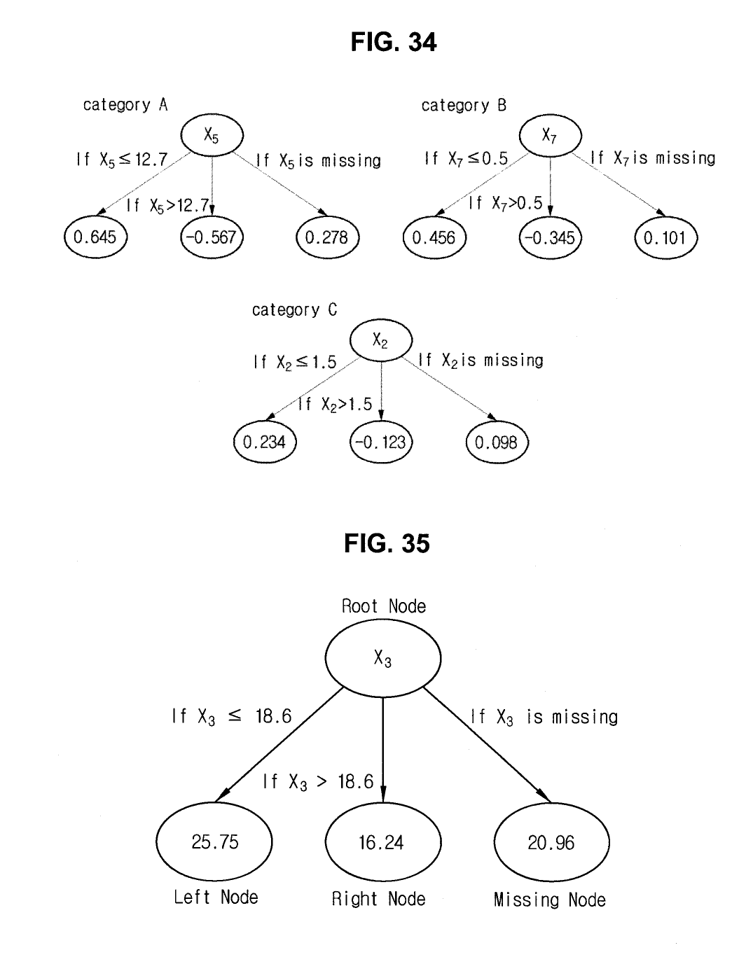

Continuously, a method of generating the dispute prediction model for three categories of A, B, and C by using a number n of classification models will be described with reference to FIG. 34. In a case of three categories differently from those shown in FIG. 32, a stump is generated in each category. That is, a stump for a category A, a stump for a category B and a stump for a category C, are respectively generated. Then, a probability is calculated in that each stump belongs to a corresponding category, and then respective data is allocated to the category having the largest probability. For example, if certain data is substituted for three stumps to obtain respective prediction values of 0.567, 0.456, and 0.234, the prediction value for the category B is the largest one. Therefore, there is the highest probability that this data belongs to the category B. Accordingly, this data is classified into the category B.

Continuously, a regression model will be described with reference to FIG. 35. The regression model is a type of statistical model used when reaction parameter values are continuous types. The dispute patent is classified into semi-dispute patents and dispute patents, and it is assumed that the semi-dispute patents have a low importance in comparison with the dispute patents with relation to dispute. In this case, a reaction parameter value of 0 may be allocated to the non-dispute patents, a reaction parameter value of 0.7 is allocated to the semi-dispute patent, and a reaction parameter value of 1 is allocated to the dispute patents. Otherwise, it is possible to allocate a reaction parameter value of 0 to the non-dispute patents, a reaction parameter value of 1.4 to the semi-dispute patents, and a reaction parameter value of 2 to the dispute patents. On the other hand, with respect to the multi-dispute patents, a reaction parameter value of 1 may be allocated to each dispute. In this case, it is possible to allocate a reaction parameter value of 0 to the non-dispute patent, a reaction parameter value of 1 to a patent having an dispute incurrence frequency of 1, a reaction parameter value of 2 to a patent having dispute incurrence frequency of 2, . . . , and a reaction parameter value of n to a patent having dispute incurrence frequency of n. On the other hand, in a case where dispute frequencies are divided into numbers n of categories, and a predetermined importance value (2 for frequencies of 2 to 5, 3 for frequencies of 6 to 20, 3 in excessive of frequencies of 20) is allocated to a patent having a dispute incurrence frequency of 1 with respect to each category, it is possible to allocate a reaction parameter value of 0 to a non-dispute patent, 1 to a patent having a dispute incurrence frequency of 1, 2 to a patent having dispute incurrence frequency of 2 to 5, and 3 to a patent in excessive of dispute incurrence frequency of 20. On the other hand, a reaction parameter value of 0.7 may be allocated to the semi-dispute patent. In a case where a different importance is applied to each kind of semi-dispute patent, a different reaction parameter value may be allocated to each kind of semi-dispute patent.

In a method of generating a dispute prediction model with relation to the regression model, the same stump as that used in the classification shown in FIG. 32 may be used. However, not deviance functions induced from a likelihood function but a minimum square error induced from normal distribution is used as a loss function at this time. A meaning of the prediction value is also changed. In the classification, the prediction value is a number relating to a probability that a reaction parameter value of corresponding data is 1. However, in the regression model, a prediction value relates to a reaction parameter itself. In FIG. 35, with respect to a description parameter X3, it is understood that the stump is split on the basis of a value of the description parameter X3 which is 18.6, and prediction values according to each split are indicated.

The method of making the stump in the regression model is not entirely different from that in the classification. The loss functions to be used are merely changed, and an optimum stump is generated according to the changed loss functions. In the classification, the loss functions are used based on a likelihood function of a binomial distribution, and in the regression, a minimum square error is used as the loss function. Further, a meaning of a prediction value is changed. In the regression, the prediction value relates to a reaction parameter itself, and in the classification, the prediction value relates to a probability that the reaction parameter has a value of 1.

On the other hand, as a specific case of the regression model, a re-dispute prediction model may be generated with relation to re-dispute patents of only the dispute patents. In this case, a sample includes only dispute patents, and a reaction parameter value becomes 1) a dispute incurrence frequency of a dispute patent, 2) a re-dispute incurrence frequency, 3) a category processing value of a dispute incurrence frequency, or 4) a category processing value of the dispute incurrence frequency. 1) a reaction parameter value of 1 may be allocated to a dispute patent having a dispute incurrence frequency of 1, a reaction parameter value of 2 may be allocated to a dispute patent having a dispute incurrence frequency of 2, and a reaction parameter value of n may be allocated to a dispute patent having a dispute incurrence frequency of n, and 2) a reaction parameter value of 0 may be allocated to a dispute patent having a dispute incurrence frequency of 1, a reaction parameter value of 1 may be allocated to a dispute patent having a dispute incurrence frequency of 2, and a reaction parameter value of n−1 may be allocated to a dispute patent having a dispute incurrence frequency of n−1. In the case of 3), a reaction parameter value of 1 may be allocated to a dispute patent having a dispute incurrence frequency of 1, a reaction parameter value of 2 may be allocated to a dispute patent having a dispute incurrence frequency of 2 to 5, a reaction parameter value of 3 may be allocated to a dispute patent having a dispute incurrence frequency of 6 to 20, and a reaction parameter value of 4 may be allocated to a dispute patent having a dispute incurrence frequency in excess of 20. In the case of 4), a reaction parameter value of 0 may be allocated to a dispute patent having a dispute incurrence frequency of 1, a reaction parameter value of 1 may be allocated to a dispute patent having a dispute incurrence frequency of 2 to 5, a reaction parameter value of 2 may be allocated to a dispute patent having a dispute incurrence frequency of 6 to 20, and a reaction parameter value of 3 may be allocated to a dispute patent having a dispute incurrence frequency in excess of 20.

The dispute prediction model generating unit 5520 generates a re-dispute prediction model by using the reaction parameter value in the same method as an information processing method of generating the dispute prediction model by using a dispute prediction element value for each dispute prediction element of a dispute patent Pi constituting a dispute patent set. A value which is generated by the re-dispute prediction model becomes the re-dispute prediction model value. The reason that the re-dispute prediction model is necessary is that it may be used to determine whether a patent in which a user is interested causes dispute again, or how many frequently the patent causes disputes. In order to generate the re-dispute prediction model, a regression model in which a reaction parameter is regarded as a dispute frequency is used. The re-dispute prediction model is employed only when 1) a method of classifying the dispute patent set into a patent set including patents having a dispute frequency of 1 is used, 2) a method of classifying the dispute patent set into a patent set including patents having a dispute frequency of more than 2 is used, 3) a method of classifying the non-dispute patent set into a patent set including patents which have caused no dispute is used, and 4) a method of classifying the non-dispute patent set into a patent set including patents which have a dispute frequency of 1 (a re-dispute frequency=0, and 2 in the present paragraph) is used.

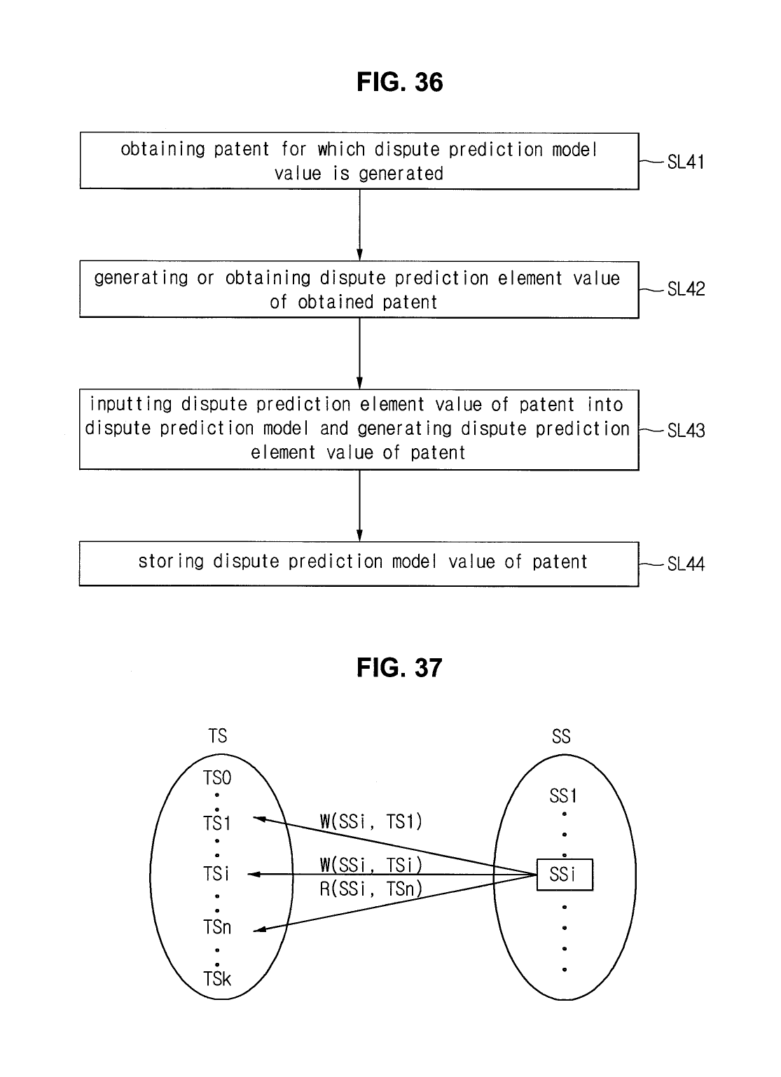

Continuously, a unit 5530 for generating a dispute prediction model value for each patent will be described with reference to FIG. 36. The dispute prediction model value generating unit 5530 obtains a patent for which a dispute prediction model value is generated in step SL41, generates or obtains a dispute prediction element value of the obtained patent in step SL42, inputs the dispute prediction element value of the patent to a dispute prediction model to generate a dispute prediction model value of the patent in step SL43, and stores the dispute prediction model value of the generated patent in step SL44.

The dispute prediction model value generating unit 5530 applies the dispute prediction model to a patent Pi so as to generate the dispute prediction model value. The dispute prediction model value generating unit 5530 may be used for a generation of a dispute prediction model (it has been described that the dispute prediction model generating unit 5520 applies a patent Pi as a dispute prediction model candidate to generate a dispute prediction model value for the dispute prediction model candidate. In this case, the dispute prediction model value generating unit 5530 operates as a subordinate of the dispute prediction model generating unit 5520, or the dispute prediction model generating unit 5520 cites and uses functions of the dispute prediction model generating unit 5520), and may use the dispute prediction model which the dispute prediction model generating unit 5520 generates independently from the dispute prediction model generating unit 5520, so as to generate the dispute prediction model value for each patent Pi which is optionally input. The patent dispute prediction model value generating unit 5530 applies the dispute prediction element value of each dispute prediction element which is generated by the dispute prediction element value generating unit 5510 with respect to the patent Pi, to a dispute prediction model so as to generate a dispute prediction model value of the patent Pi (SSn constituted of n number of stump sets is an example of the dispute prediction model. A dispute prediction model generated by using another statistical processing scheme becomes a dispute prediction model of the present invention).

The dispute prediction model value may be a value with a predetermined post-processing. Continuously, the post-processing will be described. If data (a dispute patent set and a non-dispute patent set) used in a construction of a model is randomly extracted from all patents, a statistical post-processing of the data is unnecessary. Otherwise, the statistical post-processing of the data is necessary. Several tens of thousands of cases make up the total number of dispute patents (in a case of the United States, about four million cases). Accordingly, when a random sample (a dispute patent set and a non-dispute patent set) is extracted from the population, it is difficult to make a good model because numbers of dispute patents are very small unless a size of the sample is significantly large. As a feature of the sample is fully grasped by including and analyzing a lot of dispute patents in the dispute patent set, a suitable model can be constructed. Therefore, the data is analyzed by a case-control study method. In a case of patent data, information on the dispute patents is collected in advance. Accordingly, only non-dispute patent data corresponding to the information is freely extracted and analyzed by the case-control study method. At this time, it is noted that it is necessary to convert a score obtained from the case-control sample into an original score because the score is not extracted from the population (total number of patents). In this case, a size of the entire population must be known. In the case of patent data of the United States, since a size of the entire population (about four million cases) is known, the original score of the data can be easily obtained by Bayes' theorem. The dispute prediction model value generating unit 5530 can calculate a final dispute prediction model score by using following Equation 1 induced from Bayes' theorem. In the following Equation 1, n1 indicates the number of dispute patents in the sample, n0 indicates the number of non-dispute patents in the sample, N1 indicates the number of all dispute patents, and N0 denotes the number of all non-dispute patents. A boosting score becomes a dispute prediction model value obtained by applying a dispute prediction element value corresponding to a patent Pi to a dispute prediction model which is generated by the dispute prediction model generating unit 5520.

$$final score = \frac{boosting score \frac{{N}_{1}}{{n}_{1}}}{( 1 - boosting score ) \frac{{N}_{0}}{{n}_{0}} + boosting score \frac{{N}_{1}}{{n}_{1}}} \qquad Equation 1$$

Equation 1 expresses a method of calculating the final score when a control sample is randomly extracted, and is changed when the control sample is extracted by a stratification sampling method. In each category on the basis of each patent classification, the sample has a different size, and the dispute prediction model value has a different statistical character. In order to suitably reflect the statistical character, it is taken into consideration that the non-dispute patents are extracted by using the stratification sampling in correspondence to a patent classification of the dispute patent during the sampling of the non-dispute patent. The stratification sampling is used in order to evenly extract samples in each patent classification category. When a sample is extracted by using the stratification sampling, the final score can be calculated by Equation 2. Here, s is an index to distinguish a patent classification category. For example, n₁ₛ indicates the number of dispute patents which are extracted as samples in a s^{th} patent classification category.

$$final score = \frac{boosting score \frac{{N}_{1 s}}{{n}_{1 s}}}{( 1 - boosting score ) \frac{{N}_{0 s}}{{n}_{0 s}} + boosting score \frac{{N}_{1 s}}{{n}_{1 s}}} \qquad Equation 2$$

As described above, the dispute prediction model value generating unit 5530 generates a dispute prediction model value for each patent. On the other hand, the dispute prediction model value generating unit 5530 can generate the dispute prediction model values for all patents in the patent DB 1120, and also can generate the dispute prediction model value with respect to a patent set which is constituted with at least one patent designated or managed by a user of the patent dispute prediction information generating system 5000. The generated dispute prediction model value is stored in the dispute prediction model value DB 5230. If required by an exterior to provide a dispute prediction model value for at least one patent, a dispute prediction model value providing unit 5540 of the present invention provides the dispute prediction model value for the patent. When a user selects at least one patent, or at least one patent list is indicated as a result of a search, the dispute prediction model value providing unit 5540 may provide the dispute prediction model value so that the selected patent or the searching result includes the dispute prediction model value.

The dispute prediction model value can be generated for each patent. The dispute prediction model value of the patent provides information relating to a probability that the patent becomes a dispute patent. Since there is a possibility that a patent having the dispute prediction model value becomes a dispute patent, the dispute prediction model value which sensitively relates to a dispute is referred to as patent litigation sensitivity.

The dispute prediction model value DB 7230 may include patent litigation sensitivity as the dispute prediction model value for at least two patents to which the dispute prediction model is applied. The patent litigation sensitivity prediction result may be a patent litigation sensitivity score for the patent, or a patent litigation sensitivity grade. Also, the patent litigation sensitivity prediction result may be a patent litigation sensitivity score or grade in view of each patent litigation sensitivity for the patent (patent litigation sensitivity in view of a citation, patent litigation sensitivity in view of multi-disputes, patent litigation sensitivity in view of a multi-dispute owner, patent litigation sensitivity in view of a multi-dispute technique group, and the like).

Each patent litigation sensitivity view may correspond to at least one subordinate patent litigation sensitivity view. On the other hand, at least one description parameter may correspond to the patent litigation sensitivity view or the subordinate patent litigation sensitivity view. The dispute prediction model generates a dispute prediction model value for each description parameter. Scores are generated to correspond to the patent litigation sensitivity view or the subordinate patent litigation sensitivity view by using the generated dispute prediction model value for each description parameter. For example, a citation view patent litigation sensitivity is a subordinate patent litigation sensitivity view of a patent litigation sensitivity view and corresponds to a patent litigation sensitivity in view of a total amount of citations, a patent litigation sensitivity in view of an increase and decrease of citations, and a patent litigation sensitivity in view of a recent citation. At least one description parameter such as a total cited frequency (description parameter Xi) corresponds to the subordinate patent litigation sensitivity called the patent litigation sensitivity view of the total amount of citations. In a case where at least one description parameter Xi value according to the dispute prediction model is generated with respect to the patent litigation sensitive object patent Pi, it is possible to generate a score of the subordinate patent litigation sensitivity view for the patent Pi by using the description parameter Xi.

Of course, the dispute prediction system 5000 performs a predetermined conversion processing for the dispute prediction model value of the patent P1 generated by using the dispute prediction model value, a score of at least one patent litigation sensitivity view, and a score of at least one subordinate patent litigation sensitivity view. In a case where a dispute prediction model value is generated by a dispute prediction model with relation to a plurality of patents (for example, all registered patents or sample patents extracted from all registered patents), it is possible for the dispute prediction model value not to be distributed preferably. In this case, the dispute prediction model converts the generated dispute prediction model value by applying the predetermined conversion regulation, so that the dispute prediction model value is preferably distributed. The conversion regulation includes a process of matching a range of a specific dispute prediction model value to a specific converted dispute prediction model value in a manner of one-to-one correspondence. Of course, in a case where the dispute prediction model is regulated or converted by using a predetermined conversion formula with respect to the dispute prediction model value, the dispute prediction model can be regulated so that a predetermined number of patents are included in a specific converted dispute prediction model value. The conversion processing is further necessary when it is difficult to immediately use the dispute prediction model value which the dispute prediction model generates. Of course, the dispute prediction model value including the conversion process may be generated. It should be understood that the dispute prediction model value includes the converted dispute prediction model value in not only the present paragraph but other paragraphs.

On the other hand, a perfect score may correspond to each patent litigation sensitivity view or each subordinate patent litigation sensitivity view, and the perfect score can be either identically or differently applied to each patent litigation sensitivity view and each subordinate patent litigation sensitivity view. At this time, the dispute prediction score of the patent P1 can be calculated below.

Dispute prediction model value of patent Pi=sum of {(patent litigation sensitivity score of patent litigation sensitivity view i according to dispute prediction model*perfect score of patent litigation sensitivity view i)/(sum of perfect score of patent litigation sensitivity view)}

Patent litigation sensitivity score=sum of {(patent litigation sensitivity score of subordinate patent litigation sensitivity view j according to dispute prediction model*perfect score of subordinate patent litigation sensitivity view j)/(sum of perfect score of subordinate patent litigation sensitivity view j)}

In a case where there are a litigation sensitivity object patent Pi and a patent Tj belonging to a similar patent group of the patent Pi, the dispute prediction system 5000 compares the patent Pi with the patent Tj with relation to the patent evaluation score. Further, the dispute prediction system 5000 can compare the dispute prediction scores according to each patent litigation sensitivity view or each subordinate patent litigation sensitivity view. On the other hand, the dispute prediction system 5000 may compare the dispute prediction scores of at least two subjects or at least two groups (the subject or the group includes at least one patent. For example, a company A may include ten patents, and a company B may include fifteen patents) with one another, and also may compare the dispute prediction scores with one another with relation to each patent litigation sensitivity view or each subordinate patent litigation sensitivity view. That is, the dispute prediction system 5000 can compare the dispute prediction score for each patent, the dispute prediction score for each patent according to patent litigation sensitivity view, and the dispute prediction score for each patent according to the subordinate patent litigation sensitivity view. Further, the dispute prediction system 5000 can generate sequential information or sequential comparison information on the dispute prediction score, the dispute prediction score according to each patent litigation sensitivity view, and the dispute prediction score according to each subordinate patent litigation sensitivity view.

Continuously, a method of generating a patent evaluation model will be described. The method of generating the patent evaluation model can be classified into four types. The four types include a regression model method, a survival model method, a recursive model method, and a complex model method. They will be described one by one.

The regression model method includes a first method of using a renewal registration frequency or a patent maintenance term of each patent as a reaction parameter, a second method of presuming a total cost which is paid from a filing of patent application to a patent expiration and using the total cost as a reaction parameter, and a third method of using an evaluation score of a patent which constitutes a sample patent group and is evaluated by an expert, as a reaction parameter.

The first method is a selected basic method on the assumption that a preferable patent is maintained for a long time. This method has an advantage on patent data of the United States in which a renewal registration fee is not in proportion to the number of claims. However, since this method relates to the number of claims or the number of independent claims/dependent claims, there is a disadvantage in that lots of adverse selections may be present according to the number of claims or a structure of claims. The adverse selection refers to a case in which a selection of registration renewal for which registration renewal fees are identical is different from a selection of renewal registrations depending on actual registration renewal. For example, it is assumed that there are a patent including ten claims and a patent P2 including one thousand claims, which are registered at an identical time point. Although an owner determines that the patent P2 is better than the patent P1, the owner may give up a renewal of the patent P2 and select a renewal and maintenance of the patent P1, because renewal fees of the patent P2 are significantly larger than those of the patent P1. If the renewal fees for two patents are identical, the renewal and maintenance of the patent P2 may be selected under a circumstance of selecting one of the two patents.

The second method is to overcome the first method. Not a renewal frequency and term of a registration but total renewal fees are selected as a reaction parameter. In a case where the number of claims which is changed at a time of renewing patent registration, or the renewal fees of the registration per claim are changed according to a renewal frequency of the registration or annual registration, the total maintenance fees for a patent can be used as a reaction parameter in consideration of the renewal fees of the registration. On the other hand, in the second method, the other costs which are paid for the maintenance of the patent up to the present may be presumed and calculated in addition to the renewal fees of the registration. For example, the other costs include an agent fee according to an agent filing fee model, a filing fee to a patent office, a cost according to an agent lapse event cost model, a fee to a patent office according to a lapse event, and the like. An example of the agent filing fee model includes all of a basic agent fee for filing, claim fees, and a specification/drawing fee. An example of the claim fees includes the number of claims*fee per claim, or all of the number of independent claims*fee per independent claim and the number of dependent claims*fee per dependent claim. An example of the specification/drawing fee includes pages of the specification*fee per page and the number of figures*fee per figure. The lapse event includes an office action of a patent office before an issuing of a patent, an event such as an invalidation trial after the issuing of the patent, an event such as a patent infringement litigation relating to a court, and the like. The cost of the lapse event includes a presumption cost according to a presumption cost model of each event. On the other hand, the patent official fee may be changed according to a fee policy of the patent office at a certain time point. Accordingly, the patent official fee follows the fee policy of the patent office. As described above, in the second method, the total maintenance cost till a time when the patent right is maintained is used as a reaction parameter.

The patent evaluation model can be generated by calculating a total cost presumption value according to a predetermined total cost presumption model for each patent, and performing a predetermined statistical process by respectively using the total cost presumption value and the patent evaluation element value as a reaction parameter value and the description parameter value. The total cost presumption model includes an agent fee presumption and an official fee presumption, which may be carried out for each event. The event includes at least one of a filing event, an event from filing to registration, and an event after the registration (after a grant of a patent right).

In the third method, an expert evaluates a sample patent, and the evaluation value is used as a reaction parameter. This method can improve accuracy of a patent evaluation over the other methods. However, it incurs a heavy cost to generate an evaluation result. There is a disadvantage in that an evaluation score of respective experts for an identical patent often is very different.

When the reaction parameters are generated through the first method to the third method, the regression method described with relation to the generation of the dispute prediction model is employed so as to generate a patent evaluation model.

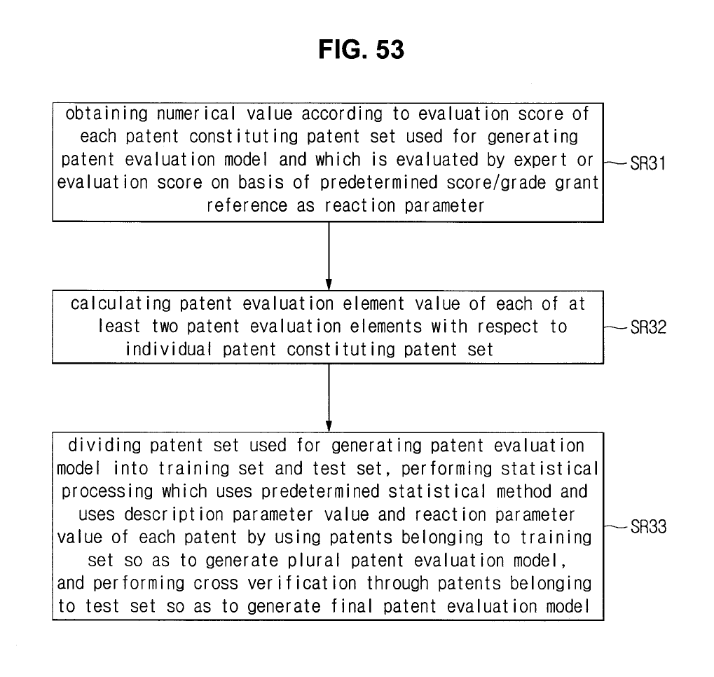

FIG. 53 is a flowchart illustrating an exemplary process of generating a patent prediction model. A patent evaluation model generating engine 7500 obtains a numeric value, which is based on an evaluation score grant reference according to an evaluation score which an expert gives to each patent constituting a patent set for a generation of a patent evaluation model, or a predetermined score/grade grant reference, as a reaction parameter in step SR31, calculates a patent evaluation element value for each of at least two patent evaluation elements of each patent constituting the patent set or obtains a previously calculated patent evaluation element value as a description parameter value in step SR32, and divides the patent set for the generation of the patent evaluation model into a training set? and a test set before a plurality of patent evaluation models are generated by applying the description parameter and reaction parameter to each patent to perform a statistical processing for the patents belonging to the training set and a final patent evaluation model is generated by performing a cross validation through the patents belonging to the test set, in step SR33.

Here, the evaluation score reference according to the predetermined score/grade grant reference includes a renewal frequency of a patent registration, a term of the patent registration, a total cost of the patent maintenance, and the like.

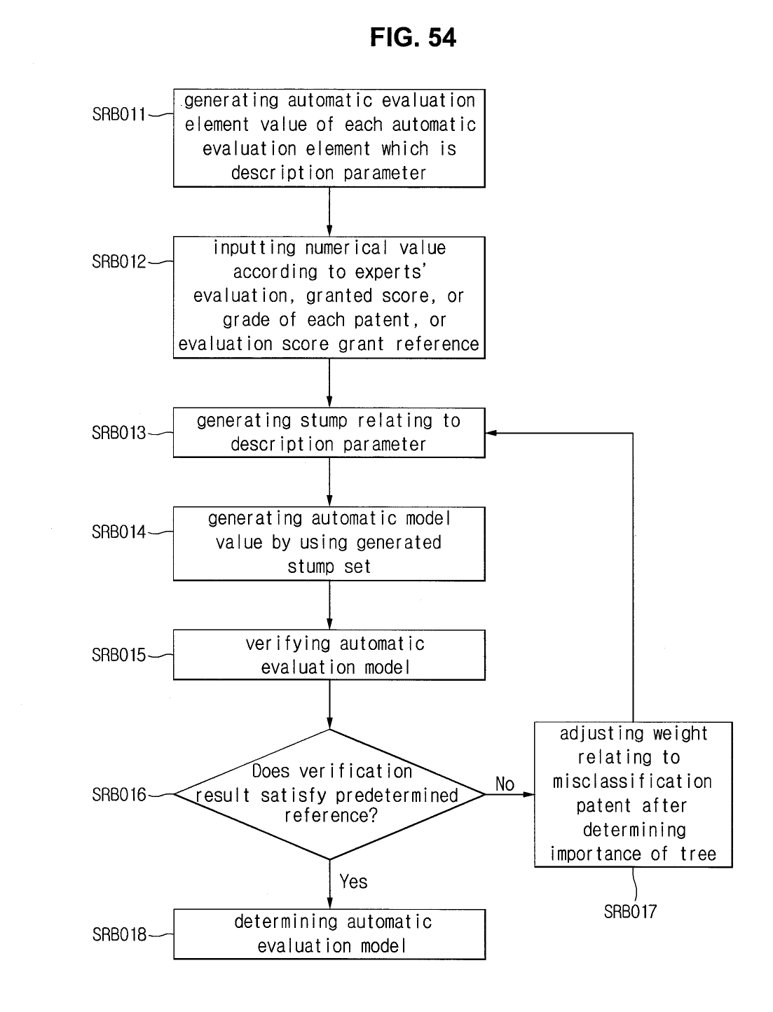

FIG. 54 is a flowchart illustrating a method of processing information in a patent evaluation model generating unit of the present invention. The patent evaluation model generating unit 7520 generates a patent evaluation element value of each patent evaluation element which is a description parameter, with respect to the patents belonging to a patent set for a generation of a patent evaluation model in step SRB011, and inputs a score or grade which an expert evaluates and gives to each patent, or a numeric value according to an evaluation score grant reference, as a reaction parameter, or sets a patent evaluation score (which the expert evaluates and gives to each patent) as a reaction parameter in step SRB012. Continuously, the patent evaluation model generating unit 7520 generates a first stump for at least one of the description parameters in step SRB013, generates a patent evaluation model value by using a first stump set including the first stump in step SRB014, and verifies the patent evaluation model value in step SRB015. As a result of the verification, if the patent evaluation model value does not satisfy a predetermined reference in step SRB016, a misclassification patent object weight is adjusted after the importance of a tree is determined in step SRB017. Then, the patent evaluation model generating unit 7520 generates a second stump for the description parameter, generates a patent evaluation model value by using the first and second stumps, and verifies the patent evaluation model value. Until the verifying result satisfies the predetermined reference, the generating of the stump, the generating of the patent evaluation model value by using the generated stumps, and the verifying of the patent evaluation model vale are repeated. As a result of the verification, if the patent evaluation model value satisfies the predetermined reference, the patent evaluation model is determined by joining the generated stumps in step SRB018.

The patent evaluation model generating unit 7520 generates a stump corresponding to each description parameter. According to circumstances, a general tree instead of the stump may be used. The patent evaluation model generating unit 7520 analyzes a description parameter value and a reaction parameter value so as to generate at least one stump including an important patent evaluation element. The stump includes five pieces of information such as 1) a patent evaluation element, 2) a split point, 3) a left node prediction value, 4) a right node prediction value, and 5) a prediction value when an application of a split is impossible. In a rule of generating a split, it is preferable to minimize a given loss function and to seek a reference point of the split and a prediction value. In the above-mentioned case, Deviance, Exponential loss function, etc. can be used as loss function.

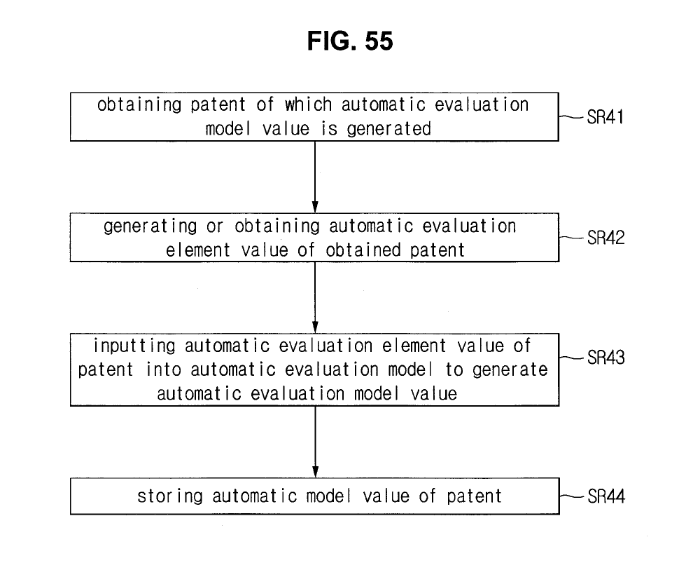

A unit for generating a dispute prediction model value for each patent will be described with reference to FIG. 55. The patent evaluation model value generating unit 7530 obtains a patent for which a patent evaluation model value is generated in step SR41, generates or obtains a patent evaluation element value of the obtained patent in step SR42, inputs the patent evaluation element value of the patent to a patent evaluation model to generate a patent evaluation model value of the patent in step SR43, and stores the patent evaluation model value of the generated patent in step SR44.

The patent evaluation model value generating unit 7530 applies the patent evaluation model to a patent Pi so as to generate the patent evaluate model value. The patent evaluation model value generating unit 7530 may be used for a generation of a patent evaluation model (it has been described that the patent evaluation model generating unit 7520 applies a patent Pi as a patent evaluation model candidate to generate a patent evaluation model value for the patent evaluation model candidate. In this case, the patent evaluation model value generating unit 7530 operates as a subordinate of the patent evaluation model generating unit 7520, or the patent evaluation model generating unit 7520 cites and uses functions of the patent evaluation model generating unit 7530), and may use the patent evaluation model which the patent evaluation model generating unit 7520 generates independently from the patent evaluation model generating unit 7520, so as to generate the patent evaluation model value for each patent Pi which is optionally input. The patent evaluation model value generating unit 7530 applies the patent evaluation element value of each patent evaluation element which is generated by the patent evaluation element value generating unit 7510 with respect to the a patent Pi, to a patent evaluation model so as to generate a patent evaluation model value of the patent Pi (SSn constituted with n number of stump sets is an example of the patent evaluation model. A patent evaluation model generated by using another statistical processing scheme becomes a patent evaluation model of the present invention).

Continuously, a survival model using a survival analysis will be described in more detail.

In the United States, an owner determines whether annual registration for an owner's registered patent renews every four years. In Korea, an owner determines whether annual registration for an owner's registered patent renews every year after a time lapse of three years from the patent registration. A patent of which registration is renewed exists, and a patent of which registration is not renewed is invalid. A term of four years or one year becomes a reference term unit of registration renewal according to the provision of law in every nation.

The survival analysis is a statistical method which analyzes data which is provided until an interesting event occurs. It is characterized that it includes a censored data. When the survival analysis scheme is applied to annual registration data, the data may be censored in the middle of a processing. All patents are forcedly lapsed by law in twenty years from their filing date (in a case of patents in the United State before 2001, a right term is seventeen years from a registration date, or a term longer than seventeen years is applied to a patent under a specific condition). If most object patents stay in a state in which a forced lapse date of the patent right does not pass in law, and the patents are valid at the present, the patents become a termination of the study. During the survival analysis, the data is regarded as the censored data.

For the survival analysis, it is preferable that parameter values changed according to a passage of time among the parameter values of the description parameter are generated by a predetermined time unit. The predetermined time unit may be annual unit, or a renewal term of patent registration (every four years in the United States). For example, it is assumed that a patent Pi registered in 2001 is cited by a frequency indicated in Table 7.

TABLE 7

| | Year | | | | | | | | | | | |
|---|---|---|---|---|---|---|---|---|---|---|---|---|
| | 2000 | 2001 | 2002 | 2003 | 2004 | 2005 | 2006 | 2007 | 2008 | 2009 | 2010 | 2011 |
| Cited | 0 | 1 | 2 | 3 | 4 | 5 | 6 | 2 | 2 | 1 | 1 | 1 |
| frequency | | | | | | | | | | | | |
| per year | | | | | | | | | | | | |

In the case, a total cited frequency of a description parameter of a patent Pi in Table 1 is 28, and a cited frequency of the description parameter of the patent Pi is five for the recent four years (in a case where n=4 in a cited frequency for the recent n years).

Accordingly, the patent evaluation element value generating unit 7510 may generate an evaluation element value data every year, as indicated in Table 8.

TABLE 8

| Year | Total cited-frequency | Cited-frequency for recent four years |
|---|---|---|
| 2000 | 0 | 0 |
| 2001 | 1 | 1 |
| 2002 | 3 | 3 |
| 2003 | 6 | 6 |
| 2004 | 10 | 10 |
| 2005 | 15 | 14 |
| 2006 | 21 | 18 |
| 2007 | 23 | 17 |
| 2008 | 25 | 15 |
| 2009 | 26 | 11 |
| 2010 | 27 | 6 |
| 2011 | 28 | 5 |

In Table 8, the total cited-frequency is defined by a sum of cited-frequency every year until a corresponding year, and the cited-frequency for the recent four years is defined by a sum of cited-frequency for late four years until a corresponding year.

Accordingly, the patent evaluation element value generating unit 7510 may generate an evaluation element value data in every four years, as indicated in Table 9. Here, a renewal of a patent registration every four years is achieved on the basis of a year of the patent registration.

TABLE 9

| Year | Total cited-frequency | Cited-frequency for recent four years |
|---|---|---|
| 2000 | 0 | 0 |
| 2004 | 10 | 10 |
| 2008 | 25 | 15 |

As indicated in Tables 8 and 9, if data is generated every year, there is a problem in that an amount of calculation and a storage space is required. However, the data has an advantage of accuracy. On the other hand, the patent evaluation element value generating unit 7510 may generate an evaluation element value not in every year but every quarter of a year or every month.

Most description parameter values of the description parameter as indicated in Tables 1 to 4 may be changed at a specific time point after a registration of a patent. Especially, the description parameter values relating to a citation may be changed, and also description parameter values relating to a dispute having a characteristic of an event, an assignment and the like may be changed. On the other hand, the number of claims, and the like may be change via withdrawal.

In order to carry out the survival analysis, data indicated Tables 8 and 9 is generated with respect to each of patents which constitute a sampled patent set. Then, the survival analysis is carried out by using the generated data. In the survival analysis, presumption of a survival function S(t), presumption of a hazard function h(t), or presumption of an intensity function I(t) are the core of the survival analysis. A value of the survival function at a time point t is defined by a probability that the registration of a patent right is maintained until the time point t. A method of presuming the survival function includes a parametric model and a non-parametric model. It is relatively preferable to mainly use the non-parametric model. Various statistical methods of presuming the survival function may be used in the present invention. The hazard function at a time point t is defined by a conditional probability that a patent right of which a registration is renewed until the time point t is invalid just after a passage of the time point t.

In the present invention, the function S(t), h(t) or I(t) is generated by applying a tree ensemble mechanic learning method. When the function S(t), h(t) or I(t) is generated, a description parameter value generated in a unit of every year can be used. The description parameter value of every year can be generated on the basis of the year-end, the beginning of the year, a certain time point throughout the year, and preferably it is generated on the basis of the year-end. In a case where the function S(t), h(t), or I(t) are generated on the base of the end of 2010, a patent of which the registration is maintained becomes a right censored data. During an application of the survival analysis, an importance of handling of the censored data cannot be emphasized too much. Functions S(t), h(t) or I(t) of a certain year can be generated by applying a description parameter value and a reaction parameter value until the certain year to the above-mentioned mechanic learning algorithm.

The patent evaluation model of the present invention may include various functions derived from the survival analysis, and functions obtained by reprocessing the functions using a predetermined relation formula. An example of the functions corresponding to the patent evaluation model includes a 1−h(t). When a patent evaluation element value of a patent Pi is determined and applied to the 1−h(t), a patent evaluation model value at an issuing of the patent is generated.

A method of generating a patent evaluation model and a patent evaluation model value by using a survival analysis method in the patent evaluation model generating engine 7500 will be described. The patent evaluation element value generating unit 7510 generates a value of at least one description parameter by using patent data generated by a predetermined time unit before a certain time point in step SSM11, and the patent evaluation model generating unit 7520 determines the presence or absence of the survival of the patent on the basis of a predetermined time and performs the predetermined survival analysis by using a value corresponding to the presence or absence of the survival of the patent as a reaction value in step SSM12, and generates a patent evaluation model by using at least one of survival analysis results in step SSM13. Continuously, the patent evaluation model value generating unit 7530 generates a patent evaluation model value by applying the generated patent evaluation model.

Continuously, the recursive model of the present invention will be described. The recursive model reflects a view that a value of a patent which is cited by a high-evaluated patent having a high patent evaluation model value is higher than that of a patent which is cited by a low-evaluated patent.

The patent evaluation model generating unit of the present invention generates a first patent evaluation model value of all registered patents (invalid registered patents may be included) by using a first patent evaluation model generated by any one of three types of the regression model, or the survival model. The first patent evaluation model value may include a score, a grade, or a value obtained by normalizing the score and the grade. When generating a description value of a citation view of Table 1 which corresponds to each patent Pi, the patent evaluation element value generating unit of the present invention reads a first patent evaluation model value of child patents which cite the patent Pi and reflects the first patent evaluation model value to generate the description parameter value. Following Table 10 indicates description values generated by reflecting the first patent evaluation model values of three when three child patents PC1, PC2 and PC3 cite the patent Pi.

TABLE 10

| | First patent evaluation model value | Citation occurrence year |
|---|---|---|
| PC1 | 0.7 | 2004 |
| PC2 | 1.5 | 2008 |
| PC3 | 1.2 | 2010 |

When there are data indicated in Table 10, the patent evaluation element value generating unit 7510 generates a patent evaluation element value of each patent evaluation element as indicated in Table 11.

TABLE 11

| | | Cited-frequency for recent |
|---|---|---|
| Patent evaluation element | Total cited-frequency | four years |
| Non-regression model | 3 | 2 |
| Regression model | 3.4(= 0.7 + 1.5 + 1.2) | 2.7(1.5 + 1.2) |

As indicated in Table 11, it will be understood that patents having a first patent evaluation model value of relatively high score recently cite a patent Pi (assuming that the first patent evaluation model value is normalized to obtain an average of 1). On the contrary, description values relating to a patent Pj are indicated in Table 12.

TABLE 12

| | First patent evaluation model value | Citation occurrence year |
|---|---|---|
| PC4 | 1.5 | 2004 |
| PC5 | 1.2 | 2008 |
| PC6 | 0.7 | 2010 |

In this case, patent evaluation element values relating to Pj are indicated in Table 13.

TABLE 13

| | | Cited-frequency for recent |
|---|---|---|
| Patent evaluation element | Total cited-frequency | four years |
| Non-regression model | 3 | 2 |
| Regression model | 3.4(= 0.7 + 1.5 + 1.2) | 1.9(1.2 + 0.7) |

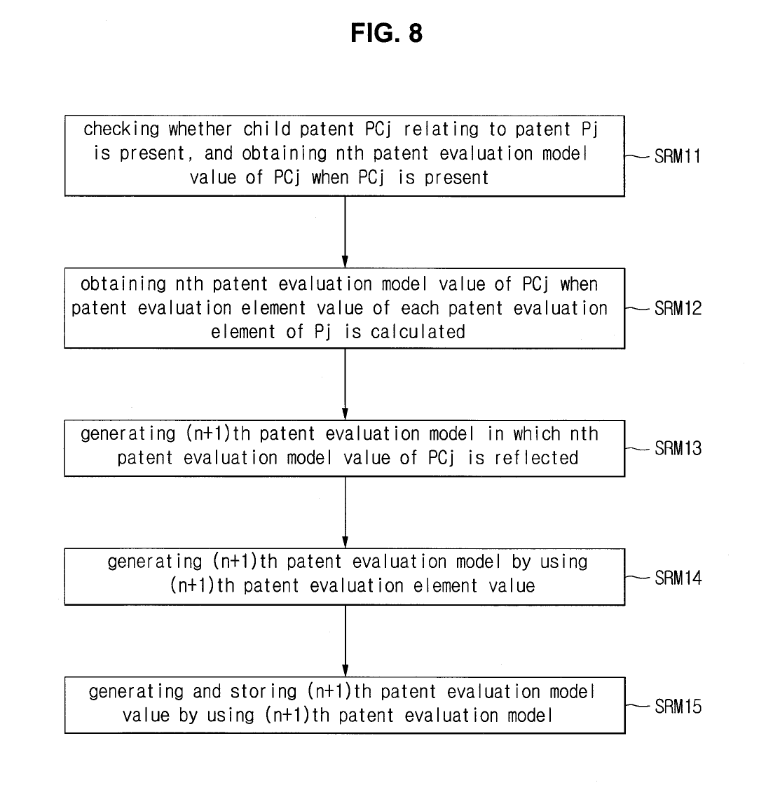

A core of the regression model according to the present invention is to differently process values of a patent Pi and a patent Pj when the cited-frequency for the recent four years is considered as an important parameter. A method of processing information in the patent evaluation model generating engine 7500 with respect to the regression model is well shown in FIG. 8.

The patent evaluation element value generating unit 7510 generates a first patent evaluation element value of each patent evaluation element indicated Tables 1 to 4 with respect to a patent Pi, and generates a first patent evaluation model by using the first generated patent evaluation element value in any one of patent evaluation model generating methods of the present invention. The patent evaluation model value generating unit 7530 of the present invention generates and stores a first patent evaluation model value for each patent by using the first patent evaluation model. The first patent evaluation model value may be generated with respect to each of all registered patents (including invalid patents).

Continuously, when generating a patent evaluation element value of each patent evaluation element indicated in Tables 1 to 4 with respect to a patent Pi, the patent evaluation element value generating unit 7510 checks whether a child patent PCj of the patent Pi is present, and obtains a first patent evaluation model value of the patent PCj if the patent PCj is present. Then, the patent evaluation element value generating unit 7510 obtains a first patent evaluation model value of the patent PCj when calculating a patent evaluation element value of at least one patent evaluation element of the patent Pi. Continuously, the patent evaluation element value generating unit 7510 generates a second patent evaluation element value to which a first patent evaluation model value of the PCj is reflected. Continuously, the patent evaluation model generating unit 7520 generates a second patent evaluation model by using the second patent evaluation element value in at least one patent model generating method of the present invention. Preferably, the first patent evaluation model and the second patent evaluation model are generated by using an identical patent evaluation model generating method, but may be generated in a different patent evaluation model generating method.

A method of processing the information in the patent evaluation model generating engine 7500 will be described with reference to FIG. 8.

The patent evaluation element value generating unit 750 checks whether a child patent PCj of a patent Pi is present, in step SRM11. If the PCj is present, the patent evaluation element value generating unit 7510 obtains the n^{th} patent evaluation model vale of the patent PCj, and obtains the n^{th} patent evaluation model value of the PCj when calculating a patent evaluation element value of at least one patent evaluation element of the patent Pi, in step SRM12. Continuously, the patent evaluation element value generating unit 7510 generates a (n+1)^{th} patent evaluation element value to which a n^{th} patent evaluation model value of the patent PCj is reflected in step SRM13. In turn, the patent evaluation model generating unit 7520 generates (n+1)^{th} patent evaluation model by using the (n+1)^{th} patent evaluation model element value, in step SRM14. In turn, the patent evaluation model generating unit 7530 generates and stores the (n+1)^{th} patent evaluation model value of the patent Pi by using the (n+1)^{th} patent evaluation model, in step SRM15.

On the other hand, the patent evaluation model generating engine 7500 continuously generates an n^{th} patent evaluation model value and an (n+1)^{th} patent evaluation model value by increasing n with respect to a plurality of patents i which are extracted to verify astringency. It is preferred that the patent evaluation model value not diverges but converges as the n increases. An example of verifying the astringency is to measure which important decrease pattern a variation of a patent evaluation model value of a patent Pi shows statistically as the n increases, with respect to the patents Pi which belong to an astringency verification patent set extracted from whole registered patent set. That is, the astringency can be verified by identifying whether an average of verification of the patent evaluation model value of each patent Pi (“(n+1)^{th} patent evaluation model value”−“n^{th} patent evaluation model value”) statistically and meaningfully decreases as n increases.

Statistical treatments such as various kinds of statistical analysis and the like are carried out in order to verify astringency. Although the patent evaluation model value does not converge, a purpose of introducing the regression model of the present invention is sufficiently established. Accordingly, it may be preferable to use the regression model rather than the non-regression model in order to evaluate a patent.

On the other hand, for the purpose of generating the dispute prediction model, when a dispute prediction element value of each dispute prediction element is generated, the first patent evaluation model value or the n^{th} patent evaluation model value of each patent, which is generated and stored, may be used.

Continuously, the complex model will be described. The complex model is a scheme of generating a patent evaluation model value in a manner of adding patent evaluation model values generated by using at least two single models. For example, with respect to a patent Pi, it is possible to add a weighted average to a patent evaluation model value of each model generated by using at least two of one or more regression models, one or more survival models, and one or more recursive models (recursive models are generated in proportional to feedback or recursive frequency), so as to generate a complex patent evaluation model value.

The patent evaluation model value DB 7230 includes an evaluation result of evaluating at least two patents by applying a patent evaluation model. The evaluation result may include an evaluation score and evaluation grade for the patent, or an evaluation score and grade in view of evaluation for the patent such as technique, right, marketability, a ripple effect, originality, and the like.

The evaluation view corresponds to at least one subordinate evaluation view. On the other hand, the evaluation view or the subordinate evaluation view corresponds to at least one description parameter. The patent evaluation model generates a patent evaluation model value for each description parameter. Scores are generated to correspond to the evaluation view or the subordinate evaluation view by using the generated patent evaluation model value for each description parameter. For example, the evaluation view of technique may correspond to a subordinate evaluation view of technical influence, a technical ripple effect, technical attraction, technical continuation, and the like. It is possible to make at least one description parameter, such as total cited-frequency (description parameter Xi), correspond to the subordinate evaluation view of the technical influence. In a case where at least one description parameter Xi value according to the patent evaluation model is generated with respect to the evaluation object patent Pi, it is possible to generate a score of the subordinate evaluation view for the patent Pi by using the description parameter Xi.

Of course, the patent evaluation system 7000 performs a predetermined conversion processing for the patent evaluation model value of the patent P1 generated by using the patent evaluation model value, a score of at least one evaluation view, and a score of at least one subordinate evaluation view. In a case where a patent evaluation model value is generated by a patent evaluation model with relation to a plurality of patents (all registered patents or sample patents extracted from all registered patents), it is possible for the patent evaluation model value not to be distributed preferably. In this case, the patent evaluation model converts the generated patent evaluation model value by applying the predetermined conversion regulation, so that the patent evaluation model value is preferably distributed. The conversion regulation includes a processing of matching a range of a specific patent evaluation model value to a specific converted patent evaluation model value in a manner of one-to-one correspondence. Of course, in a case where the patent evaluation model is normalized or converted by using a predetermined conversion formula with respect to the patent evaluation model value, the patent evaluation model can be regulated so that a predetermined number of patents are included in a specific converted patent evaluation model value. The conversion processing is further necessary when it is difficult to immediately use the patent evaluation model value which the patent evaluation model generates. Of course, the patent evaluation model value including the conversion processing may be generated. It should be understood that the patent evaluation model value includes the converted patent evaluation model value in not only the present paragraph but other paragraphs.

On the other hand, a perfect score may correspond to each evaluation view or each subordinate evaluation view, and the perfect score can be either identically or differently applied to the evaluation view and the subordinate evaluation view. At this time, the patent evaluation model value of the patent P1 can be calculated below.

Patent evaluation model value of patent Pi=sum of {(evaluation score of evaluation view I according to patent evaluation model*perfect score of evaluation view)/(sum of perfect score of evaluation view)}

Evaluation score of evaluation view I according to patent evaluation model=sum of {(evaluation score of subordinate view j according to patent evaluation model*perfect score of subordinate evaluation view j)/(sum of perfect score of subordinate evaluation view j)}

In a case where there are an evaluated object patent Pi and a patent Tj belonging to a similar patent group of the patent Pi, the patent evaluation system 7000 compares the patent Pi with the patent Tj with relation to the patent evaluation score. Further, the patent evaluation system 7000 can compare the patent evaluation scores according to each evaluation view or each subordinate evaluation view. On the other hand, the patent evaluation system 7000 may compare the patent evaluation scores of at least two subjects or at least two groups (the subject or the group include at least one patent. For example, a company A may include ten patents, and a company B may include fifteen patents) with one another, and also may compare the patent evaluation scores with one another with relation to each evaluation view or each subordinate evaluation view. That is, the patent evaluation system 7000 can compare the patent evaluation score for each patent, the patent evaluation score for each patent according to evaluation view, and the patent evaluation score for each patent according to the subordinate evaluation view. Further, the patent evaluation system 7000 can generate sequential information or sequential comparison information with respect to the patent evaluation score, the patent evaluation score according to each evaluation view, and the patent evaluation score according to each subordinate evaluation view.

Continuously, a method of generating dispute prediction information through the dispute prediction model will be described with reference drawings.

The dispute prediction engine 5100 firstly obtains a self-patent set including at least one patent, and secondly obtains at least one target patent set including at least one patent relating to the self-patent. Otherwise, the dispute prediction engine 5100 firstly obtains a target patent set including at least one patent, and secondly obtains at least one self-patent set relating to the target set, in step SL51. Continuously, the dispute prediction engine 5100 obtains a dispute prediction model value of each patent constituting the target patent set in step SL52, and generates at least one piece of dispute prediction information by using the dispute prediction model value of each patent in step SL53. Hereinafter, it will be described in detail.

Firstly, a self-patent set SS is defined. The self-patent set refers to a patent group which includes at least one patent corresponding to a predetermined input of a system or an input which a user inputs to generate dispute prediction information. The input may include any one or at least one combination of at least one patent input, at least one owner input, at least one inventor input, at least one patent classification input and at least one searching formula. The searching formula properly includes a searching formula of each field and each field combination for loading patents stored in a patent DB 1120, and also includes an input of a searching keyword for a certain field. For example, a user can generate a technical field tree of his/her company, a domestic, foreign, or each national competing or related company tree, a tree for each technical field corresponding to a function of a related product of a users' company, a tree of at least one patent group which the users' company manages, and a searching formula tree for loading a patent group in which the users' company is interested. An end node of each tree may correspond to users' input or condition, or individual patent documents. It is obvious that the tree may be a multi-stage tree including at least one stage. The IPC layered structure is a representative example of the multi-stage tree. A self-patent set generating unit 5110 of the present invention generates the self-patent set.

The self-patent set is a patent set including at least one publication or registered patent which the user or the patent dispute prediction information generating system 5000 generates, selects or designates. The self-patent set generating unit 5110 of the dispute prediction engine 5100 generates or obtains a self-patent including at least one patent to constitute a self-patent set. The generation of the self-patent set may be performed by a search engine or by a search through DBMS. The self-patent set may be generated in such a manner that a user designates at least one stored patent set or a patent set resulted from a calculation of the patent set, or designates at least one patent included in the patent set. The self-patent set need not be patents which a users' company maintains, and preferably includes patents which the user is interested in. The user can manage interested patents in a manner of the tree having the multi-stage layered structure. Each node constituting the tree has a node name, and corresponds to at least one patent.

A reason for introducing of the self-patent SSi is as follows. A patent dispute is a problem of a relation between a plaintiff's patent right and a defendant's machine, product, method, and a composite (hereinafter, they are referred to as products), and is not a problem of a plaintiff's patent and a defendant's patent. Accordingly, it is necessary to trace or reflect the defendant's product to data which the system can process. Therefore, the user of the present invention needs to input a patent group relating to a product which the user is interested in, so that the system can recognize the patent group. An example of an input of the patent group relating to the product includes 1) an input of the patents if a technique is patented among techniques, such as a function, a structure, a method, and a material of a plaintiff's company's product, reflected to the product, 2) an input of a defendant's patent relating to the plaintiff's product if the plaintiff has no patent or lacks patents, 3) an input of a person's patent relating to the plaintiff's product, 4) a patent classification input of a technical field relating to the plaintiff's product, and 5) an input of searching formulas used for searching for patents relating to the plaintiff's product. A patent group relating to the product can be specified by at least one input or at least one combination input of the above-mentioned inputs 1) to 5). The system generates patent dispute prediction information by not directly using the product, but the patent group to which the product is reflected.

The user can set a subjective weight for the self-patent SSi even when configuring the self-patent set. The setting of the weight is performed through the UI provided by a weight regulating unit 5143 of the present invention. The UI provides a list of patents which belong to the self-patent set SS, and allows the user to input a weight, an importance, or an important grade in the patent list. The weight is referred to as a self-patent set weight. The self-patent set weight is reflected to a target set TS which is generated by using the self-patent SSi and described later.

The patents belonging to the self-patent set SS are referred to as the self-patent SSi. A target patent set TS is defined with relation to each self-patent SSi. The target patent TS refers to a patent set which a user or the system specifies in a manner of generating, designating, or inputting the patent set for a purpose of generating the self-patent SSi and the dispute prediction information. A target patent set generating unit 5120 of the present invention generates the target patent set. The target patent set refers to a patent set including self-patents which belong to the self-patent set, and the target patent which have a predetermined relation. The target patent set generating unit 5120 of the present invention generates the target patent set by using the self-patent set, or in a manner that the user or the patent dispute prediction information generating system 5000 designates or selects. The former will be described in detail. The predetermined relation includes 1) a citing-cited patent relation, 2) a similar patent group relation in a text mining method, 3) a similar technique patent relation in the patent classification, and 4) a designated patent group relation including patents which the user designates.

Continuously, a method of generating dispute prediction information by using weight information on each target patent in consideration of the predetermined relation information in the dispute prediction engine 5100 will be described. The dispute prediction engine 5100 obtains a self-patent set in step SL61, and extracts a target patent having a predetermined relation with each patent constituting the self-patent set so as to generate the target patent set in step SL62. Continuously, the dispute prediction engine 5100 obtains or generates the relation information on the target patent in SL63, generates weight information on each target patent in step SL64, and generates at least one piece of dispute prediction information by using the weight information on the target patent in step SL65.

FIG. 37 shows a setting of the predetermined relation between each self-patent constituting the self-patent set and each target patent constituting the target patent set. The relation is defined as R(SSi, TSi) which is a value generated between the SSi and the TSi. As shown in FIG. 37, one SSi may relate to at least one TSi, and also one TSi may relate to at least one SSi. In FIG. 37, R(SS1, TS1), R(SS1, TS2), and R(SS2, TS2) may be different, and in view of the TS2, the TS2 has two relations R(SS1, TS2) and R(SS2, TS2). The TSi may have n relations, and the relations are used to generate a weight W(TSi) for the TSi. For example, when the relation is the similar patent group relation in a text mining, the R(SSi, TSi) may be a similarity in which a predetermined keyword similarity function is applied on the basis of a core keyword between the SSi and TSi. On the other hand, if the relation is a citation, the R(SSi, TSi) may be a citation relation function value which is added in consideration of a type of the citation.

The citing-cited relation indicates a relation between the self-patent and the target patent, which corresponds to at least one of 1) a direct citation, 2) an indirect citation having a citation depth of n (n>1), 3) a latent citation, 4) a chain citation, and 5) a family citation, as are described above. In a case where an individual patent P1 is present, a predetermined different citation weight may be provided to each type of citation. The similar patent group relation according to the text mining scheme refers to a predetermined keyword similarity on the basis of a keyword which is used to extract the self-patent and the target patent, and also the similar technique relation according to the classification refers to a predetermined similar technique relation which the self-patent and the target patent make in the patent classification system.

The citation patent set generating unit 5121 of the present invention generates a citation patent set including preceding patents which the patent Pi cites according to each type of citation of the Pi, with respect to the patent Pi belonging to the self-patent set, and the citation patent set becomes an example of the target patent set or a subset of the target patent set. When the citation patent set is generated, the patent Pi belonging to the self-patent set may be included in the citation patent set. In this case, it is determined according to a target patent set generating policy, whether the patent Pi is made to be included in the citation patent set. On the other hand, the user may exclude patents with predetermined properties such as a patent of a certain applicant (for example, a company A or an applicant who has a specific relation to the company A if the user belongs to a company A) and the like when the target patent set generating unit 5120 generates the target patent set. Of course, the exclusion of the patent of the certain applicant may be accomplished through a users' post-processing (deletion, addition, and the like of the target patent) for the generated target patent set.

Here, the citation patent set TS may include patents TSi with different weights. The citation patents constituting the citation patent set have 1) a citation weight based on a citation type, 2) a citation weight based on duplication, 3) a citation weight based on a depth in a case of an indirection citation, 4) a weight in inverse proportional to the number of citations, and 5) a citation obsolescence weight. In a case of an application of the citation weight based on the citation type, the largest weight is applied to the direct citation. In a case of the latent citation, a different weight is applied according to each type of the latent citation. In a case of the indirect citation, a low weight is applied as the depth of the citation increases. In a case of the weight in inverse proportional to the number of citations, a relative weight of a certain reference becomes lower as the number of references of the self-patent set SSi increases. Recently, the misuse of the reference (adding data such as lots of patents or theses to the reference) increases. When the number of references is very large, there is a significant probability that references which cannot play a role of the reference may be included. The weight in inverse proportion may be “constant/(number of references—predetermined integer)”. The formula is applied in a case where the number of references is in excess of the predetermined integer. When the interval between filing dates of the SSi and TSi becomes longer, there is a significant possibility that the relation in content of the SSi and TSi decreases. Accordingly, the citation obsolescence weight may be added to the TSi in consideration of an obsolescence function which is in inverse proportional to the interval between the filing dates of the TSi and SSi. The citation obsolescence weight can be calculated by “constant/f(lapse date between the filing dates of the SSi and the TSi)”.

On the other hand, the number n of SSi which are different from one another can cite the TSi. In this case, a weight according to a duplicate citation of TSi becomes n. Further, in a position of the SSi, an identical weight cannot be added to a parent patent which is directly cited by the SSi and has a citation depth of 1 and a grandparent patent which is cited by the parent patent and has a citation depth of n (n>1). Here, the weight of the TSi according to the citation depth is regulated by adding a reduction factor for reducing the weight by exponential series, geometric progression, or arithmetic progression as the citation depth n increases. On the other hand, in a case of a recently cited TSi, a weight may be further added to the TSi. In a case where an owner is a patent troll, a multi-dispute owner, or a competitor of other users, a weight may be further added to the TSi according to the property of the owner. In a case where the patent TSi which pertains to a standard patent pool or in which a dispute occurs has a predetermined property, the weight may be further added to the patent TSi. The setting of the weight to the TS is performed by a weight regulating unit 5143 in the system.

The weight based on the SSi will be described. The user can add a user setting SSi weight which is a subjective weight of the user to each SSi patent. The TSi which generates a citation patent set or a similar patent group are based on the SSi. The weight which is added to the SSi may also be added to the TSi. That is, a greater weight is added to the TSi which is a patent group cited by a certain SSi having a very great weight rather than the TSj which is a patent group cited by a SSi having a very small weight. Accordingly, it is further preferable to add the user setting SSi weight information which is a weight based on the SSi, to the TSj constituting the TS.

The representative example of the TS is a similar patent group which is generated by the text mining scheme with respect to the SSi. It will be described. Firstly, at least one keyword candidate is extracted with respect to all patents. Then, a core keyword is extracted and stored from the keyword candidate. In turn, at least one patent, which has a core keyword very similar to the core keyword group corresponding to a certain patent I, is extracted from the patents so as to generate a similar patent group. The keyword candidate includes a pair of keywords (a pair of co-occurrence), and a patent classification code and can be processed like as a keyword. The generation of the similar patent group is performed by the similar patent group generating unit 5122 of the present invention. The similar patent group generating unit 5122 extracts a preceding application patent group similar to the SSi by using the core keyword set extracted from the SSi. The SSi and the preceding patent group TS(SSi) are generated. The SSi and the TSi(SSi) have a similarity score. On the other hand, a TS(SSj) is generated with respect to another patent (SSj) constituting a self-patent set, and the TS constituting the TS may have the same number of similarities as the frequency (both the SSi and the SSj correspond to at least one j not I which have the identical TSi as the similar patent. In this case, the frequency of the TSi is more than 2).

Especially, in a case of the patent classification, plural patent classifications may be respectively used like the core keyword. On the other hand, a different weight may be added to each patent classification in a manner of further adding the weight to a main patent classification. On the other hand, in an n dot subclass, which has the largest depth, of the patent classifications, the depth in the patent classification system increases as n becomes larger. A greater weight may be added to the patent classification which has a large depth. In the patent classification of H04B 7/26, H04B 7/24 (1 dot subgroup), H04B 7/00 (main group), and the like, which correspond to a parent of H04B 7/26 (2 dot subgroup) can be treated like a core keyword because of a representing technique of a patent specification, although they are not described. Of course, a weight for H04B 7/26 is high and a weight for H04B 7/24 is low. A weight for H04B 7/00 (main group) may be set to be the lowest. In addition, when the similar patent group is generated by using the text mining scheme, reference information also may be treated like the core keyword, and may be used to generate the similar patent group. In this case, an identical or different weight may be added to the patent classification according to each citation type, each citation depth, and each citation relation patent.

A method of generating the similar patent group (or expendably related patent group) using a citing-cited relation will be described. When a specific patent P1 is provided and cites the number n of parent patents PP1, PP2, . . . , PPn, each PPi may cite a grandparent patent GPPj. This is identically continued as a citation depth increases. Likewise, when the number n of child patents CP1, CP2, . . . , CPn cites the patent Pi, a patent CPi also may be cited by a grandchild patent GCPj. This is identically continued as a citation depth increases.

An exemplary method of calculating the similarity of the patent PPi and a patent CPi which have a direct citing-cited relation with the patent Pi will be described. There is an increased possibility that patents having a citing-cited relation are similar in content. A key of generating the similar patent group is to determine which patent of the patents PPi is more similar to the patent Pi, that is, to determine the similarity of the patents constituting the similar patent group.

In the present invention, the similarity of a self-patent Si and a patent Tj having a citing-cited relation is expressed by a following function.

SimF(Si,Tj)=SimF

(citation type, citation depth, time interval, technical consistency, number of claims, number of references, nationality of applicant, etc.).

Types of the citation include a direct citation, an indirect citation, a latent citation, a chain citation, and a family citation. When other parameter values are identical, the direct citation and a first type of latent citation have the largest value of the SimF, the family citation and the first chain citation have the value of the SimF smaller than that of the direct citation and the first type of the citation, and the indirect citation, the second latent citation and the second chain citation have the smallest value of the SimF.

The SimF is in inverse proportion to the citation depth. The relative similarity decreases as the citation depth increases.

On the other hand, when the time interval between filing dates (earlier date is more accurate) of a patent Si and a patent Tj becomes longer, compared patents have an increased possibility that they are technically different. There increases a possibility that the patent has an increased technical similarity as the time interval becomes shorter. Technique is developed or changed with time. Similar techniques greatly tend to reflect requirements of an era or a market, and to appear and disappear at a similar time. Therefore, the SimF has a relation in inverse proportional to the time interval between the filing dates of the patent Si and the patent Tj.

The consistency of the technical field reflects 1) a consistency of a predetermined patent classification depth in a specific patent classification, and 2) a consistency of a keyword, and the SimF is in proportion to the consistency of the technical field. The patent classification includes at least one of the IPC, the USPC, the FT, the FI and the ECLA. It may be considered which one of the main patent classification and the sub patent classification the technical field is coincident with and which depth of the patent classification system the technical field is coincident. The number of the coincident patent classifications is important. On the other hand, the patent classification noted in a section of Field of Search can be used as an object of the patent classification consistency.

In addition, the number of claims of the patent Si may be an important parameter. A possibility that a specific patent Tj is similar to a patent Si having one claim is lower than a probability that the patent Tj is similar to a patent Si having one hundred claims. Many claims of the patent Si means that one patent includes many inventory elements. When a certain patent Tj is similar to one or more claims of the patent Si, it is preferable to treat the patent Tj as a similar patent. That is, a possibility that a patent having one claim is substantially similar to various patents which the patent cites is lower than a possibility that a patent having one hundred claims is substantially similar to patents which the patent cites. Accordingly, the SimF has a proportional relation to the number of claims of the patent Si.

On the other hand, if the patent Si has a large number of references (the number of parent patents, or the number of child patents), a possibility that each reference is similar to the patent Si in content is relatively lower. In a case where a writer or an examiner of a patent Si inputs patents relating to the patent Si as references, there is an increased possibility that they may be selected references if the number of references is small. On the other hand, there is an increased possibility that references are not selected well if the number of references is significantly large. Accordingly, the SimF has an inverse proportional relation to the number of references or the number of child patents.

There is a significant possibility that a technological gap within a nation is smaller than that between nations. Therefore, when some of references in the patent Si belong to an identical nation, a substantial similarity of the patents Sin and Tj increases more as the average of technological gap between nations becomes smaller.

Here, an example of the SimF(Si, Tj) is as follows.

SimF(Si,Tj)=c*/{sqrt(t)*d*d}

Wherein c is a sum of number of identical classifications between patents Si and Tj at a 1 dot main group level of the IPC+number of identical classifications at a class level of the USPC+1, t is a time interval between the patents Si and Tj ((riling date of patent Si−filing date of patent Tj+1|/365.2564), and d is a numerical value according to a citation type, i.e. a direct citation corresponds to a value of 1, an indirect citation corresponds to a value of two or more, a first type latent citation corresponds to a value of 1 to 1.5, a second type latent citation corresponds to a value of 1.5 to 2, a first type chain citation corresponds to a value of 1.3 to 1.7, a second chain citation corresponds to a value of 1.7 to 2.0, and a family citation corresponds to a value of 1.2 to 1.7.

If there are the values of the SimF between the plural patents Si and the plural patents Tj, a distribution of the SimF(Si, Tj) is calculated, and the SimF(Si, Tj) is made to correspond to a value between 0 and 1 in consideration of the distribution. An example of the correspondence is that the SimF(Si, Tj) is normalized, or that a distribution value in a certain section of the SimF(Si, Tj) is made to correspond to a distribution value in a certain section between 0 and 1 in a manner of one-to-one correspondence by a section unit.

A patent Tj is found in all registered patents Si, and the value of the SimF(Si, Tj) converted into a value of 0 to 1 with respect to the patent Tj can be stored in a data unit 1000 of the present invention. In a case where there is the value of the converted SimF(Si, Tj) for all patents, the converted SimF(Si, GPPj) or SimF(Si, GCPj) can be easily calculated with respect to the grandparent patent GPPj or the grandchild patent GCPj of the patent Si. If the GPPj is the parent patent of the parent patent PPj of the patent Si, the converted SimF(Si, GPPj)={converted SimF(Si, PPj)}*{converted SimF(PPj, GPPj)}. Likewise, if the GCPj is the child patent of the child patent CPj of the patent Si, the converted SimF(Si, GCPj)={converted SimF(Si, CPj)}*{converted SimF(PPj, GCPj)}.

The reason is because all the Si, PPj, GPPj, CPj and GCPj are elements of a registered patent set, and a similarity relation of the Si, PPj, GPPj, CPj, and GCPj always can be generated if there is the converted SimF(Si, Tj) for all registered patents Si.

A similar patent group of the Si can be generated by using only a forward citation patent group, only a backward citation patent group, or both the forward citation patent group and the backward citation patent group.

The similar patent group can be generated by using a clustering method and a search engine. The clustering is a method of generating the similar patent group based on a distance between core keywords, and as an example includes a K-means algorithm. On the other hand, the search engine includes a ranking algorithm therein. In a case where the number n of core keywords is input, patent documents which include the number n of core keywords are output from patent documents which are objects to be searched for. The predetermined number of patents which have at least a predetermined score can be classified into a similar patent group. At this time, it is obvious that a different weight is applied to each core keyword in each field of the patent specification (for example, the largest weight is applied to a core keyword in the title of the invention, a relatively large weight is added to a keyword in the claims, and the smallest weight is applied to a core keyword in the detailed description of the invention). In a case where the search engine obtains a weight for each keyword, the weight is applied to the number n of core keywords which are input and it is possible to query to the search engine. Especially, when a query is generated by using the number n of keywords having the weight and the generated query is input to correspond to a core keyword field (a field in which only the extracted core keywords are collected), the similar patent group may be rapidly generated.

The technologically similar patent group is generated with respect to the patent evaluation object patent Si in the patent evaluation, and may be used to compare relative patent evaluation model values between the patent Si and at least one patent Tj belonging to the similar patent group. The patent evaluation model value generating unit 7530 may generate a patent evaluation model value by applying a patent evaluation model to all the registered patents and may store the patent evaluation model value in a patent evaluation model value DB 7230. Since the patent Tj is one of all the registered patents, the patent evaluation model value may correspond to the patent Tj which belongs to the similar patent group.

On the other hand, a user of the patent evaluation system 7000 may generate an evaluation patent set which is an object to be evaluated. Since the evaluation patent set is generated by the user, it is referred to as a self-set (SS) and the patent which belongs to the self-set SS is expressed by SSi. The patent evaluation system 7000 may obtain the self-set SS from the user. The method of obtaining the self-set SS includes 1) a method of generating the self-set SS resulting from a search through an input of a search formula, 2) a method of generating the self-set SS from patent sets which the user inputs at the interior and manages in the patent information system 10000, 3) a method of generating the self-set SS from patent sets which the user uploads at the exterior to the patent information system, and 4) a method of generating the self-set SS by performing a set calculation for two or more patent sets which are generated by using at least one of methods 1) to 3). Selection of a patent to be evaluated from the obtained patent sets corresponds to the method 4). Since the method of generating the selected patent set removes patents not to be evaluated from the obtained patent set, the set calculation may be a differential set calculation. That the evaluation patent set generating unit 7110 generates the evaluation patent set in order to evaluate the patent is equal to or corresponds to that the self-patent set generating unit 5110 generates a self-patent set in order to predict dispute. The evaluation patent set generating unit 7110 performs an identical function to that of the self-patent set generating unit 5110 of the patent dispute prediction information generating system 5000.

The patent evaluation engine 7100 of the present invention includes a related patent set generating unit 7120, and the related patent set generating unit 7120 performs functions identical or corresponding to those of the target patent set generating unit 5120. Both units 7120 and 5120 perform a function of generating related patent sets with respect to a given patent set (an evaluated patent set or a self-patent set). The related patent set includes a similar patent group (the similar patent set generated by using a citing/cited relation, a keyword, and the like), and a similar technique patent group (the patent group including identical patents of which the patent classification is a specific patent classification).

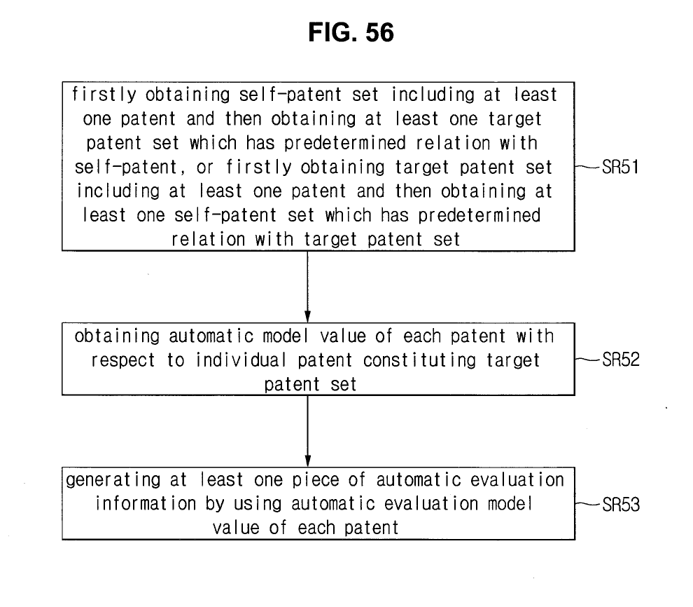

As shown in FIG. 56, the patent evaluation engine 7100 firstly obtains a self-patent set including at least one patent, and secondly obtains at least one target patent set including at least one patent relating to the self-patent. Otherwise, the patent evaluation engine 5100 firstly obtains a target patent set including at least one patent, and secondly obtains at least one self-patent set relating to the target set, in step SR51. Continuously, the patent evaluation engine 7100 obtains a patent evaluation model value of each patent constituting the target patent set in step SR52, and generates at least one piece of patent evaluation information by using the patent evaluation model value of each patent in step SR53.

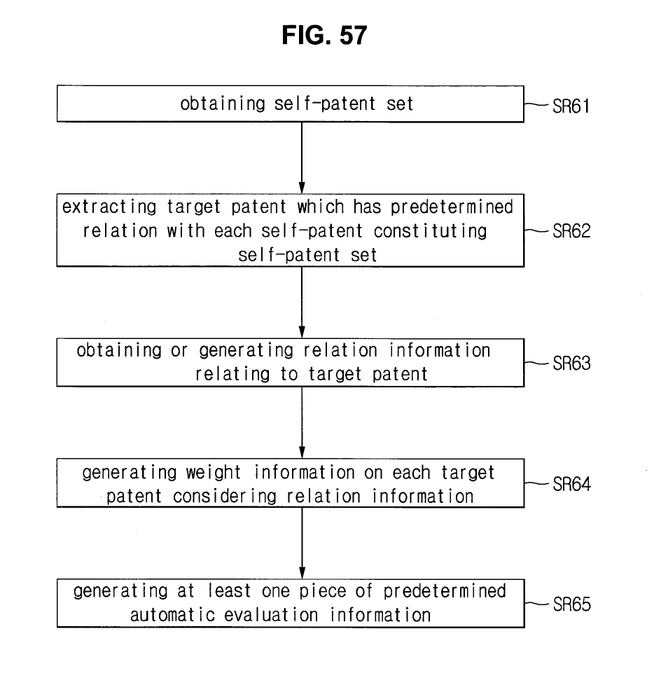

A method of generating patent evaluation information by using weight information on each target patent in consideration of the predetermined relation information in the patent evaluation engine 7100 will be described with reference to FIG. 57. The patent evaluation engine 7100 obtains a self-patent set in step SR61, and extracts a target patent having a predetermined relation with each patent constituting the self-patent set so as to generate the target patent set in step SR62. Continuously, the patent evaluation engine 7100 obtains or generates the relation information on the target patent in SR63, generates weight information on each target patent in step SR64, and generates at least one piece of patent evaluation information by using the weight information on the target patent in step SR65.

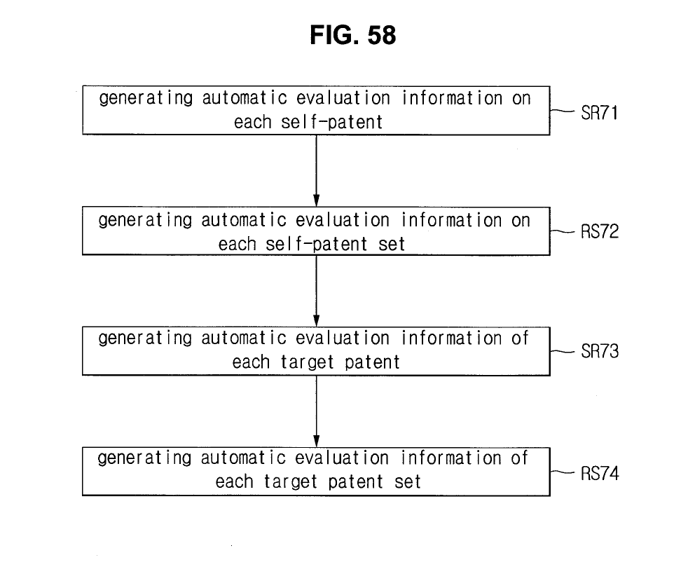

FIG. 58 is a flowchart illustrating an exemplary process of generating patent evaluation information in the patent evaluation information generating unit 7140 of the present invention. The patent evaluation information generating unit 7140 firstly may generate patent evaluation information on each self-patent (a evaluated object patent which is input by a user, or an evaluation patent) in step SR71. That is, the patent evaluation information generating unit 7140 generates the target patent information on one patent SSi, and then generates patent evaluation information on each TSi which constitutes TS, or each TS, as patent evaluation information on SSi. On the other hand, the patent evaluation information generating unit 7140 may generate the patent evaluation information on each self-patent set which is constituted of at least one self-patent in step SR72. On the other hand, the patent evaluation information generating unit 7140 may generate the predetermined patent evaluation information on each target patent constituting the TS, with respect to both each SSi and SS. Further, the patent evaluation information generating unit 7140 may generate the predetermined patent evaluation information on each target set which is constituted, with respect to either each SSi or SS in step SR74.

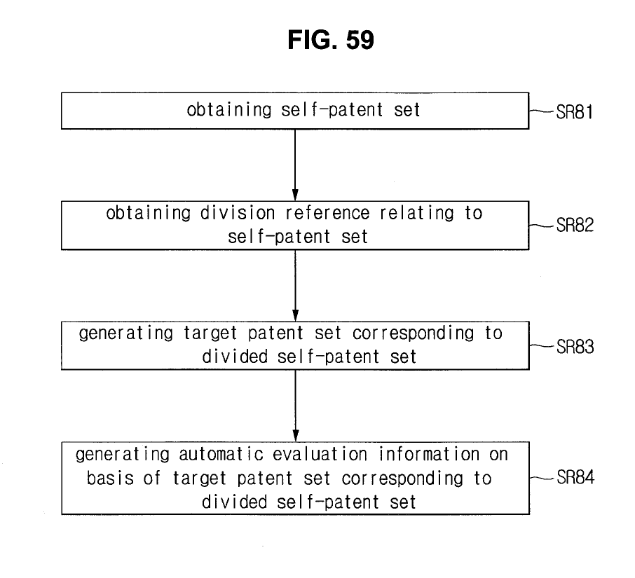

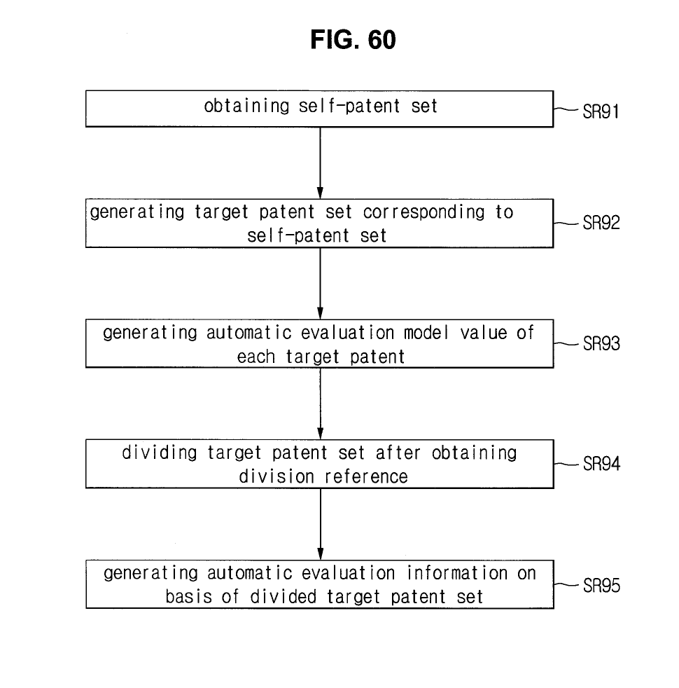

A method of generating patent evaluation information, to which a set division concept is applied, will be described with reference to FIGS. 59 and 60. FIG. 59 shows a flowchart illustrating an exemplary process of dividing the self-patent set through the patent set dividing unit 7310 of the present invention, and generating patent evaluation information on the divided self-patent set. The patent evaluation engine 7100 obtains the self-patent set in step SR81, obtains a division reference for the self-patent set through the patent set dividing unit 7310 in step SR82, generates a target patent set corresponding to the divided self-patent set in step SR83, and generates the patent evaluation information on the basis of the target patent set corresponding to the divided self-patent set in step SR84.

FIG. 60 shows a flowchart illustrating an exemplary process of dividing a target patent set through the patent set dividing unit 7310 of the present invention, and generating patent evaluation information on the divided target patent set. The patent evaluation engine 7100 obtains a self-patent set in step SR91, generates a target patent set corresponding to the self-patent set, and generates a patent evaluation model value of each target patent in step SR93. In turn, the patent evaluation engine 7100 obtains a division reference through the patent set dividing unit 7310 and divides the target patent set in step SR94, and generates patent evaluation information on the basis of the divided target patent set in step SR95. Hereinafter, it will be described in detail.

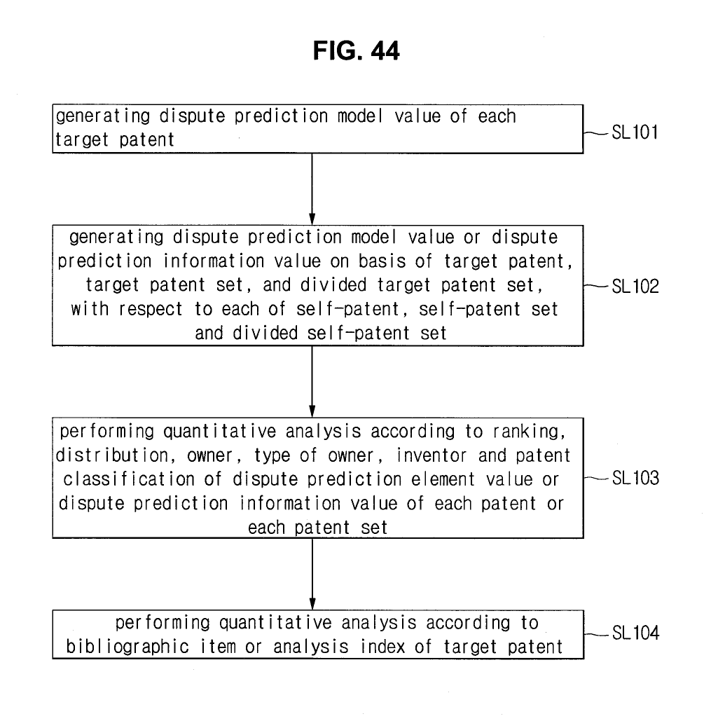

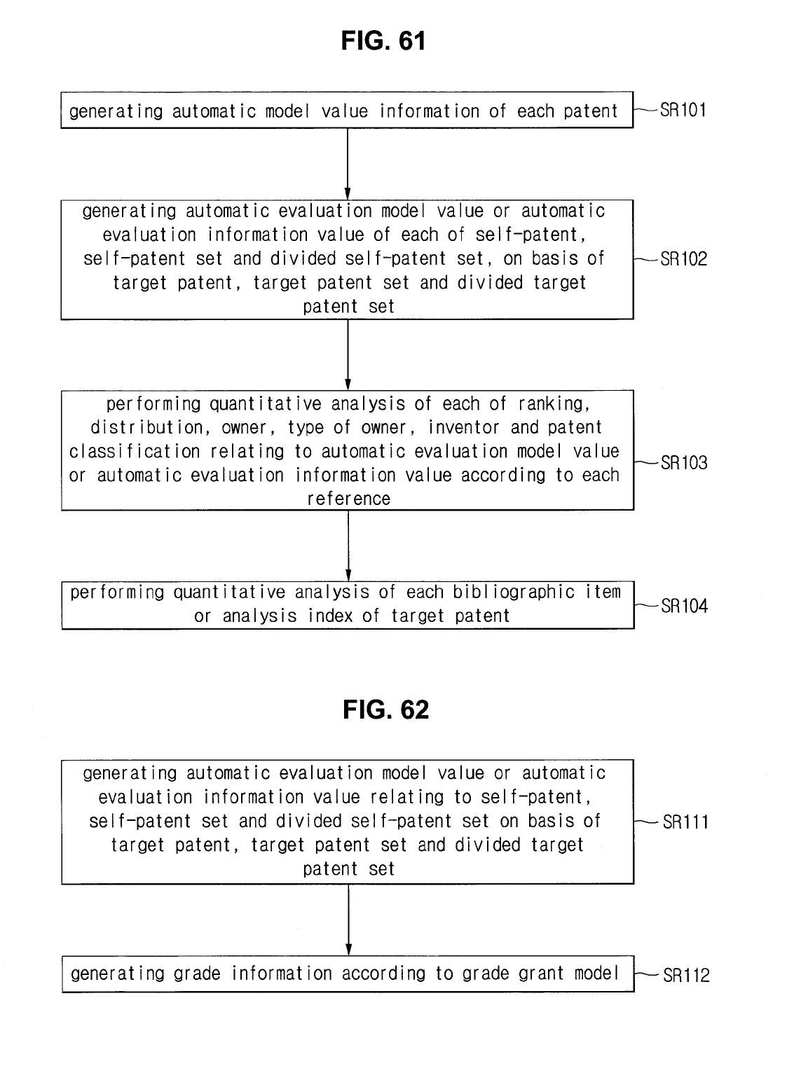

As shown in FIG. 61, the patent evaluation information analysis engine 7300 of the present invention analyzes the patent evaluation information. In FIG. 44, an exemplary method of processing information in the patent evaluation information analysis engine 7300 of the present invention is shown. The patent evaluation information analysis engine 7300 generates patent evaluation model value information on each target patent in step SR101, and generates a patent evaluation model value or a patent evaluation information value on the basis of a target patent, a target patent set, and a divided target patent set with respect to each of a self-patent, a self-patent set, and a divided self-patent set in step SR102. Next, the patent evaluation information analysis engine 7300 performs a quantitative analysis of a ranking of a patent evaluation model value or a patent evaluation information value according to each reference, each owner, each type of owner, each inventor, and each patent in step SR103, performs a quantitative analysis of bibliography of a target patent or each analysis index in step SR104, and generates a result of the quantitative analysis performance.

Referring to FIG. 62, a method of generating predetermined grade information in the patent evaluation engine 7100 based on the patent evaluation information value will be described. The patent evaluation engine 7100 generates a patent evaluation model value or a patent evaluation information value on the basis of the target patent, the target patent set, the divided target patent set with respect to each of the self-patent, the self-patent set, and the divided self-patent set in step SR111, and generates grade information according to a grade grant model in step SR112. When a patent evaluation information value or a patent evaluation function value of each f(TS) or f(TSui) is generated with respect to at least one patent evaluation information generating function f, the patent evaluation grade may be determined according to the predetermined grade grant model. The grade grant model grants a grade to each patent evaluation function value section, defines a grade section based on the distribution in consideration of a distribution of the patent evaluation function value, and grants a predicted grade to the defined grade section. It is obvious to a person skilled in the art that there are plural models for dividing a score value into the number n of grades.

Continuously, a method of generating a core keyword will be described. The keyword is generated by processing the text included in the patent specification. The generation of the keyword is performed by a core keyword generating unit 2100 of the data processing unit 2000 of the present invention. The core keyword generating unit 2100 extracts the keyword from phrases or sentences corresponding to each field constituting the patent specification. A pair of co-occurrence is extracted through a combination of terms which are adjacent to one another at a near distance (a distance satisfying a space reference between terms in a paragraph). The field corresponds to at least one of the title of the invention, claims, summary, the description of the invention, industrial applicability, effect, and background art which constitute the patent specification. The core keyword generating unit 2100 generates a core keyword set for the number n of keywords extracted from the fields. In the generation of the core keyword, the core keyword generating unit 2100 preferably performs a synonym process, a thesaurus process, and the like, and collects the terms which substantially have an identical meaning or a similar meaning as a representative term, so as to select the core keyword. On the other hand, when a term is processed as the representative term, it is preferable to perform the synonym and thesaurus process for two or more words which are present in one patent document, by using dictionaries or a machine translator. Further, it is preferable to translate the representative term and the extracted core keyword to at least one language by using the dictionaries or the machine translator. It pertains to a well-known technique in a natural language processing field to extract a keyword (in the technical field, a keyword is typically called a term) or a pair of co-occurrence. By applying a predetermined core keyword selection algorithm to the extracted n keywords (including a pair of co-occurrence), a core keyword set (selectively including a core co-occurrence pair set) which is representative of the patent specification is selected. The algorithm to be frequently used includes a Term Frequency and an Inverse Document Frequency.

In the natural language processing field, various function formulas having the TF and IDF as parameters is well known. It is obvious to apply a complex calculation formula such as a weight for each field to the natural language processing. At this time, a core keyword set including only a keyword in the narrow of sense, and a core keyword set including only a pair of co-occurrence the algorithm are separately generated, or the keyword in the narrow sense and the pair of co-occurrence are evenly processed by the algorithm. When the core keyword selection algorithm processes the pair of co-occurrence and the core keyword in the narrow sense together, a core keyword pair set may be generated with respect to n pairs of keywords.

Following Equation 3 is used in the algorithm of extracting the core keyword with respect to the extracted keyword.

$${Weight}_{term} = \frac{( 1 + log ( 1 + log ( tf ) ) ) \times ( 1 + log ( \frac{N}{df} ) \times ( {Σ}_{i = 1}^{4} {fw}_{i} )}{( ( 1 - slope ) \times pivot + ( slope \times uf ) )} \qquad Equation 3$$

wherein tf: a term frequency of which a keyword (index) appears in the present document,

N: the number of total documents,

Df: a document frequency of which the keyword appears,

Slope: inclination (optional constant value, adjustable),

ut: unique terms in total document set,

pivot: an average length of document,

uf: ut of corresponding document, and

Fwi: weight of each field.

On the other hand, when the core keyword generating unit 2100 extracts a new term including two or more words/vocabularies/phrases, there are cases where it is determined whether the new term technically has a meaning. At this time, there may be a method of determining whether the new term has a technical meaning, by using an external search engine such as google.com. The core keyword generating unit 2100 performs at least one predetermined process, such as quotation mark processing (a keyword processing scheme of google.com of processing an exact match), of the extracted new term, and then transmits the new term to an exterior searching service system such as google.com. Then, the core keyword generating unit 2100 receives a search result from the exterior searching service system. If the search result satisfies a predetermined reference, the extracted new term is processed as a normal term. The analysis of the searching result is achieved by measuring the number of search results (the number of hits, displaying the number of search results which are matched to the query). For example, as an example of a predetermined reference, in a case of English query, more than one thousand results may be displayed, and in a case of other languages, more than one hundred results may be displayed. For example, in March, 2010, when “patent informatics” and “patent informatics services” are queried to google.com, of 67,300 and 279 results are mentioned respectively. In this case, “patent informatics” may be regarded as a new term, while “patent informatics services” may not be recognized as a new term. On the other hand, when a keyword is queried to a system which provides a description of a term, such as Wikipedia.org, instead of a search engine such as google.com, and the like, the term may be regarded as a new term if the description of the term is present.

Through the core keyword selection algorithm as described above, one or more core keyword sets (including a core keyword combination set maintaining one or more core frequencies) corresponding to one patent document, i.e. a core keyword set KS(Pi)={K1(Pi), K2(Pi), . . . , Ki(Pi), Kj(Pi), . . . , Kn(Pi)} corresponding to i^{th} patent document Pi are obtained. In the core keyword set, i,j, and n are positive numbers, and Kn(Pi) refers to an n^{th} core keyword selected from i^{th} patent document Pi. A plurality of core keyword sets correspond to one patent document. The reason is because the keyword can be obtained 1) in a specific field (claims or abstract), 2) by applying a different weight to each field, 3) by using two or more core keyword selection algorithms, 4) on the basis of a reference range of IDF calculation, and 5) by a term extraction scheme. The core keyword set KS(Pi)={K1(Pi), K2(Pi), . . . , Ki(Pi), Kj(Pi), . . . , Kn(Pi)} corresponding to i^{th} patent document Pi may be stored in a core keyword DB 1300 on the basis of the Pi or a key value corresponding to Pi.

On the other hand, a core keyword metadata information generating unit 2140 of the present invention generates at least one metadata which is predetermined on each core keyword, and the generated core keyword metadata information is stored in a core keyword metadata information DB. Metadata which the core keyword metadata information generating unit 2140 generates for each core keyword generally is classified into two types.

Firstly, the metadata includes relation information between the core keywords. All core keywords correspond to the document Pi from which the core keyword is extracted. Accordingly, if there is a patent group including at least two patents (including all patent, all patents within a certain period, patents belonging to each patent classification, patents belonging to each patent owner, patents belonging to each patent inventor, and the like), the core keyword set KS(Pi) corresponding to the patent document Pi is processed by patent group unit through an association analysis (so called market basket analysis) so that the relation information between the core keywords is generated. The relation information between the core keywords may be visualized as a core keyword network. A network analyzing unit 4700 of the present invention is capable of analyzing the core keyword network, and a data visualizing unit 4700 of the present invention performs the visualization of the core keyword network.

Secondly, the metadata includes bibliographical information according to each keyword. The core keyword set KS(Pi) corresponding to the patent document Pi corresponds to all bibliographic elements (filing date, applicant, inventor, patent classification, reference, and the like), or a dispute prediction element value of each dispute prediction element, indicated in Tables 1 to 4, of the Pi. Accordingly, if there is a patent group including at least two patents (for example, all patents, all patents in a certain period, patent in each patent classification, patents of each owner, patents of each inventor, and the like), at least one patent document may correspond to each core keyword on the basis of the patent group. Accordingly, information (number of applications, number of registered patents, amount of increased applications, amount of increased registrations, and information on optional quantitative analysis for patent sets) on a quantitative analysis which is performed for the patent document of the patent group in which the core keyword is regarded as its core keyword may become metadata of each core keyword. A remarkable core keyword can be found by using the metadata of each core keyword as described above, and a core keyword network around the remarkable keyword can be found when the core keyword network is coordinated and used. On the other hand, two core keywords correspond to an edge between the core keywords constituting the core keyword network. Therefore, a patent document simultaneously including the two core keywords may be searched for (the search engine makes the core keyword to be included in a search index in order to separately search for only the core keyword which is extracted from each patent Pi).

If individual keyword which constitutes the core keyword set KS(Pi) corresponding to the patent Pi is processed by unit of a patent group through the association analysis, association information between the core keywords is generated and may be visualized as a core keyword network.

On the other hand, a method of generating a similar patent group in a similar technique patent group generating unit 5123 of the target patent set generating unit 5120 by using the patent classification will be described. In a case where the self-patent SSi has n IPCs and m local patent classifications (i.e. USPC), a similar patent group is generated by using the n IPCs and m local patent classifications. The similar technique patent group generating unit 5123 extracts patents TS(IPC1), . . . , TS(IPCn) which have the IPC including the main patent classification and sub-patent classification of each of IPC1 to IPCn. When a size of the extracted TS(IPCi) (the size is the number of patents belonging to the TS(IPC1) is defined as s(TS(IPC1)), a weight of 1/s(TS(IPCi)) is applied to the TSi(IPCi) which belongs to TS(IPCi). On the other hand, in a case where identical patents are duplicated in the TS(IPC1), . . . , TS(IPCn), i.e a case where two or more IPCs are present in the SSi, and patents having two or more identical IPCs are present in the TSi belonging to the TS, 1/s(TS(IPC1 and IPCj)) may be allocated to the identical IPCi and at least one IPCj. A TS(IPCi and IPCj) refers to a TS including a TSi having both the IPCi and IPCj. On the other hand, although patents have no identical IPC, the patents may have the similarity higher than a predetermined level when they have an adjacent IPC in the technical classification system. The similar technology patent group generating unit 5123 extracts at least one super ordinate patent classification such as a super ordinate patent classification of the IPCi of the SSi, and applies a weight which is in inverse proportion to the size of the TS including the super ordinate patent classification, to a patent document including the super ordinate patent classification. On the other hand, the similar technology patent group generating unit 5123 extracts at least one sub ordinate patent classification of the IPCi of the SSi with reference to the patent classification system, and applies a weight which is in inverse proportion to the size of the TS including the sub ordinate patent classification, to a patent document including the sub ordinate patent classification.

On the other hand, as a differential between the filing dates of the SSi and the TSi becomes greater, there is an increased possibility that the patents SSi and the TSi have no similarity even though they have the identical patent classification. Accordingly, the weight may be multiplied by an obsolescence weight in consideration of an obsolescence function which has an inverse proportion to a differential value of the filing dates. The obsolescence weight is defined by constant/f(lapse days between the filing dates of the SSi and TSi+1).

In a case where a plurality of patent classifications is included in the SSi or TSi when the similar patent group is generated by using the sub patent classification as well as the main patent classification, although the patent classifications of the SSi and the TSi are identical as the SSi and the TSi have the large number of patent classifications, there is a decreased possibility that the SSi and the TSi are identical in a technical content. Accordingly, it is necessary to introduce a dilution rate according to the number of the patents. Each weight is multiplied by the dilution rate. The dilution rate is in inverse proportional to the number of patent classifications of the SSi and TSi. On the other hand, in a case where the patent classification is identical to a main patent classification when the dilution rate is applied, a main patent classification coincidence weight may be further allocated. That is, when the main patent classification of the SSi is identical to the patent classification of the TSi, or the patent classification of the SSi is identical to the main patent classification of the TSi, a classification coincidence weight may be additionally allocated. A predetermined weight may be applied to each TSi which is generated by using the patent classification in the above-mentioned manner. The local patent classifications such as USPC, FT, FI and ECLA are processed in such a manner as the IPC is processed. When the TSi corresponding to the SSi relates to two or more types of the patent classifications, the weight of the TSi may be summed according to each type of the patent classification.

The similar patent group may be generated with respect to each patent belonging to the SS by the above-mentioned method. Each patent of the generated similar patent may have a similarity score. Accordingly, in view of all patents of SSi, the similar patent group set is generated 1) by using patents, which have a score higher than a predetermined similarity score, of similar patent groups which are generated with relation to each patent belonging to the SS, 2) in such a manner that similar patent groups having a similarity score are generated with respect to each patent belonging to the SS, the generated similar patent groups are summed, and the predetermined number or ratio (3 to 5 times of the number of patents of the SS) of the similar patent group set is generated on the basis of the total similarity scores (a similar patent appearing more than 2 times has two or more similarity scores) with respect to each patent of the summed whole similar patent group. A total similarity score corresponds to each patent included in the similar patent group set, through the above-mentioned process. Since the generation of the similarity score is a kind of weight for the TSi, the setting of the similarity score is performed by a weight adjusting unit 5143 of the present invention.

A preceding application similar patent group set is extracted from the similar patent group set. If there is a plurality of patents SSi, filing dates of the patents SSi have a range. Accordingly, it is difficult to specify the filing date of the patents SS. As a result, there is a problem in that it is difficult to specify a preceding application similar patent group and a succeeding application similar patent group. The preceding application similar patent group set is generated as follows. 1) When a similar patent group is generated by using individual patents of SS, the similar patent group is generated by using the preceding similar patents which have the filing dates prior to that of the individual patents. 2) If patent groups have a prior filing date to an intermediate filing date of all similar patent groups on the basis of the intermediate filing date of the patents belonging to the SS, the patent groups having the property are defined as a preceding similar patent group while other patent groups having no property are defined as succeeding similar patent groups.

It is obvious that the succeeding similar patent group set is generated in an identical manner to a method of generating the preceding similar patent group set.

A representative example of the TS is a patent set which is constituted by a user. The preceding/succeeding similar patent group set or the preceding/succeeding citation patent set may be defined by a period, a property (owners' property, a property of patents, a property of technical field), a keyword, or a search formula, but it is a general patent set. Accordingly, the user may generate a self-patent set by adding optional patent set defining means such as a patent set which the user manages, patents of a competing company, and patents of a related company to the general patent set. For example, when a patentee A attacks a user, a preceding application citing patent set of a specific patent set such as patents which belong to a patent portfolio of the patentee A, patents which attack the user, patents which belong to a similar patent group of the patent which attack the user, and the like, may be an example of the user constituted patent set. Alternatively, the user constituted patent set is generated in such a manner that the patent set is selectively extracted from the patents which belong to the citation patent set, the similar patent group set, and/or the patent set which the user inputs or generates.

On the other hand, when constituting the user constituted patent set, the user may apply a subjective weight to the TSi. The weight is called a user set TSi weight. The setting of the weight is performed through the UI provided by the weight adjusting unit 5143 of the present invention. The UI provides a patent list belonging to TS, and allows the user to input a weight, an importance, or an important grade.

The representative example of the TS is a system constituted patent set which is provided by the system. The system constituted patent set is a preceding citation patent set which includes a preceding application patents cited by the SSi according to the property, such as the smallest frequency patent classification to which the SSi belongs, which represents the SS or SSI. On the other hand, the system presents various patent sets such as a patent set including increased patent applications and registration, patents of a university or institution, a certain owners' patent set (a patent set of a company to be sold), which the administrator of the system sets, to the user, and receives a users' selection or makes a default so as to generate the system constitution patent set.

Then, a method of processing information in the system when the SS and TS are specified will be described. Firstly, a dispute prediction method will be described.

When the target patent set generating unit 5120 determines the TS, the dispute prediction model value obtaining unit 5130 obtains and stores a dispute prediction model value Sg(TSi) for a dispute prediction model Sg with respect to the TSi pertaining to the TS. The dispute prediction information generating unit 5140 may use the Sg(TSi) with respect to the TSi belonging to the TS. However, it is possible to limit only the Sg(TSi) which belongs to a predetermined quantile of n-quantiles such as quartiles, to be processed, or only the Sg(TSi) which has a value larger than the predetermined reference, to be processed. The limitation of the object to be processed is performed by the system or the user.

The dispute prediction information generating unit 5140 applies a predetermined weight to the Sg(TSi) which the dispute prediction model value obtaining unit 5130 obtains, through a multi-relation processing module 5141. The weight applied to the Sg(TSi) has an identical origin to the weight applied to the TSi. The weight applied to the TSi is determined by using at least one of 1) a weight relating to the SSi, 2) a duplication weight, 3) a subjective weight which a user applies to the SSi, and 4) a subjective weight which a user applies to the TSi. The weight applied to the TSi is referred to as W(TSi). The weight applied to the TSi is affected by the relation of the TSi and SSi. Accordingly, the W(TSi) may be W(TSi, SSi). The W(TSi, SSi) is a weight relation formula concerning the subjective weight which the user applies to the SSi, a relation of each TSi relating to the SSi (including a relation when at least one SSi relates to one TSi), and a subjective weight which a user applies to the TSi.

The processing of information relating to the weight is performed through the UI provided by the weight adjusting unit 5143 of the present invention. The user applies the subjective weight to an individual patent SSi or TSi through the weight adjusting unit 5143, and may apply a weight which the user sets according to a type of the relation or each detailed relation, or adjust a weight which the system applies to the SSi or TSi. Also, the user may determine which type of weight of the weights 1) to 4) is applied, may set a relative weight for each type of the weight (i.e. 1) weight of 50%, 2) weight of 30%, 3) weight of 10%, and 4) weight of 10%), and may adjust the weight of 1) to 4) which the system applies.

The dispute prediction information value generating module 5142 processes the Sg(TSi) and the W(TSi) so as to generate dispute prediction information wf(Sg(STi), W(TSi). Here, wf is a formula. An example of wf includes Sg(TSi)*W(TSi), and another example of the wf includes Sg(TSi) to which no weight is applied. The dispute prediction information generating unit 5140 generates the wf(Sg(TSi), W(TSi)) with respect to the TSi of the target patent set. The dispute prediction information value providing unit 5150 provides the wf(Sg(TSi), W(TSi)) to a user requiring the wf(Sg(Tsi), W(TSi)). The wf(Sg(TSi), W(TSi)) which is generated for each TSi is an example of dispute prediction information of SS on the basis of the TS. Continuously, the dispute prediction information generating unit 5140 may generate at least one piece of collective dispute prediction information on all target patent sets. The collective dispute prediction information generating function is referred to as f(TS). An example of f(TS) includes a total sum of wf(Sg(TS1), W(TSi) of each TSi, an average of wf(Sg(TS1), W(TSi) of each TSi, a sum or an average of wf(Sg(TS1), W(TSi) of each TSi, a predetermined statistical processing value for the distribution of wf(Sg(TS1), W(TSi) of each TSi, and a grade value which is obtained by applying the statistical processing value to the predetermined grade grant model.

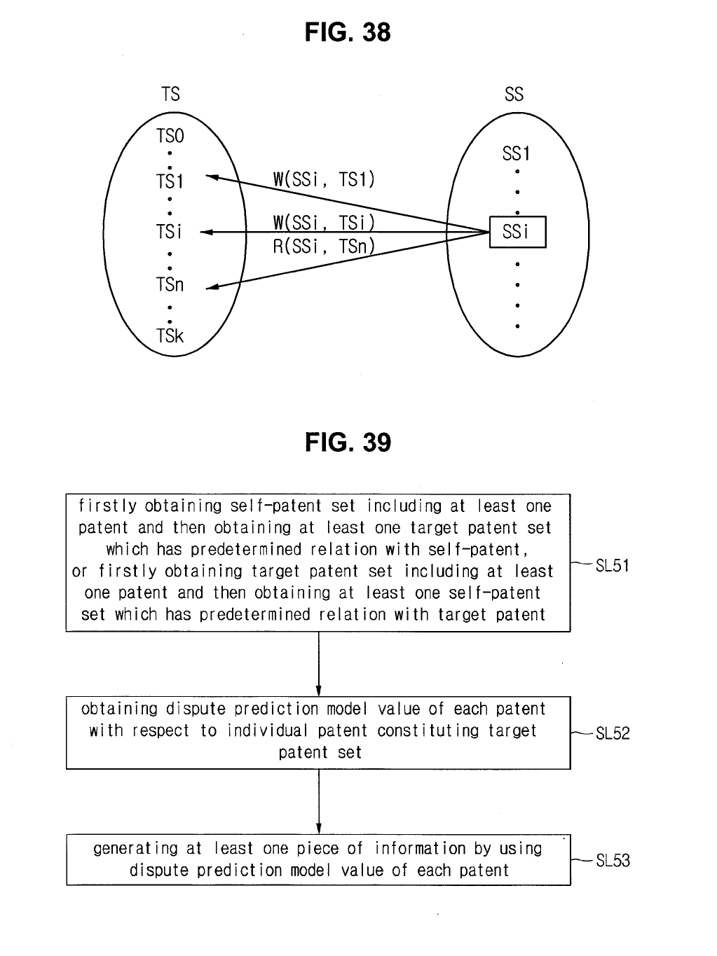

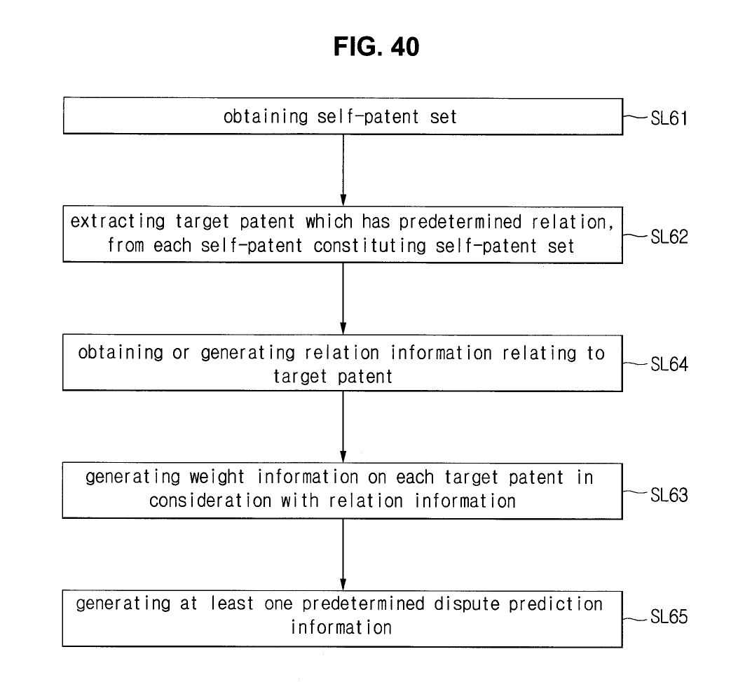

FIG. 38 is a mimetic diagram illustrating a process of generating a dispute prediction information value with respect to one patent in the dispute prediction information value generating module 5142. In FIG. 38, the SSi which has the number n of TSi and a weight of the W(SSi, TSi) is shown. In this case, the dispute prediction information value generating module 5142 may generate the dispute prediction information with respect to the individual patent SSi by using the following formula.

wf(Sg(TSi),W(TSi))(SSi)={Sg(TS1)*W(SSi,TS1)++Sg(TSi)*W(SSi,TSi)++Sg(TSn)*W(SSi,TSn)}/{W(SSi,TS1)++W(SSi,TSi)++W(SSi,TSn)}

On the other hand, the dispute prediction information generating unit 5142 may generate the dispute prediction information with respect to the whole SS including the number n of individual patents SSi by using the following formula.

wf(Sg(TSi),W(TSi))(SS)=1−{1−wf(Sg(TSi),W(TSW(SS1)}{1−wf(Sg(TSi),W(TSi))(SSi)}{1−wf(Sg(TSi),W(TSi))(SSn)}

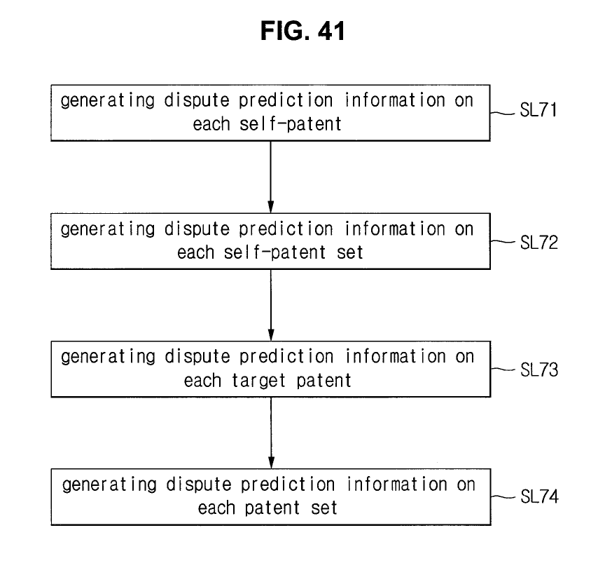

FIG. 41 is a flowchart illustrating an exemplary process of generating dispute prediction information according to types of the patents in the dispute prediction information generating unit 5140 of the present invention. Firstly, the dispute prediction information generating unit 5140 individually generates dispute prediction information of each self-patent in step SL71. That is, after a target patent set is generated with respect to one SSi, dispute prediction information on each TSi constituting the TS, or each TS is generated as the dispute prediction information on the SSi. On the other hand, the dispute prediction information generating unit 5140 generates predetermined dispute prediction information on each self-patent set including at least one self-patent in step SL72. On the other hand, the dispute prediction information generating unit 5140 generates predetermined dispute prediction information on each target patent constituting the TS with respect to either each SSi or each SS in step SL73. The dispute prediction information generating unit 5140 generates predetermined dispute prediction information on each target patent set constituting the TS with respect to either each SSi or each SS in step SL74.

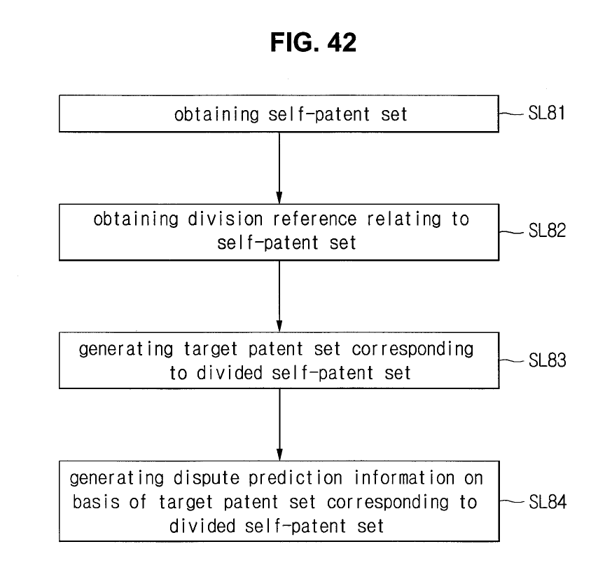

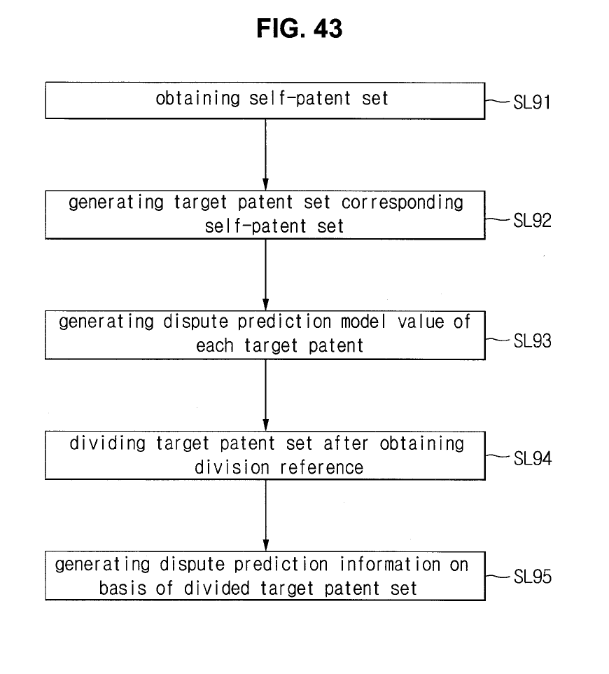

Continuously, a method of generating dispute prediction information, to which a set division concept is applied, will be described with reference to FIGS. 42 and 43. FIG. 42 shows a flowchart illustrating an exemplary method of generating dispute prediction information on a divided self-patent set which is obtained by dividing the self-patent set in the patent set dividing unit 5310 of the present invention. The dispute prediction engine 5100 obtains the self-patent set in step SL81, obtains a division reference for the self-patent set in step SL82, generates a target patent set corresponding to the divided self-patent set in step SL83, and generates dispute prediction information with respect to the target patent set corresponding to the divided self-patent set in step SL84.

FIG. 43 shows a flowchart illustrating an exemplary process of generating dispute prediction information on a divided target patent set after a target patent set is divided by the patent set dividing unit 5310 of the present invention. The dispute prediction engine 5100 obtains a self-patent set in step SL91, generates a target patent set corresponding to the self-patent set in step SL92, and generates a dispute prediction model value of each target patent in step SL93. Continuously, the dispute prediction engine 5100 obtains a dividing reference through the patent set dividing unit 5310 to divide the target patent set in step SL94, and generates dispute prediction information on the basis of the divided target patent set in step SL95. Hereinafter, the method of generating dispute prediction information will be described in detail.

The TS is a target patent set, and the target patent set is divided into at least one unit by applying at least one dividing reference. The division is performed by the patent set dividing unit 5310 of the dispute prediction information analysis engine 5300 of the present invention. An i^{th} TS divided into a unit is referred to as a TSui. In this case, the dispute prediction information generating unit 5140 may generate a value of wf(Sg(TSui)), W(TSui), or f(TSui) of each TSui. TS may be divided according to 1) owner, 2) technical field (using IPC or USPC), 3) period, 4) inventor, 5) nation, 6) owners' property, 7) the presence or absence of at least one certain keyword, 8) a condition under which a patent set is divided or defined, 9) a patent group having a specific property, and/or 10) a combination of 1) to 9). An example of 6) includes (1) a property of a patent troll and (2) a multi-dispute causing owner. An example of the specific property of 9) includes (1) a patent group of TS having a large similarity to the SS and (2) a patent group which includes TSi corresponding to the user setting SSi having a value higher than a predetermined value in ranking, level and range.

On the other hand, the SS is a self-patent set which may be divided into at least one unit through the target patent set. The divided i^{th} SS is called SSui. A target patent set TS(SSui) is generated with respect to each SSui, and wf(Sg(TS(SSui)), W(TS(SSui)), or f(TS(SSui)) may be generated with respect to each TS(SSui). Further, since the TS(SSui) is a sort of a target patent set, it may be divided by the dividing method. The wf(Sg(TS(SSui)), W(TS(SSui)), or f(TS(SSui)) may be generated with respect to the divide TS(SSui).

The dispute prediction information analysis engine 5300 of the present invention analyzes the dispute prediction information. FIG. 44 shows a flowchart illustrating an exemplary method of processing information in the dispute prediction analysis engine 5300 of the present invention. The dispute prediction information analysis engine 5300 generates information one a dispute prediction model value of each target patent in step SL101, and then generates a dispute prediction model value or a dispute prediction information value with respect to each of a self-patent, a self-patent set, and a divided self-patent set in step SL102. In turn, the dispute prediction information analysis engine 5300 generates information on the dispute prediction model value of each target patent in step SL101, and generates a dispute prediction model value or a dispute prediction information value with respect to each of a self-patent, a self-patent set, and a divided self-patent set in step SL102. Continuously, the dispute prediction information analysis engine 5300 performs a quantitative analysis of the dispute prediction model value or the dispute prediction information value according to a ranking, a distribution, an owner, a type of owner, an inventor, and the patent classification in step SL103, and performs a quantitative analysis of the dispute prediction model value or the dispute prediction information value according to a bibliographic detail or an analysis index in step SL104, so as to generate a resulting value of the quantitative analysis.

The dispute prediction information which is an object to be analyzed by the dispute prediction information analysis engine 5300 includes SSi, TSi, wf(Sg(TSi)), W(TSi), and f(TS). Especially, the TSi includes a bibliographic detail and the dispute prediction element value of each dispute prediction element in Tables 1 to 4. The bibliographic detail, the dispute prediction element value, and wf(Sg(TSi), W(TSi)) may be objects of the quantitative analysis. For example, it is possible to analyze which size of the dispute prediction information value of the SS a certain owner has, by using the wf(Sg(TSi), W(TSi)) for the TSi of each owner included in the TS, and generates a ranking of each wf(Sg(TSi), W(TSi) in such a manner that TSi having a largest value of wf(Sg(TSi), W(TSi)) is generated with the TSi of a certain owner. Therefore, it is possible to effectively select patents and owners which have a possibility of attacking a company which possesses the SS or manufactures a product relating to the SS. On the other hand, it is possible to analyze the TSi having a value of more than the predetermined wf(Sg(TSi), W(TSi)) and to find a smallest frequency of an inventor so as to generate information on wf(Sg(TSi), W(TSi)) of each inventor. On the other hand, the TSi of a personal owner or a small and middle-sized enterprise may be extracted from the TSi which has the wf(Sg(TSi), W(TSi)) is larger than a predetermined reference.

If the dispute prediction information value or the dispute prediction function value of each f(TS) or f(TSui) is present with respect to a dispute prediction function f, the dispute prediction information generating unit 5140 of the present invention may determine how to organize the dispute prediction function value so as to generate the dispute prediction information, and may use the generated dispute prediction information as a dispute prediction model. On the other hand, a dispute prediction result outputting unit determines which format of a disputed prediction result is output. Actually, a report having a pdf format or a report for an E-mail is generated by a patent dispute information report generating unit 4440 of the present invention.

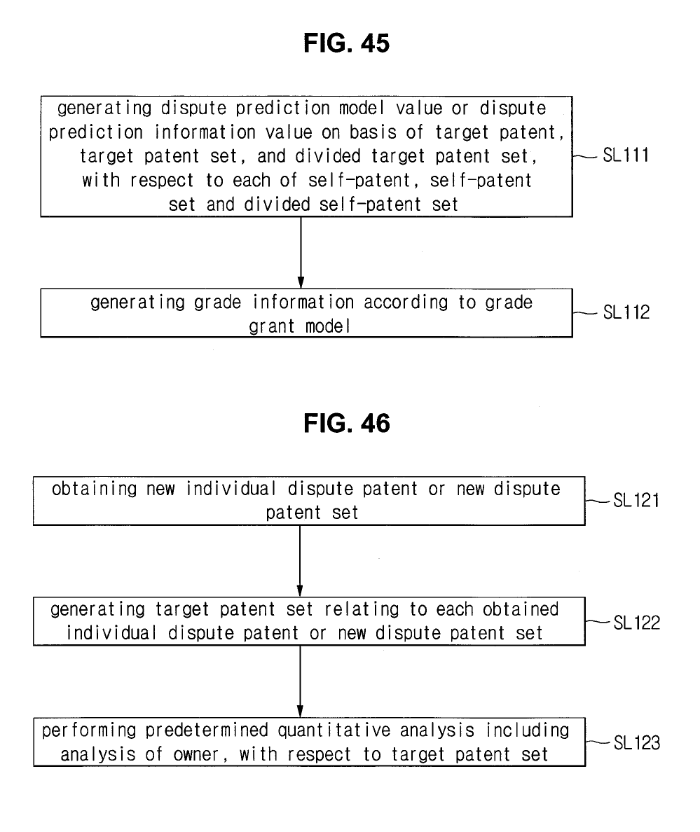

Continuously, a method of generating grade information based on the dispute prediction information value in the dispute prediction engine 5100 will be described with reference to FIG. 45. The dispute prediction engine 5100 generates a dispute prediction model value or a dispute prediction information value with respect to the self-patent, the self-patent set, and the divided self-patent set in step SL111, and generates grade information according to a grade grant model in step SL112. When the dispute prediction information value or the dispute prediction function value of each f(TS) or f(TSui) is present with respect to at least one collective dispute prediction information generating function f, it is possible to determine a dispute prediction grade according to the predetermined grade grant model. The grade grant model grants a grade to each section of the dispute prediction function value, or determines a grade section on the basis of a distribution, considering a distribution of the dispute prediction function value so as to grant a prediction grade to the determined grade section. There is a plurality of models which divide a score value into the number n of grades when the score value is present. It will be obvious to a person skilled in the art.

Continuously, a method of upgrading a model of the patent dispute prediction information generating system 5000 will be described. In a case where dispute incurrence patents are increased as time passes, the dispute prediction element or a new dispute prediction element set, which includes the added dispute incurrence patents, is used to generate a dispute prediction model. Dispute prediction information may be generated by using the generated dispute prediction model. In other words, the dispute prediction element value of each Pi is changed as time passes. If the dispute prediction element value is changed, the dispute prediction model is changed and the dispute prediction model value and the dispute prediction information value also are changed. On the other hand, the patent dispute prediction information generating system 5000 arranges and generates at least one dispute prediction model value and the dispute prediction information value according to a predetermined period or condition with respect to at least one patent set which the patent dispute prediction information generating system 5000 manages and at least one patent set which the user manages.

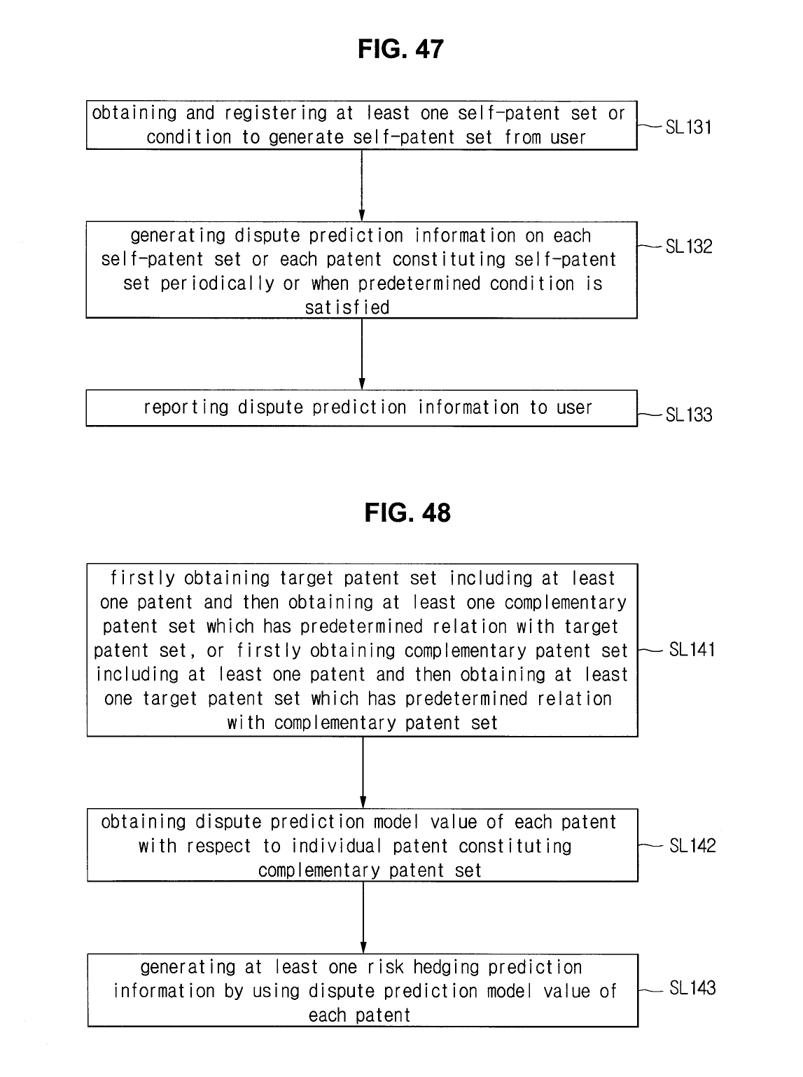

Continuously, a method of processing information in a dispute extending prediction engine 5600 of the present invention will be described with reference to FIGS. 46 and 47. The dispute extending prediction engine 5600 obtains a new dispute patent or a new dispute patent set in step SL121, and generates a target patent set corresponding to each dispute patent or each dispute patent set in step SL122. Then, the dispute extending prediction engine 5600 performs the predetermined quantitative analysis including an owner analysis for the target patent set in step SL123. The dispute extending prediction engine 5600 obtains and registers at least one self-patent set or a condition in which at least one self-patent set is generated, from the user in step SL131, and generates dispute prediction information on each self-patent set or each self-patent constituting the self-patent set periodically or when the predetermined condition is satisfied, in step SL132. Continuously, the dispute extending prediction engine 5600 reports the generated dispute extending prediction information to the user in step SL133. Hereinafter, the method of processing the information in the dispute extending prediction engine will be described.

The dispute extending prediction engine 5600 analyzes the dispute patent through a new dispute incurrence analyzing unit 5610 when at least one new dispute patent is obtained, so as to generate analysis information on the new dispute patent, dispute extending prediction information on the new dispute patent through the new occurrence dispute extending prediction unit 5620, or perform a process of informing of the new dispute patent through a dispute extending informing unit 5630.

Firstly, the new occurrence dispute analysis unit 5610 analyzes a frequency of disputes caused by new dispute patent and a sequential distribution of the frequency, the presence or absence of duplication of a dispute party (defendant and the like), and a sequential distribution of the dispute of each dispute party in a dispute including the new dispute patent. On the other hand, it is possible to perform the predetermined quantitative analysis for the new dispute patent by a predetermined period unit. In the quantitative analysis process, quantitative analysis information is generated according to each owner, each dispute institution person, each dispute patent, each defendant, each inventor, each patent classification, and each dispute institution date.

The new occurrence dispute extending prediction unit 5620 treats each new dispute patent as a self-patent SSi, and generates a TS including succeeding patents after a filing date of the self-patent (earlier date or priority date may be a reference) by using the target patent set generating unit 5120 of the present invention. The predetermined quantitative analysis process including an owner analysis of TSi is performed with respect to the generated TS. On the other hand, the new occurrence dispute extending prediction unit 5620 constitutes a new dispute patent set including two or more new dispute patents as a self-patent set, and generates a TSi(SSi) including succeeding patents after a filing date of the self-patent SSi (earlier date or priority date may be a reference) by using the target patent set generating unit 5120 of the present invention. TS is constituted with the generated TSi (SSi). The predetermined quantitative analysis process including an owner analysis of TSi is performed with respect to the generated TS. It should be understood that the predetermined dispute prediction model value and the weight of the present invention are applied to the TSi constituting the target patent set. The dispute prediction model value and the weight are used for the quantitative analysis of the present invention.

Continuously, a method of providing alert service to each user by using the dispute extending informing unit 5630 will be described. The user may set at least one SS, and may register an owner such as competing company relating to the user, interested patents, and interested technology groups (registered by the patent classification). In a case where variation of the whole patent data such as an occurrence of new patent data, and a change of an owner, occurrs, a new troll is added, a standard patent pool is added, or dispute incurrence patent is added, a dispute prediction function value of the f(TS) or f(TSui) is changed in each SS. When the dispute prediction function value of the f(TS) or f(TSui) at a time when t=t1 and the dispute prediction function value of the f(TS) or f(TSui) at a time when t=t2 are changed over the predetermined value, the system can provide information on variation occurrence to the user. For example, when an event that a certain troll purchases the number n of patents through a child-company from at least one person or company within the previous one month (this can be known through current assignee information) occurs, the dispute prediction function value of the f(TS) or f(TSui) for the SS is changed over the predetermined value at a time when t=t2, a patent dispute danger of the user may remarkably increase. Of course, the system can perform the predetermined quantitative analysis for the patent (an owner analysis, a technical field analysis, a sequential analysis, and the like) when n patents are present. The system may obtain a parent patent set which is cited by the n patents, and may perform the predetermined quantitative analysis for the parent patent set.

Continuously, a method of generating risk hedging prediction information by using the patent dispute prediction information generating system 5000 will be described. A risk hedging information generating unit of the present invention generates the risk hedging prediction information. FIG. 48 shows a flowchart illustrating an exemplary method of processing information in the risk hedging information generating unit. The risk hedging information generating unit firstly obtains a target patent set including at least one patent and then obtains at least one complementary patent set relating to the target patent set, or firstly obtains at least one complementary patent set and then obtains at least one target patent set relating to the complementary patent set in step SL141, obtains at least one dispute prediction model value of each patent constituting the complementary patent set in step SL142, and generates at least one piece of risk hedging prediction information by using the dispute prediction model value of each patent in step SL143. Hereinafter, the method of generating risk hedging prediction information will be described in detail.

The risk hedging prediction information is to generate a risk hedging patent set RHS which is a kind of complementary patent set and is used to predict a patent attack on all TSs or at least one divided TS, and to generate a cross-licensing patent set CLS which is a kind of the complementary patent set and has a predetermined relation designated by the SS or a generator of the SS in the RHS. Firstly, the risk hedging information generating unit obtains selection information of a user or the patent dispute prediction information generating system 5000 on TSs or at least one divided TS. The divided TS may be a divided TS of the TS according to an owner or an owner having a specific property (troll, competition company, dispute causing person, dispute experience person, and the like), and also may be a divide TS including plural TSi having a high value of the wf(Sg(TSi)), W(TSi) with respect to the divided TS, and the divided TS having a high value of f(TS) with respect to the divided TS.

The risk hedging information generating unit may treat the TS or the divided TS (hereinafter, referred to as re-input TS) like the SS. When the re-input TS is processed just like the self-patent set, the target patent set generating unit 5120 generates a TS (re-input TS) which is a target patent set relating to the re-input TS. The dispute prediction element value generating unit 5510 generates a dispute prediction element value of each dispute prediction element in Tables 1 to 4 with respect to a target patent TSi (re-input TS) constituting the TS (re-input TS). The dispute prediction model value obtaining unit 5130 obtains a dispute prediction model value relating to the dispute prediction element value of the generated TSi (re-input TS). The dispute prediction information generating unit 5140 generates all predetermined information relating to the TSi (re-input TS). Information which the dispute prediction information generating unit 5140 generates may be wf(Sg(TSi(re-input TS)), W(TSi(re-input TS)), or f(TS(re-input TS)).

The risk hedging information generating unit selects a complementary patent candidate group or a complementary patent group which is a patent having wf(Sg(TSi(re-input TS))) and W(TSi(re-input TS))) larger than the predetermined level, and a patent having wf(Sg(TSi(re-input TS))) and W(TSi(re-input TS))) larger than the predetermined level, of which an applicant is a person, a small and middle-sized enterprise, a university, or an institution, and an owner with a predetermined risk hedging property. The risk hedging property enables the SS or a generator of the SS to hedge a risk, and refers to a property of allowing an owner to counterattack a person who is able to attack the user, or making a patent dispute risk to be reduced. A patent becomes a strong complementary patent as the property becomes stronger. If TS of the SS including patents of a certain owner which cause a patent dispute has a possibility in that TS is exposed to a dispute hazard from a specific patent group, the specific patent group A becomes a complementary patent group which has a possibility of hedging a risk of the TS in view of the SS. Accordingly, the information processing of the risk hedging information generating unit is to seek the above-mentioned complementary patent group A.

The TS is divided by the patent set dividing unit 5310. If the divided TS of the specific owner is present, the risk hedging information generating unit controls the patent set dividing unit 5310 to generate at least one re-divided TS according to various division policies with respect to the divided TS of the specific owner. According to each re-divided TS, the risk hedging information generating unit selects a patent of which wf(Sg(TSi(re-divided TS)), W(TSi(re-divided TS))) is larger than a predetermined level, a patent of which wf(Sg(TSi(re-divided TS)), W(TSi(re-divided TS))) is larger than the predetermined level and of which an applicant is a person, a small and middle-sized enterprise, a university, or an institution, or a patent of an owner which has a predetermined risk hedging property, from the TSi(re-divided TS). The risk hedging information generating unit performs a kind of simulation in which a plurality of re-divided TSs is generated and a patent group A relating to the re-divided TS is found. On the other hand, a plurality of re-divided TSs may be generated by applying a clustering for the divided TSi constituting the divided TS of the specific owner to constitute the number n of clustered and re-divided TSs, or by dividing the divided TSi into several pieces according to each patent classification. The reason that the risk hedging information generating unit processes information of each re-divided TS is because of not only finding a patent group A capable of counterattacking on the divided TS with a wide range, but also seeking a specified patent group B capable of counterattacking several re-divided TSs with a narrow range, in consideration of a counterattack on an owner of the divided TS.

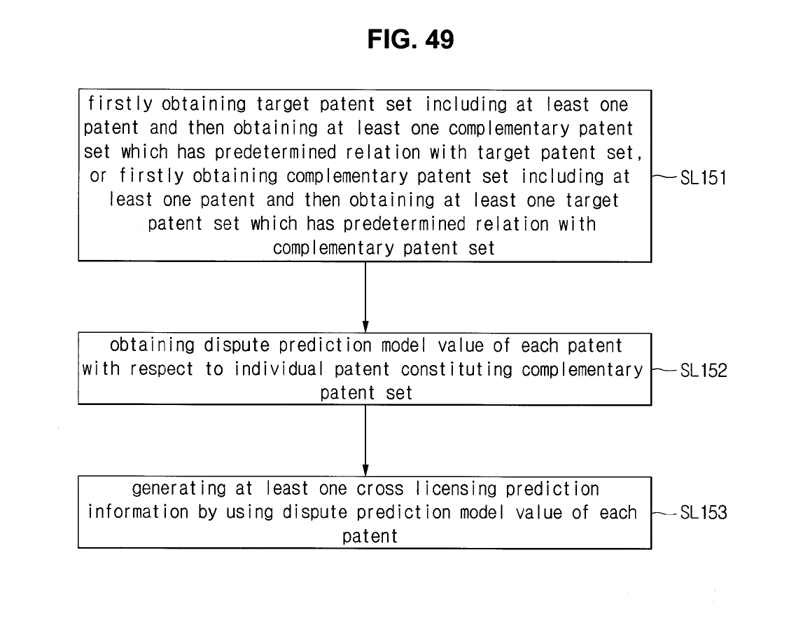

Continuously, a method of processing information in the cross licensing information generating unit 5340 of the present invention will be described with reference to FIG. 49. The cross licensing information generating unit 5340 firstly obtains a target patent set including at least one patent and then obtains at least one complementary patent set which has a predetermined relation with a target patent set, or firstly obtains a complementary patent set including at least one patent and then at least one target patent set which has a predetermined relation with a complementary patent set in step SL151. Then, the cross licensing information generating unit 5340 obtains at least one dispute prediction model value of each patent with respect to an individual patent constituting the complementary patent set in step SL152, and generates at least one cross licensing prediction information by using the dispute prediction model value of each patent in step SL153. Hereinafter, the method of processing the information in the cross licensing information generating unit will be described in more detail.

The cross licensing patent group is generated by the cross licensing information generating unit 5340 of the present invention. The cross licensing information generating unit 5340 extracts patents included in the SS, or of an owner which a person generating the SS designates (for example of the owner, a company, subsidiary companies, a subcontracted company, a prime contract company or cooperating company, an affiliate person, an institution, a university and the like), from the patent group A capable of counterattacking the divided TS with a wide range or the specified patent group B capable of strongly counterattacking the several re-divided TS with a narrow range. On the other hand, the cross licensing information generating unit 5340 defines patents of the SS or patents which an owner generating the SS designates (for example of the owner, a company, subsidiary companies, a subcontracted company, a prime contract company or cooperation company, an affiliate person, an institution, a university and the like), when generating the TS (divided TS) with respect to the divided TS, and extracts patents with a property which the unit 5340 desires from the defined patents so as to generate the TS (divided TS) through the target patent set generating unit 5120. On the other hand, the cross licensing information generating unit 5340 controls the dispute prediction information generating unit 5140 to generate wf(Sg(TSi(divided TS)), W(TSi(divided TS))) or f(TS(divided TS)) relating to the TSi (divided TS) which is an individual patent constituting the TS(divided TS). Typically, there is a possibility that no identical patent is present between the SS and the TS (divided TS). However, there is a possibility that an identical patent is present between the SS and the TS (divided TS) since plural patents constituting the SS are present and filing dates of the patents constituting the SS are widely distributed.

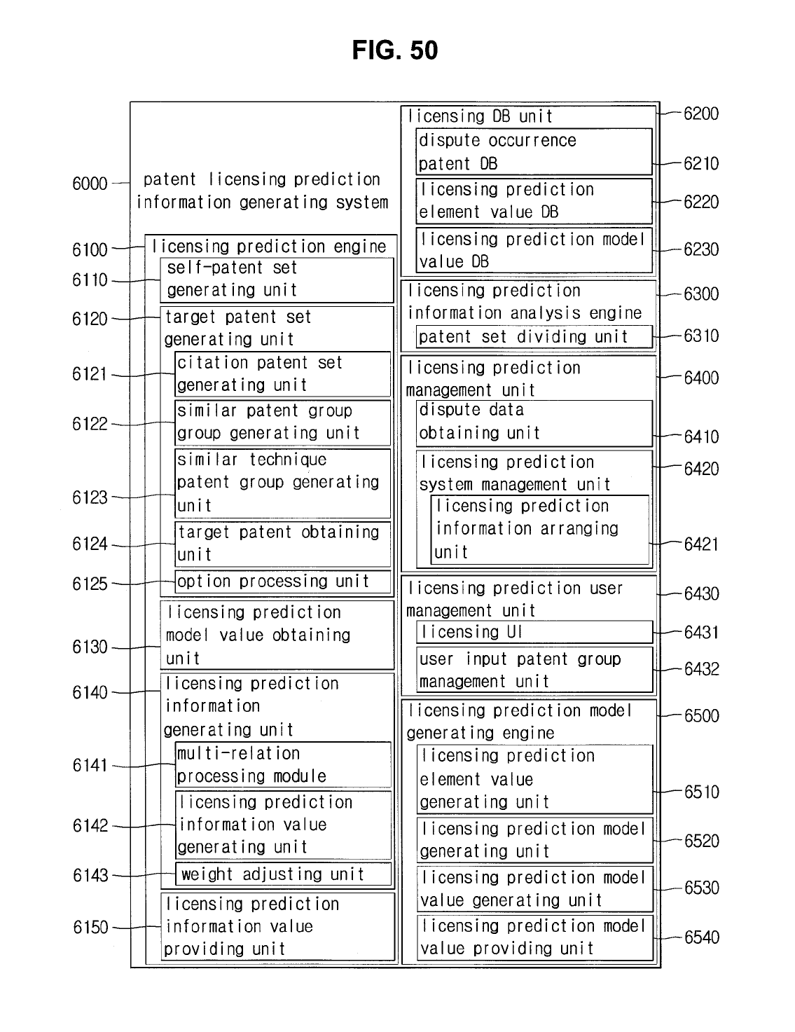

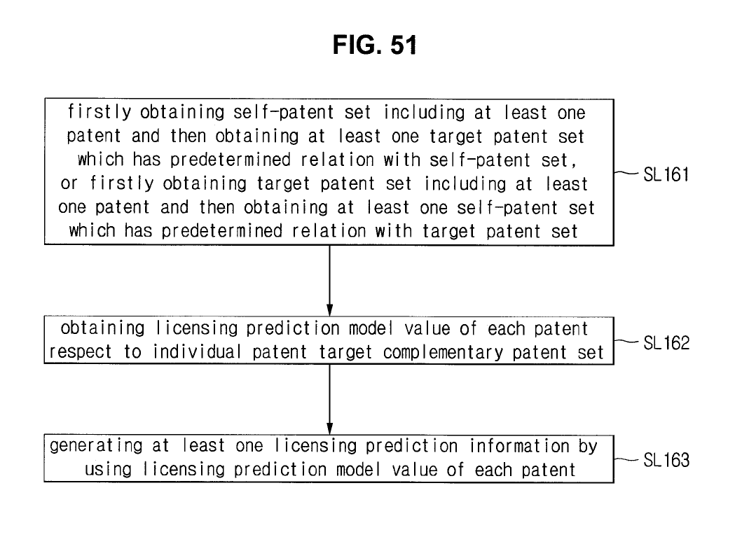

Continuously, an application system using each engine, DB and functional units constituting the patent dispute prediction information generating system 5000 of the present invention and a method of processing information in the application system will be described. There is a patent licensing prediction model generating system as a representative application system. In FIG. 50, an exemplary configuration of the patent licensing prediction information generating system 6000 is shown, and in FIG. 51, a flowchart illustrating a method of processing information in the patent licensing prediction information generating system 6000 is shown.

Firstly, the patent licensing prediction information generating system 6000 will be described. When a patent dispute occurs, there are many cases where the dispute is finished through a licensing. If a licensing negotiation fails, there are many cases where litigation is raised. Accordingly, if functions of the patent dispute prediction information generating system 5000 are used in themselves, it is possible to configure the patent licensing prediction information generating system 6000. Most functional modules identically operate in the patent licensing prediction information generating system 6000 and the patent dispute prediction information generating system 5000. However, in the case of the patent licensing prediction information generating system 6000, the target patent set generating unit 5120 generates a target patent set relating to the succeeding application patent set TSi rather than the self-patent set, differently in the patent dispute prediction information generating system 5000, when generating a similar patent group which has a predetermined relation.

With relation to the patent dispute prediction information generating system 5000 and the patent licensing prediction information generating system 6000, the dispute prediction element corresponds to the licensing prediction element. The dispute prediction model may correspond to the licensing prediction model, and the dispute DB unit 5200 corresponds to the licensing DB unit 6200. The dispute prediction information analysis engine 5300, the dispute prediction management unit 5400, the dispute prediction model generating engine 5500, the dispute prediction engine 5100, the dispute prediction model value obtaining unit 5130, the dispute prediction information generating unit 5140 and the dispute prediction information value generating module 5142 respectively correspond to the licensing prediction information analysis engine, the licensing prediction management unit 6400, the licensing prediction model generating engine 6500, the licensing prediction engine 6100, the licensing prediction model value obtaining unit 5130, the licensing prediction information generating unit 6140 and the licensing prediction information value generating module 6142. Also, the dispute prediction information value providing unit 5150, the dispute prediction element value DB 5220, the dispute prediction model value DB 5230, the dispute prediction system management unit 5420, the dispute prediction information arranging unit 5421, the dispute prediction user management unit 5430 and the dispute UI unit 5431 respectively correspond to the licensing prediction information value providing unit 6150, the licensing prediction element value DB 6220, the licensing prediction model value DB 6230, the dispute prediction system management unit 6420, the dispute prediction information arranging unit 6421, the licensing prediction user management unit 6430 and the licensing UI unit 6431. Further, the dispute prediction element value generating unit 5510, the dispute prediction model generating unit 5520, the dispute prediction model value generating unit 5530, the dispute prediction model value providing unit 5540 and the attack prediction information generating unit respectively correspond to the licensing prediction element value generating unit 6510, the licensing prediction model generating unit 6520, the licensing prediction model value generating unit 6530, the licensing prediction model value providing unit 6540 and the licensing prediction information generating unit. Therefore, the description of the configuration of the patent licensing prediction information generating system 6000 and the method of processing the information will be sufficient when the terms in the description of the patent dispute prediction information generating system 5000 are changed into corresponding terms.

On the other hand, in the patent licensing prediction information generating system 6000, the dispute incurrence patent DB 5210, 6210, and the dispute data obtaining unit 5410, 6210 of the patent dispute prediction information generating system 5000 respectively perform identical functions. Further, the self-patent generating unit 5110, 6110, the target patent set generating unit 5120, 6120, the citation patent set generating unit 5121, 6121, the similar patent group generating unit 5122, 6122, the similar technique patent group generating unit 5123, 6123, the target set obtaining unit 5124, 6124, the option processing unit 6125, 5125, the multi-relation processing module 5141, 6141, and the weight adjusting unit 5143, 6143 perform identical functions. Especially, since the licensing prediction information generating system 6000 generates the licensing prediction elements and the licensing prediction model by using dispute incurrence patents and non-dispute patents, the dispute incurrence patent DB 5210, 6210 and the dispute data obtaining unit 5410, 6410 are used with name identical to that in the patent dispute prediction information generating system 5000. In those paragraph, identical structural elements which have the same name in the patent licensing prediction information generating system 6000 and the patent dispute prediction information generating system 5000 are indicated by the same reference numerals.

As shown in FIG. 51, the patent licensing prediction information generating system 6000 firstly obtains a self-patent set including at least one patent and then obtains at least one target patent set which has a predetermined relation with the self-patent set, or firstly obtains a target patent set including at least one patent and then obtains at least one self-patent set which has a predetermined relation with the target patent in step SL161, obtains at least one licensing prediction model value of each patent with respect to an individual patent constituting the target patent licensing in step SL162, and generates at least one piece of licensing prediction information by using the licensing prediction model value of each patent in step 163. The generation of the licensing prediction information in the patent licensing prediction information generating system 6000 may be performed by applying the method of generating the dispute prediction information of the patent dispute prediction information generating system 5000. It is obvious to a person skilled in art that the method of generating individual licensing prediction information can be understood by reading the method of generating the dispute prediction information. Accordingly, the description of the method will be omitted.

Continuously, a method of generating citation analysis information of each group, which is a key elementary technique in the patent dispute information processing, will be described with reference to the drawings.

FIG. 5 shows an exemplary structure of a citation analysis unit 4500 according to the present invention. the citation analysis unit 4500 includes an obtained patent set generating unit 4510 which obtains a patent set constituted with at least two patents and generates an obtained patent set, an object patent set generating unit 4520 which processes an individual patent included in the obtained self-patent set and generates at least one citation patent set, and a citation analysis unit 4530 which analyzes a citation according to each predetermined citation analysis purpose with the citation patent set.

The obtained patent set generation unit 4510 includes a patent set obtaining unit 4511 which obtains a patent set, and an obtained patent set definition unit 4512 which defines the obtained patent set. The object patent set obtaining unit 4520 includes an object patent set obtaining unit 4522 which obtains an object patent set and an object patent set definition unit 4521 which defines the object patent set. The patent set which the object patent set obtaining unit 4522 obtains includes a forward citation patent set, a backward citation patent set, a forward self-citation patent set, a backward self-citation patent set, and a citation occurrence patent set. The obtained object patent set generating unit 4520 defines the object patent set under a specific condition, and obtains the object patents from the data unit 1000 by reflecting the condition. The citation patent set generating unit 4523 generates a citation patent set by using the obtained object patent group. The citation analysis unit 4530 includes a citation analysis purpose selection unit 4531 which selects a citation analysis purpose, and a citation analysis execution unit 4532 which performs a citation analysis for the selected purpose. On the other hand, the patent information system 10000 generates and manages patent sets according to each category, and the management of the patent set is performed by the system patent set management unit of the present invention. The system patent set management unit includes an applicant related patent set management unit which manages a patent set specified to each applicant, a classification related patent set management unit which manages a patent set specified to each patent classification, and a patent set management unit which manages a patent set specified to other classifications or categories.

On the other hand, the patent set which the users generate is managed by a subscriber related patent set management unit.

As shown in FIG. 2, the patent data unit 1100 includes a patent specification file unit 1110, a patent DB unit 1120, a patent classification DB 1130, and the like. The patent DB unit 1120 manages bibliographic details, a specification, drawings, and the like relating to all patents in each field, and includes core keywords extracted from various fields constituting the specification (title, summary, related art, claims, detailed description of the present invention, and the like). On the other hand, the patents may further include citation information relating to prior technical documents of the patents. As an example, in the case of US patent data, the citation information is included in a reference part, and includes a US patent number, foreign patent number, an indicator for a non-dispute patent, and the like. On the other hand, information on search report of a patent office examiner or related person, cited reference information in an examiners opinion, and the like become citation information in a broad sense. In a case where a patent document has forward citation information, the specific document becomes a backward citation document in view of a document included in the forward citation information. In view of the specific document, a document included in the forward citation information becomes a parent document, and in view of the parent document, the specific document becomes a child document. It is obvious to a person skilled in the art to process information relating to the child-parent relation in DB, and accordingly the description will be omitted.

The bibliographic details of the patent document includes information on published nation information, information on various dates, information on various numbers, information on at least one owner, information on at least one inventor, information on at least one patent classification, information on at least one priority, and the like. The date information includes filing dates, published dates, registration dates, and the like. The number information includes application serial numbers, publication numbers, registration numbers, original application number, priority number, and the like. The owner information includes applicants, assignees, patentees, and the like. When an owner is changed and the change of the owner is managed, the owner information may include information on an assignor and an assignee, and information on a final owner. The priority information includes a priority number, a priority date, a nation, and the like. On the other hand, in a case of a divisional application, Continuation-In-Part application, continuation application, and the like, information on an original application number, an original filing date, and the like is added to the bibliographic details. Further, a representative figure, title, summary, index keyword, and the like are included in the bibliographic details. On the other hand, a processed bibliographic detail includes domestic family information (divisional application, changed application, or a patent application relating to continuation-in-part application and continuation application), or foreign family information (application relating to priority according to treaty, and international application). On the other hand, the processed bibliographic detail further includes core keyword information which is extracted from a text of the patent specification through a natural language processing in a manner of extracting keywords according to each field or each combination of fields constituting a body of the patent specification. The patent classification information includes specific and local patent classification of each nation such as USPC, FT, FI, ECLA and the like, as well as a common IPC.

Continuously, a method of processing information in a citation analysis unit 4500 relating to each set will be described in detail.

The obtained patent set generating unit 4510 obtains an obtained patent set including at least two patents. The object patent set generating unit 4520 processes each patent included in the obtained patent document set to generate at least one object patent set. The citation analysis unit 4530 processes at least one citation analysis with respect to the object patent set.

On the other hand, as shown in FIG. 20, the citation analysis unit 4500 defines the obtained patent set or the object patent set through the obtained patent set definition unit 4512 or the option selection unit 4340, obtains selection information relating to the citation analysis purpose through the citation analysis purpose selection unit 4531, generates a citation patent set which is extracted from the defined patent set through the citation patent set generating unit 4523 and analyzed, and generates analysis information through the citation analysis purpose selection unit 4531 and the citation analysis execution unit 4532 with relation to the patents included in the citation analysis object set according to a citation analysis purpose.

The citation analysis unit 4530 of the present invention obtains a users' selection for the citation purpose by using the citation analysis purpose selection unit 4531. The citation analysis purpose indicates what important information resulting from the citation analysis relates to. An example of the citation analysis purpose includes the total amount, the applicant/owner, the inventor, the patent classification, and the individual patent. In a case where a patent set relating to a citation is present, the citation analysis execution unit 4532 performs at least one predetermined quantitative analysis with relation to a total amount of patents in the patent set, a total amount of patents of each applicant/owner, a total amount of patents of each period, a total amount of patents in each patent classification, and the like. The citation analysis execution unit 4532 includes a quantitative analysis unit which performs a quantitative analysis. The quantitative analysis may be performed for each field. On the other hand, the quantitative analysis may include a sequential analysis, and also may include a sequential analysis for each field.

A citation direction may be one of a forward citation, a backward citation, and an obtained citation occurrence patent set. On the other hand, it is preferable to allow a duplication of a forward citation patent set or a backward citation patent set. However, in a specific case, it is preferable for a user not to select the duplication thereof. That is, where the n patents I1, I2, . . . , In belonging to the obtained patent set cite an identical patent Pi, it is preferable that a weight is applied to the Pi at n times. Typically, when a set operation (union operation) is performed, duplication frequency is removed from duplicated elements Pi and the duplicated elements are treated one time. This is not preferable considering the purpose of the citation analysis. Therefore, each Pi is treated while frequency of the Pi is maintained.

On the other hand, a rising analysis is performed with respect to a patent group constituting a forward citation patent set, a backward citation patent set, a forward self-cited patent set, a backward self-cited patent set, an obtained citation occurrence patent set, etc. which are defined or not defined. The rising analysis performs a sequential analysis for each applicant, each inventor, each patent classification, each keyword (including a pair of keywords), and each document, or for each co-applicant, each co-inventor, each pair of patent classifications, and each pair of keywords. On the other hand, a new entry analysis is performed with respect to a patent group constituting the forward citation patent set, the backward citation patent, the forward self-cited patent set, the backward self-cited patent set and the obtained citation occurrence patent set, which are defined or not defined. The new entry analysis is to extract an individual applicant, an inventor, a patent classification, a keyword, an individual document, a co-applicant, a co-inventor, a pair of patent classifications, and a pair of keywords of patent applications filed after a specific time, i.e. cutoff or threshold. On the other hand, in a kind of the new entry analysis, it is possible to extract an applicant, an inventor, a patent classification, a keyword, and an individual document, or an applicant, an inventor, a patent classification, a keyword, and an individual document which have a rising rate of frequency of a keyword pair, or a co-applicant, a co-inventor, a pair of patent classifications, and a pair of keywords, on the basis of a specific cutoff.

On the other hand, it is obvious to a person skilled in the art that since a condition (all conditions are defined by SQO), under which a numeric value is present, is allocated to each of all numeric values present in the result of the citation analysis, patent documents corresponding to the numeric value are loaded when the numeric value is clicked. Accordingly, the citation analysis can be performed again by using the patent documents, which correspond to the analysis numeric value, as the obtained patent set.

On the other hand, the network analysis unit 4700 analyzes an association network between co-defendants. The data visualization unit 4710 visualizes the network of the co-defendants. For example, in a case where a defendant i and at least one defendant j are co-defendants with relation to a patent dispute i, or where a defendant i and at least one defendant j are co-defendants with relation to a dispute patent i, the network analysis unit 4700 performs an analysis relating to a network between the co-defendants with respect to each patent dispute group including at least one patent dispute i, or with respect to each dispute patent group including at least one patent dispute i. On the other hand, the network analysis unit 4700 performs a network analysis by including the plaintiff and the co-defendants with respect to each patent dispute group including at least one patent dispute I, or with respect to each dispute patent group including at least one dispute patent i since there is present a plaintiff of each dispute patent i or each patent dispute i. At this time, a relation between the plaintiff and the defendant is processed with directivity, while a relation between the co-defendants is processed without directivity. In this case, when a network for each patent dispute group or for each dispute patent is performed, the number of plaintiffs becomes the largest. Accordingly, the plaintiff is placed at a center. The network analysis unit analyzes arbitrary association through the network analysis. The association which the network analysis unit 4700 analyzes is identically applied on the basis of an arbitrary patent set to a case where there is present a plurality of core keywords included in the identical patent document, a case where at least two patent classifications are present, a case where at least two inventors are present, a case where at least two applicants are present, and a case where at least two citation patent documents are present. If two or more objects simultaneously are in a single patent set as described above, the two or more objects which are simultaneously present have association and become objects of the network analysis when the number n of the single patent sets are present.

### INDUSTRIAL APPLICABILITY

The present invention will be extensively utilized in a patent information industry, a patent information analysis industry, a patent evaluation business, a patent trading business, a patent law industry, a patent consulting industry, R&D, and the like.

1-30. (canceled)

31. A method of generating a patent dispute prediction model of a patent information system, the method comprising:
(A) obtaining at least one dispute patent set including a patent used for at least one kind of patent dispute and at least one non-dispute patent set;
(B) generating dispute prediction element values for at least two predetermined dispute prediction elements with respect to at least two dispute patents constituting the dispute patent set and at least two non-dispute patents constituting the non-dispute patent set; and
(C) performing a predetermined statistical process for the dispute patent and the non-dispute patent by using the dispute prediction element value as a description parameter value and using a dispute patent grant value which is granted to the dispute patent and a non-dispute patent grant value which is granted to the non-dispute patent differently from the dispute patent grant value as a reaction parameter value, so as to establish at least one dispute prediction model for generating at least one predetermined dispute prediction model.

32. (canceled)

33. The method as claimed in claim 31, wherein The dispute prediction element includes a citation related dispute prediction element, and at least one of a direct citation, and an indirect citation, a latent citation, and a chain citation is used to generate a dispute prediction element value for the citation related dispute prediction element, and wherein a method of using at least two of the direct citation, the latent citation, the latent citation and the chain citation uses at least one of a first citation using method of generating a dispute prediction element value for a predetermined prediction element by independently processing each kind of citation, and a second citation using method of applying a predetermined weight to each kind of citation to generate a dispute prediction element value for a predetermined dispute prediction element.

34. The method as claimed in claim 31, wherein the method of granting the dispute patent granting value to the dispute patent includes any one of a first method of differently granting the dispute patent grant value according to a property of the dispute patent and a second method of granting a dispute patent grant value according to whether the dispute occurs, regardless of the property of the dispute patent.

35. The method as claimed in claim 34, wherein the property of the dispute patent includes at least one of a multi-dispute property, a property of the number of co-defendants, and a co-participation property, the multi-dispute property is a property relating to the dispute patent involved in at least two disputes, the co-defendant property is a property of the dispute patent which is related to a dispute in which litigation is instituted with respect to at least two defendants, and the co-participation property is a property in which at least one dispute patent relates to a dispute to which the dispute patent relates.

36. The method as claimed in claim 35, wherein in a case where the first method of granting a first dispute patent grant value is employed, the method of granting the dispute patent grant value grants the high dispute patent grant value when the dispute patent has the multi-dispute property rather than when the dispute patent has no multi-dispute property, grants the high dispute patent grant value when the dispute patent has a co-defendant property rather than when the dispute patent has no co-defendant property, and grants the low dispute patent grant value when the dispute patent has a co-participation property rather than when the dispute patent has no co-participation property.

37. The method as claimed in claim 35, wherein in a case where the first method of granting a first dispute patent grant value is employed, when the dispute patent has the multi-dispute property, the method of granting the dispute patent grant value grants the dispute patent grant value with reference to at least one of a total number of disputes, a distribution property of all disputes at each time, and a distribution property of total disputes of each defendant, to which the dispute patent relates, when the dispute patent has the co-defendant property, the method of granting the dispute patent grant value grants the dispute patent grant value with reference to at least one of a total number of defendants, an average number of defendants per dispute, and a statistical distribution property of the defendants per dispute, to which the dispute patent relates, and when the dispute patent has the co-participation property, the method of granting a dispute patent grant value grants the dispute patent grant value with reference to at least one of an average share of the dispute patent and a statistical distribution property of the average share, to which the dispute patents relates.

38. (canceled)

39. The method as claimed in claim 31, further comprising: (D) generating a dispute prediction model value of each patent with respect to patents belonging to a patent set which is obtained by using the dispute prediction model, wherein the obtained patent set is at least one of all patent sets, a predetermined patent set, a patent set which a user designates, and a patent set relating to the patent set which the user designates, and the obtained dispute prediction model value is temporarily or permanently stored in correspondence to the patent, or is transmitted to a person who requests the dispute prediction model value.

40. (canceled)

41. A method of processing dispute prediction information of a patent information system, the method comprising:
(a)(a1)(a11) firstly obtaining a self-patent set including at least one patent, and then (a12) obtaining at least one target patent set having a predetermined relation with the self-patent, or (a2)(a21) firstly obtaining a target patent set including at least one patent, and then (a22) obtaining at least one self-patent set having a predetermined relation with the target patent;
(b) obtaining at least one dispute patent prediction model value of each patent with respect to an individual patent constituting the target patent set; and
(c) generating at least one piece of dispute prediction information by using the dispute prediction model value of each patent.

42. The method as claimed as claim 41, wherein the self-patent set is a user management patent set which a user generates or manages, or a system management patent set which the patent information system generates or manages, and the self-patent set is defined by using a predetermined set definition option, or divided into two or more partial patent sets by applying a predetermined division reference thereto, and wherein the target patent set is a user management patent set which a user generates or manages, or a system management patent set which the patent information system generates or manages, and the target patent set is defined by using a predetermined set definition option or divided into at least two partial patent sets by applying a predetermined division reference thereto.

43-48. (canceled)

49. The method as claimed in claim 41, wherein the dispute prediction model value of each patent is generated by using at least one dispute prediction element value of the dispute prediction element selected from at least one dispute prediction element in view of citation, at least one dispute prediction element in view of a multi-dispute patent, at least one dispute prediction element in view of a multi-dispute causing person, and at least one dispute prediction element in view of a multi-dispute technique group.

50. (canceled)

51. The method as claimed in claim 41, wherein the generated dispute prediction information is at least one of the dispute prediction information of each target patent corresponding to the obtained self-patent set, the dispute prediction information of each target patent group corresponding to the obtained self-patent set, the dispute prediction information on the target patent set corresponding to the obtained self-patent set, the dispute prediction information of each target patent corresponding to at least one partial self-patent set, and the dispute prediction information of each target patent group corresponding to at least one partial self-patent set.

52-55. (canceled)

56. The method as claimed in claim 42, wherein in step (a12), the target patent set is obtained in correspondence to each partial self-patent set which is divided, and in step (c), the dispute prediction information is generated in correspondence to each partial target patent set corresponding to the partial self-patent set, or in step (a22), the self-patent set is obtained in correspondence to each partial target patent set, and in step (c), the dispute prediction information is generated in correspondence to each partial self-patent set corresponding the partial target patent set.

57-61. (canceled)

62. The method as claimed in claim 41, wherein in step (b), after a predetermined set operation for the obtained first target patent set is performed, the dispute prediction model value of each second target patent constituting the second target patent set is obtained, and the second target patent set is generated by performing at least one of deletion of the first target patent constituting the first target patent set, definition of the first target patent set and addition of a new patent to the second target patent set.

63-70. (canceled)

71. A method of processing patent licensing prediction information of a patent information system, the method comprising:
(I)(I1)(I11) firstly obtaining a self-patent set including at least one patent and then (I12) obtaining at least one target patent set which has a predetermined relation with the self-patent, or (I2)(I21) firstly obtaining a target patent set including at least one patent and then (I22) obtaining at least one self-patent set which has a predetermined relation with the target patent set;
(J) obtaining at least one licensing prediction model value of each patent with respect to an individual patent constituting the target patent set; and
(K) generating at least one licensing prediction information by using the licensing prediction model value of each patent.

72. The method as claimed in claim 71, wherein in step (I12), the target patent set is a succeeding application on the basis of an earlier date of a self-patent which constitutes the self-patent set, or in step (I22), the self-patent set is a preceding application on the basis of an earlier date of a target patent which constitutes the target patent set.

73. The method as claimed in claim 71, wherein the generated licensing prediction information includes at least one of licensing prediction information on each self-patent corresponding to the target set, licensing prediction information on each self-patent group corresponding to the target patent set, licensing prediction information on the self-patent set corresponding to the target patent, licensing prediction information on each self-patent corresponding to at least one partial target patent set and licensing prediction information on each self-patent group corresponding to at least one partial target set.

74. The method as claimed in claim 71, wherein in step (I12) of obtaining the target patent set, only a patent satisfying a predetermined condition is obtained as a target patent, or a target patent is obtained in correspondence to each divided partial self-patent set or in correspondence to each of two or more self-patent sets, wherein the predetermined condition is set up by the user or the patent information system and includes at least one of an owner condition, a relation condition, an owner's total sales, recent dispute accusation information on an owner, and a property condition of an individual patent, wherein in a case where the target patent set is obtained in correspondence to each partial self-patent sets, in step (d) of generating the licensing prediction information, the licensing prediction information is generated in correspondence to each partial target patent set corresponding to the partial self-patent set, and in a case where the target patent set is obtained in correspondence to two or more self-patent sets, in step (I) of obtaining the self-patent set, at least two self-patent sets are obtained, and in step (d) of generating the licensing prediction information, the licensing prediction information is generated in correspondence to each target patent set corresponding to the self-patent set.

75. The method as claimed in claim 71, wherein in step (I22) of obtaining the self-patent set, only a patent satisfying a predetermined condition is obtained as a self-patent, or a self-patent set is obtained in correspondence to each divided partial target patent set or in correspondence to each of two or more target patent sets, wherein the predetermined condition is set up by the user or the patent information system and includes at least one of an owner condition, a relation condition, an owner's total sales, recent dispute accused information on an owner, and a property condition of an individual patent, wherein in a case where the self-patent set is obtained in correspondence to each partial target patent set, in step (d) of generating the licensing prediction information, the licensing prediction information is generated in correspondence to each partial self-patent set corresponding to the partial target patent set, and in a case where the self-patent set is obtained in correspondence to two or more self-patent sets, in step (I) of obtaining the target patent set, at least two target patent sets are obtained, and in step (d) of generating the licensing prediction information, the licensing prediction information is generated in correspondence to each self-patent set corresponding to the target patent set.

76-80. (canceled)

81. A method of processing patent risk hedging prediction information of a patent information system, the method comprising:
(i)(i1)(i11) firstly obtaining a target patent set including at least one patent and then (i12) obtaining at least one complementary patent set which has a predetermined relation with the target set, or (i2)(i21) firstly obtaining a complementary patent set including at least one patent and then (i22) obtaining at least one target patent set which has a predetermined relation with the complementary set;
(j) obtaining at least one dispute prediction model value of each patent with respect to an individual patent constituting the complementary patent set; and
(k) generating at least one risk hedging prediction information by using the dispute prediction model value of each patent.

82. (canceled)

83. The method as claimed in claim 81, wherein the target patent set is a patent set which has a predetermined relation with a self-patent set including at least one patent, a partial patent set which has a predetermined relation with the self-patent set, a patent set including patents which have a larger value than a predetermined dispute prediction model value, a partial patent set including patents which have a larger value than a predetermined dispute prediction model value, a patent set including patents which have a larger value than a predetermined dispute prediction information value with relation to the self-patent set, a partial patent set including patents which have a larger value than a predetermined dispute prediction information value with relation to the self-patent set, a patent set which has a larger value than a predetermined dispute prediction information value with relation to the self-patent set, or a partial patent set which has a predetermined dispute prediction information value.

84. The method as claimed in claim 81, wherein the target patent and the complementary patent are related patents which have a predetermined relation, the predetermined relation is at least one of a citing-cited patent relation, a relation of a similar patent group in a text mining scheme, and a similar technique patent relation in a patent classification, the complementary patents constituting the complementary patent set have a predetermined relation with two or more target patents, the relation is measured, and the measurement of the relation includes a relation frequency and a relation strength.

85. The method as claimed in claim 81, wherein the generated risk hedging prediction information includes at least one of risk hedging prediction information on each target patent corresponding to the complementary patent, risk hedging prediction information on each of one or more target patent groups corresponding to the complementary set, risk hedging prediction information on a target patent set corresponding to the complementary set, risk hedging prediction information of each target patent corresponding to at least one partial complementary set, and risk hedging prediction information on each of one or more target patent groups corresponding to at least one partial complementary set.

86-92. (canceled)
